(19) United States
(12) Patent Application Publication
(10) Pub. No.: US 2026/0311356 A1
(43) Pub. Date: Oct. 8, 2026

(54) Dimension Measurement System, Estimation System, and Dimension Measurement Method

(71) Applicant: Hitachi High-Tech Corporation, Minato-ku, Tokyo (JP)

(72) Inventors: Atsushi SAWADA, Tokyo (JP); Akira IKEUCHI, Tokyo (JP)

(21) Appl. No.: 19/100,769

(22) PCT Filed: Sep. 8, 2022
(86) PCT No.: PCT/JP2022/033680

§ 371 Date: Feb. 3, 2025

(51) Int. Cl. G06T 7/60; G06T 7/00; G06T 7/13

(52) U.S. Cl. CPC G06T 7/60; G06T 7/0004; G06T 7/13; G06T 2207/10061; G06T 2207/20081; G06T 2207/20092; G06T 2207/30148

(57) ABSTRACT

A technique capable of reducing the time and effort of manual operation by a person or burden on the person while allowing the person to input and set some of information, regarding a dimension measurement system or the like is provided. The invention is directed to a dimension measurement system that displays, for a user, a screen including an image and a graphical user interface (GUI), designates a reference line (interface reference line) for specifying a part of an area of a dimension measurement target structure, and designates a reference point (area reference point) contained within the area for specifying the area of the dimension measurement target structure, based on a manual operation by the user, on the image on the screen (step S3), detects a contour or edge of the area of the dimension measurement target structure in the image by using the reference line and the reference point (step S4), and measures the dimension of the dimension measurement target structure in the image by using information on the detected contour or edge (step S5).

### TECHNICAL FIELD

The present invention relates to a technique for measuring dimensions of a device structure or the like from an image of a sample such as a semiconductor device.

### BACKGROUND ART

As a technique for measuring (sometimes referred to as length measurement) the dimensions of a device structure or the like from an image of a sample such as a semiconductor device, and a technique for observing, analyzing, evaluating, inspecting a sample, there is a technique for performing such processes (sometimes referred to collectively as dimension measurement) using a charged particle beam apparatus such as a scanning electron microscope (SEM) or a transmission electron microscope (TEM). A computer system built into or externally connected to the charged particle beam apparatus processes captured images obtained by the charged particle beam apparatus to measure dimensions of target structures or patterns (for example, trenches) such as device structures.

For example, the computer system detects the contour of a structure from a cross-sectional image obtained by capturing a cross section of a semiconductor device (for example, a cross section produced by cleavage), and measures the dimensions (for example, trench width and trench depth) based on the contour.

An example of the prior art is JP4865147B (PTL 1). PTL 1 describes, as a “pattern measurement method and measurement system using a display microscope image”, “a step of setting an edge reference line on the edge of a pattern in a microscope image”, “a step of setting a plurality of edge points along the edge reference line”, “a step of integrating a luminance profile near a search line that intersects with the edge reference line at one edge point and calculating an edge position for one edge point”, “a step of calculating an approximation line for the edge from the edge position calculated for each of the plurality of edge points”, and “a step of measuring the shape of a pattern using the approximation line” (claim 1) and the like.

### CITATION LIST

### Patent Literature

PTL 1: JP4865147B (corresponding U.S. Pat. No. 7,054,506B)

### SUMMARY OF INVENTION

### Technical Problem

As a technique for a dimension measurement system that measures the dimensions of a target, based on detection of the contour of the target structure from a captured image (for example, a cross-sectional image) obtained using the above charged particle beam apparatus, there is a first technique in which a computer system automatically implements contour detection and dimension measurement by image processing such as template matching. Further, there is a second technique involves a person manually inputting and setting information required for contour detection and dimension measurement, and a computer system then implementing contour detection and dimension measurement based on that information.

In the first technique, it may be difficult to appropriately detect contours using image processing such as template matching, or the calculation load may be too high.

In the second technique, information required for contour detection and dimension measurement needs to be set by a person. For example, in the case of PTL 1, information such as “edge reference line” and “edge point” is set by the user. By using the information set by the person, image processing or the like by the computer system can be facilitated. However, in the case of the second technique, the time and effort of manual operation by a person may increase, and the work efficiency may decrease.

An object of the present disclosure is to provide a technique capable of reducing the time and effort of manual operation by a person and improving work efficiency while allowing the person to input and set some of information, regarding techniques such as a dimension measurement system that uses a charged particle beam apparatus to measure the dimensions of a target structure from a captured image. Another object is to provide a technique capable of reducing the influence of errors caused by manual operation by a person.

### Solution to Problem

A representative embodiment of the present disclosure has the following configuration. A dimension measurement system of an embodiment is a dimension measurement system which measures a dimension of a structure in an image, and includes a processor and a memory resource that stores data to be processed by the processor, in which the processor displays a screen including the image and a graphical user interface (GUI) for a user; designates a reference line for specifying a portion of an area of the structure of a dimension measurement target, based on a manual operation by the user on the image on the screen, acquires position information of the reference line, designates a reference point included in the area for specifying the area of the structure of the dimension measurement target, based on a manual operation by the user on the image on the screen, acquires position information of the reference point, detects a contour or edge of the area of the structure of the dimension measurement target in the image by using the reference line and the reference point, and measures the dimension of the structure of the dimension measurement target in the image by using information on the detected contour or edge.

An estimation system according to an embodiment is an estimation system that estimates a structure in an image, and includes a processor and a memory resource that stores data to be processed by the processor, in which the processor displays a screen including the image and a graphical user interface (GUI) for a user, designates a reference line for specifying a portion of an area of the structure of a dimension measurement target, based on a manual operation by the user on the image on the screen, acquires position information of the reference line, designates a reference point included in the area for specifying the area of the structure of the dimension measurement target, based on a manual operation by the user, acquires position information of the reference point, accumulates data including the image, the reference line, and the reference point as learning data, trains a learning model of machine learning for estimating the reference line and the reference point from an input image, by using the learning data, inputs an input image to be estimated into the learning model, and outputs information on the estimated reference line and information on the estimated reference point as estimation results by the learning model.

### Advantageous Effects of Invention

According to a representative embodiment of the present disclosure, it is possible to reduce the time and effort and burden of manual operation by a person and improve work efficiency while allowing the person to input and set some of information, regarding techniques such as a dimension measurement system that uses a charged particle beam apparatus to measure the dimensions of a target object from a captured image. It is also possible to reduce the influence of errors caused by manual operation by a person. Problems, configurations, effects, and the like other than those described above will be described in the description of the embodiment of the invention.

### BRIEF DESCRIPTION OF DRAWINGS

FIG. 1 is a diagram showing a configuration example of a system including a dimension measurement system according to Embodiment 1.

FIG. 2 is a diagram showing a configuration example of the dimension measurement system according to Embodiment 1 as a computer system.

FIG. 3 is a diagram showing a configuration example of an SEM in Embodiment 1.

FIG. 4 is a diagram showing the structure, dimensions, or the like of a semiconductor device in Embodiment 1.

FIG. 5 is a diagram showing a process flow of a dimension measurement method according to Embodiment 1.

FIG. 6 is a diagram showing an example of a GUI screen in Embodiment 1.

FIG. 7 is a diagram showing an example of definition information in Embodiment 1.

FIG. 8 is a diagram showing examples of a cross-sectional image and an interface selection GUI in Embodiment 1.

FIG. 9 is a diagram showing examples of a cross-sectional image and an area selection GUI in Embodiment 1.

FIG. 10 is a diagram showing an example of an algorithm for detecting contours in the cross-sectional image in Embodiment 1.

FIG. 11 is a diagram showing an example of an algorithm for detecting contours in the cross-sectional image in Embodiment 1.

FIG. 12 is a graph showing a line profile in Embodiment 1.

FIG. 13 is a diagram showing an example of a case where a second rule is applied to edge candidate extraction in Embodiment 1.

FIG. 14 is a diagram showing an example of a combination of edge candidates in Embodiment 1.

FIG. 15 shows an example of detected contours (edge points and contour lines) in Embodiment 1.

FIG. 16 is a diagram showing an example of contour detection regarding a mask in Embodiment 1.

FIG. 17 is a diagram showing an example of contour detection regarding a pillar in Embodiment 1.

FIG. 18 is a diagram showing an example of measurement target dimensions in Embodiment 1.

FIG. 19 is a diagram showing an example of measuring the area of a structure in Embodiment 1.

FIG. 20 is a diagram showing an example of a GUI screen displaying a dimension measurement result in Embodiment 1.

FIG. 21 is a diagram showing examples of a cross-sectional image or the like when dust is attached in Embodiment 1.

FIG. 22 is a diagram showing examples of an image of etching target pattern and an image after actual processing in Embodiment 1.

FIG. 23 is a diagram showing an example in which a plurality of area reference points or the like are designated collectively in a cross-sectional image in Embodiment 1.

FIG. 24 is a diagram showing a first example of setting two interface reference lines in a cross-sectional image in Embodiment 1.

FIG. 25 is a diagram showing a second example of setting two interface reference lines in a cross-sectional image in Embodiment 1.

FIG. 26 is a diagram showing an example of a GUI screen for an interface reference line adjustment function, as Modification 1 of Embodiment 1.

FIG. 27 is a diagram showing a cross-sectional image or the like in a case where a reference line is set to a part other than an interface, as Modification 2 of Embodiment 1.

FIG. 28 is a diagram showing another method of setting a line profile as Modification 3 of Embodiment 1.

FIG. 29 is a diagram showing a method of setting a dimension measurement target line using an area reference point, as Modification 4 of Embodiment 1.

FIG. 30 is a diagram showing a method of setting on/off of a dimension measurement target using an area reference point, as Modification 5 of Embodiment 1.

FIG. 31 is a diagram showing a method of setting a horizontal line profile in a dimension measurement system of Embodiment 2.

FIG. 32 is a diagram showing a method of setting a radial line profile in a dimension measurement system 2 of Embodiment 3.

FIG. 33 is a diagram showing a configuration example of an estimation system according to Embodiment 4 as a computer system.

FIG. 34 is a diagram showing the input/output configuration of a learning model in Embodiment 4.

FIG. 35 is a diagram showing the configuration of the learning model in Embodiment 4.

FIG. 36 is a diagram showing a learning process flow in Embodiment 4.

FIG. 37 is a diagram showing an example of a GUI screen for an estimation function in Embodiment 4.

FIG. 38 is a diagram showing the input/output configuration of a learning model in a modification of Embodiment 4.

FIG. 39 is a diagram showing the input/output configuration of a learning model in a modification of Embodiment 4.

FIG. 40 is a diagram showing an example of a GUI screen in a modification of Embodiment 4.

FIG. 41 is a diagram showing a configuration example of a dimension measurement system according to Embodiment 5 as a computer system.

FIG. 42 is a diagram showing a dimension measurement process flow in Embodiment 5.

FIG. 43 is a diagram showing an example of setting points and lines for supporting contour detection on an image, in Comparative Example 1 of the embodiment.

FIG. 44 is a diagram showing an example of setting points and lines for supporting dimension measurement on an image, in Comparative Example 2 of the embodiment.

### DESCRIPTION OF EMBODIMENTS

Hereinafter, embodiments of the present disclosure will be described in detail with reference to the drawings. In the drawings, the same parts are generally given the same reference numerals and repeated descriptions are omitted. In the drawings, the representation of components may not depict their actual positions, sizes, shapes, ranges, or the like in order to facilitate understanding of the invention.

For the purpose of description, when describing processing by a program, the program, function, processing unit, or the like may be described as the main subject, but the main hardware subject for these is a processor, or a controller, device, computer, system, or the like configured with that processor, or the like. The computer executes processing according to a program read into a memory by using a processor, while appropriately using resources such as memory and a communication interface. This allows predetermined functions, processing units, or the like to be implemented. The processor is, for example, a semiconductor device such as a CPU/MPU or a GPU. The processing is not limited to software program processing, but can also be implemented using dedicated circuits. The dedicated circuit may be an FPGA, an ASIC, a CPLD, or the like.

The program may be pre-installed as data in the target computer, or may be distributed as data from a program source to the target computer. The program source may be a program distribution server on a communication network, or a non-transitory computer-readable storage medium, such as a memory card or a disk. The program may include a plurality of modules. The computer system may include a plurality of apparatuses. The computer system may be a client-server system, a cloud computing system, an IoT system, or the like. The various types of data and information are configured in structures such as, but not limited to, tables and lists. Expressions such as identification information, identifier, ID, name, number, or the like are interchangeable.

### Problems or the Like

Problems or the like will be additionally described. In recent years, device structures have been miniaturized to improve the performance of semiconductor devices, and device structures, such as Fin-Field Effect Transistors (FETs) and 3D-NAND, are becoming increasingly three-dimensional and complex. The dimensions of such advanced devices are on the order of nanometers (nm), and the film structures between structures require processing precision on the order of sub-nm.

Semiconductor devices are generally fabricated by combining and repeating processes such as lithography, etching, film formation, and planarization. For example, in the etching process, as processing becomes more difficult, efforts are being made to optimize etching conditions by combining post-processing dimensional data with machine learning, requiring technique to measure precise dimensions quickly and in large quantities.

As a method for precise dimension measurement, charged particle beam apparatuses such as SEM and TEM are often used. This is because charged particle beam apparatuses use charged particle beams with wavelengths shorter than that of light, and are therefore capable of observing sub-nm order microstructures with high resolution, which cannot be observed with an optical microscope.

When comparing SEM and TEM as measurement means, observation with a TEM requires pretreatment with a focused ion beam (FIB) device. Therefore, when it is desired to perform cross section observation and dimension measurement in a shorter time, a method of observing the cross section of a cleaved sample after etching by using an SEM may be selected.

However, when the structure of the measurement target partially collapses due to damage caused by cleavage or contamination or has dust or other particles attached, from the cross section of a cleaved sample, a structure different from the original structure formed in the etching process may be observed. When measuring the dimensions of a structure having such artifacts due to cleavage, there is a risk of unintended feedback being performed when feedback is given to the etching conditions based on the dimension measurement result. Therefore, it is necessary to measure the dimensions of only structures that have been normally cleaved, in other words, only structures excluding collapsed or contaminated portions.

In addition, in dimension measurements during an etching process, the processing depth of a target etching layer (for example, trench depth) is often measured based on the interface between the mask layer and the target etching layer (for example, a Si layer). Therefore, it is also important to detect the position of such an interface (in other words, a material interface or a reference interface).

However, it is difficult to determine the normality of a structure such as the cross section of a cleaved sample or to accurately detect the interface position by using the image processing methods such as template matching in the related art. Therefore, in the related art, the normality of a dimension measurement target structure has been left to the subjective determination of an operator who measures the dimensions.

Furthermore, even when a normal dimension measurement target structure and an accurate reference interface position are determined, there remains a problem in terms of accuracy in the measurement work after the determination. When observing the cross section of a cleaved sample with an SEM, a white shadow-like area (hereinafter referred to as a “white band”) appears in the captured image at the boundary between the device structure (for example, a pillar) and the vacuum area which is the open portion, that is, in the area near the contour of the device structure. This white band is a portion of pixels with high luminance on the image, and is generated, for example, by the influence of secondary electrons from a structure in the depth direction relative to the captured image. Therefore, it is difficult to automatically detect the contour of the device structure from the image by image processing such as binarization. That is, there is a problem with the efficiency and accuracy of detecting the contour or edge of the device structure.

Therefore, the dimension measurement of cross-sectional SEM images in the related art is likely to be performed by manual operation and determination by an operator as a person, which takes a lot of time and effort. Another problem is that each operator will have errors in their manual operations and determinations, resulting in different degrees of precision and accuracy in contour detection and dimension measurement.

For example, PTL 1 describes an example in which the cross-sectional structure of a magnetic head device is observed by SEM to measure dimensions such as the height and sidewall angle of the structure. In PTL 1, for a single magnetic head structure, by designating an edge reference line and a plurality of edge points on an SEM image by user input, an approximate straight line for each edge of the structure is calculated, and used for measuring dimensions and calculating the sidewall angle of the structure.

In the case of a method in which the user inputs and sets some of the information required for contour detection and dimension measurement as described above (the second technique described above), the number of input operations by the user increases, which takes a lot of time and effort. When a cross-sectional SEM image contains a plurality of target structures, the number of input operations required by the user will be the product of the number of target structures and the number of measurement dimension types (for example, width, height, or the like). When performing dimension measurements on a plurality of samples or a plurality of complex structures, this increases the burden on the user and reduces work efficiency.

In particular, in dimension measurements after etching, it is necessary to measure various dimensions of the remaining mask pattern, various dimensions of the trench portion dug by etching, and various dimensions of the fin- or pillar-type structure directly below the mask pattern. In such cases, there is a demand for automation of contour detection and dimension measurement of target structure patterns from cross-sectional images, reduction in the burden of inputting manual operation by users, and improvement in work efficiency.

### [First and Second Techniques]

In a semiconductor device manufacturing process in the related art, structures such as masks, pillars, trenches, or the like (which may also be referred to as structures, patterns, or the like) are formed on a wafer by processing such as deposition and etching. In the manufacturing process, it is necessary to check and inspect whether the three-dimensional structure obtained as a result of such processing is appropriate. In this case, as described above, a cross section of the structure is fabricated by means of, for example, cleavage or FIB processing, and an image of the cross section is captured by means of, for example, an SEM. A computer system and an operator perform processes and tasks such as length measurement and observation on the cross-sectional images to check and inspect whether the shape of the structure is appropriate.

For this, it is necessary to determine and detect the contour or edges of the structure from the cross-sectional image and measure its dimensions. In order to make such processing and work more efficient, automation or high-efficiency through computer systems is required. However, as described above, it is difficult to fully automate the process for detecting the contours of a structure from cross-sectional images and measuring the dimensions of the structure.

In the related art, in the first technique described above, when a computer system is used to fully automatically detect the contour of a target structure from a cross-sectional SEM image and measure its dimensions, the contour detection process is difficult, making it difficult to detect the contour efficiently and accurately. Therefore, as the second technique described above, there is a method in which a user manually inputs and sets some of the information for supporting the processes of contour detection and dimension measurement by a computer system, from a cross-sectional SEM image. For example, reference lines or points are designated and set on the cross-sectional image. Using information on the set lines, points, and the like, the computer system performs contour detection and dimension measurement processes on the cross-sectional image. Such a method is a method (a general term including methods, devices, or the like) that combines manual operation and automatic processing, and for the sake of description, such method may be referred to as a semi-automatic method.

### Comparative Example 1

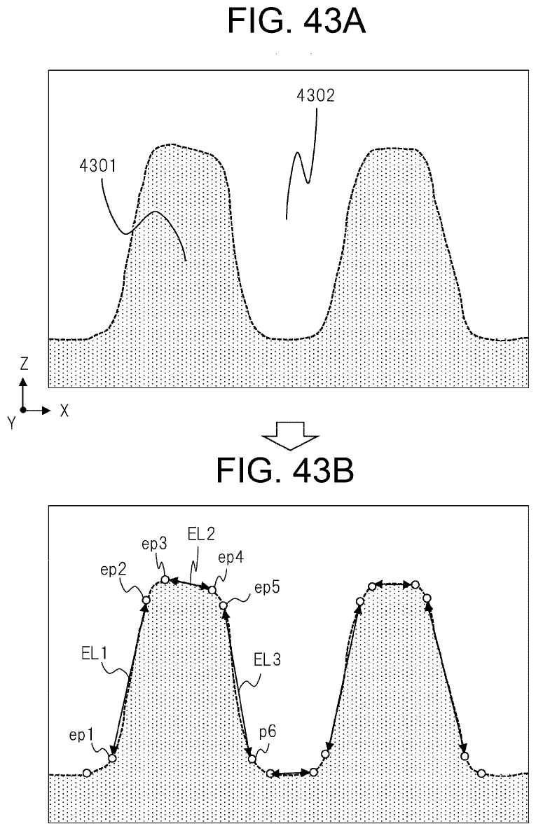

FIG. 43 is an explanatory diagram of a technique of Comparative Example 1 of the embodiment. The technique of Comparative Example 1 corresponds to the technique of PTL 1. The technique of Comparative Example 1 involves a user manually setting points, lines, and the like that serve as support for contour detection on a cross-sectional image. (A) in FIG. 43 is a schematic diagram of an example of a cross-sectional image, showing areas of pillars 4301 and trenches 4302 having roughly trapezoidal shapes on a vacuum background (shown in white in the schematic but black in luminance). (B) in FIG. 43 shows an example in which a user manually inputs and sets points and lines to support contour detection on the image of (A). In this example, the user sets edge points ep1 to ep6 on the edges of the trapezoid of pillar 4301. In other words, the user sets edge lines EL1 to EL3 (corresponding to the “edge reference line” in PTL 1) on the edges of the trapezoid of the pillar 4301. For example, a straight line connecting the edge point ep1 serving as the start point and the edge point ep2 serving as the end point becomes the edge line EL1.

The computer system determines the edges that form the contour of the pillar 4301 by using the set edge points ep1 to ep6 or edge lines EL1 to EL3. For example, the computer system detects the edge of the pillar 4301 by referring to the luminance profile in the vertical direction on the edge line EL1 and searching for luminance on the luminance profile. The computer system determines an approximate straight line for the contour by connecting the plurality of detected edges. The computer system measures the dimensions of the structure pattern, such as the width and height of the pillar 4301, based on the information on the detected contour.

In Comparative Example 1, it is necessary to input and set at least two edge points for each edge of a structure in an image, for example, a trapezoid pattern, as the manual operation of the user, the number of inputs. Therefore, as the number of structures such as pillars 4301 and the number of types of dimensions to be measured increase, the time and effort of manual operation by the user increases. Moreover, the more complicated the pattern shape, the more time and effort are required.

Comparative Example 1 can be considered as a technique in which a user inputs and sets lines, points, and the like for support by tracing the contour or edge of a structure pattern in an image. Such techniques require a lot of time and effort of manual operation. Furthermore, since this is a manual operation, the user may not always be able to accurately set lines or points for support relative to the contours or edges of the structure pattern on the image, and errors may occur for each user.

### Comparative Example 2

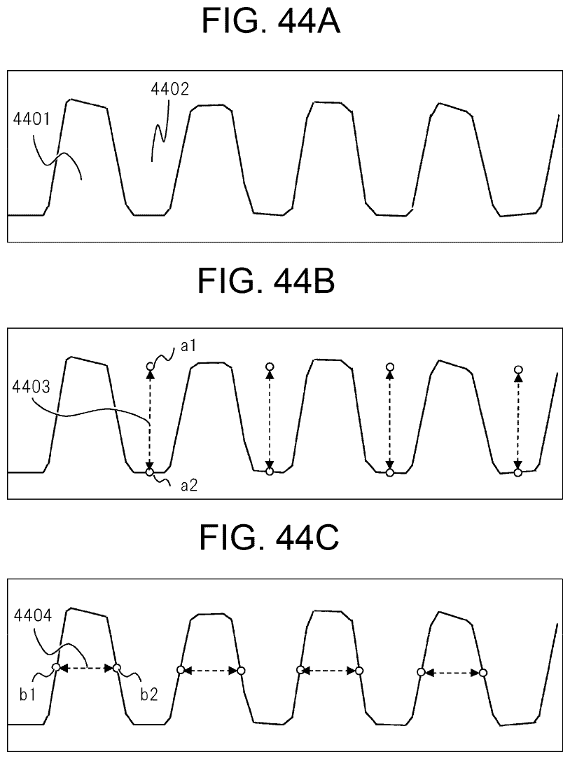

FIG. 44 shows Comparative Example 2 as another example in the prior art. The technique of Comparative Example 2 involves a user manually setting lines, points, and the like to support dimension measurement on a cross-sectional image. (A) in FIG. 44 shows a schematic diagram of an example of a cross-sectional image, which has, for example, four pillars 4401 and four trenches 4402. In Comparative Example 2, the user directly and manually inputs and sets the location where the user wants to measure the dimensions of a structure pattern in a cross-sectional image, for example, a pillar 4401 or a trench 4402 having a roughly trapezoidal shape, that is, the position that defines the measurement target dimensions.

For example, (B) in FIG. 44 shows a case where the trench depth is measured. When it is desired to measure the trench depth, the user determines and designates, for each trench 4402, the two end points (points a1, a2) that define the trench depth (and the corresponding dimension measurement target line 4403) as the dimension measurement target locations. For example, a mouse is clicked for each point. The point a1 indicates the top of the trench 4402, and the point a2 indicates the bottom of the trench 4402. One end of the dimension measurement target line 4403 is the point a1, and the other end is the point a2. Thereafter, the computer system measures the location of the dimension measurement target line 4403 defined by the two designated points (points a1 and a2) as the trench depth. In other words, the two points are the start point and the end point of the dimension.

Similarly, in (C) in FIG. 44, when it is desired to measure the pillar width, the user determines and designates, for each pillar 4401, the two end points (points b1, b2) that define the pillar width (and the corresponding dimension measurement target line 4404) as the dimension measurement target locations. The point b1 is a point on the left sidewall of the pillar 4401, and the point b2 is a point on the right sidewall of the pillar 4401. One end of the dimension measurement target line 4404 is the point b1, and the other end is the point b2. Thereafter, the computer system measures the location of the dimension measurement target line 4404 defined by the two designated points (points b1 and b2) as the pillar width.

In this way, in Comparative Example 2, the user needs to perform an operation of inputting at least two points for each target structure pattern, each dimension measurement target location, and each dimension type. Therefore, in Comparative Example 2, similar to Comparative Example 1, as the number of target structures or the dimension types increase, the time and effort of the manual operation by the user increase. Furthermore, errors occur due to manual operations (such as mouse operation) and subjective determination by a person. The two points designated by the user for the dimension measurement target location and dimension (for example, trench depth) may deviate from the actual situation, and individual differences may also occur. Such errors affect the accuracy of the dimension measurements.

### Solution or the Like

In consideration of the above problems, the dimension measurement system and the like according to the embodiments have the following solutions.

The dimension measurement system of the embodiment has a processor and memory resources, and performs processing related to contour detection and dimension measurement on an image (in other words, a cross-sectional image, a target image, a captured image, or the like) captured by a charged particle beam apparatus such as an electron microscope so as to capture the cross-sectional structure of a semiconductor device which is a sample. The processor executes processing according to the dimension measurement method of the embodiment on data and information such as images stored in the memory resource.

The dimension measurement system of the embodiment is a system employing a semi-automatic method that combines a method in which predetermined information such as reference lines and reference points for supporting contour detection and dimension measurement is input, designated, and set for cross-sectional images through a manual operation by a person such as a user and an automatic method in which contour detection and dimension measurement processes are performed on the cross-sectional images for which the predetermined information has been set, through an automatic process by a computer. The embodiment has a feature of such a semi-automatic method. Note that a system or method, in which material interfaces or dimension measurement target structure areas are designated and selected by manual operations, and contour detection and dimension measurement are automatically performed, may be referred to as a “semi-automatic method”.

The dimension measurement method of the embodiment includes: a step of designating a location such as a material interface that is difficult to automatically detect or recognize as a reference line (in other words, an interface reference line, a support line, or the like) on a cross-sectional image, based on a manual operation by a person such as a user; and a step of designating an area of a structure pattern of a dimension measurement target, which is difficult to automatically detect or recognize as a reference point (in other words, an area reference point, a support point, or the like) on the cross-sectional image, based on a manual operation by the user. These steps involve manual operations by a person. The dimension measurement method according to the embodiment includes a step of automatically detecting the contour of the structure pattern of the dimension measurement target in an image in which the reference line and reference point are set, and a step of automatically measuring the dimension of the measurement target, based on information on the detected contour. These steps involve computer automatic process.

In the dimension measurement system and method according to the embodiment, first, as the features of the manual setting method, for a cross-sectional image, by a user's manual operation on the GUI screen, for a material interface of a target structure, an interface reference line, which is a reference line for indicating the material interface, is designated and also an area reference point, which is a reference point for indicating a dimension measurement target structure area, is designated. Such manual operation steps are implemented as a new user interface that differs from examples in the prior art. This reduces the amount of input data, reduces the time and effort or burden on the user, and also reduces errors caused by manual operations by the user.

In the dimension measurement system and method according to the embodiment, next, as the features of the automatic method, for the cross-sectional image for which predetermined information has been set as described above, a computer system specifies an area of a target structure pattern, based on the reference lines and reference points, and detects the edges that configure the contour of the target structure pattern, through processes using a predetermined algorithm.

Then, the computer system measures a designated type of dimensions in the area of the structure pattern of dimension measurement target, based on the reference lines and reference points, and information on the detected contour. The type of dimension to be measured (for example, trench width, trench depth, or the like) can be set and designated by the user on the GUI screen.

The computer system displays at least one of the information on the detected contour and the dimension measurement results on the GUI screen for the user.

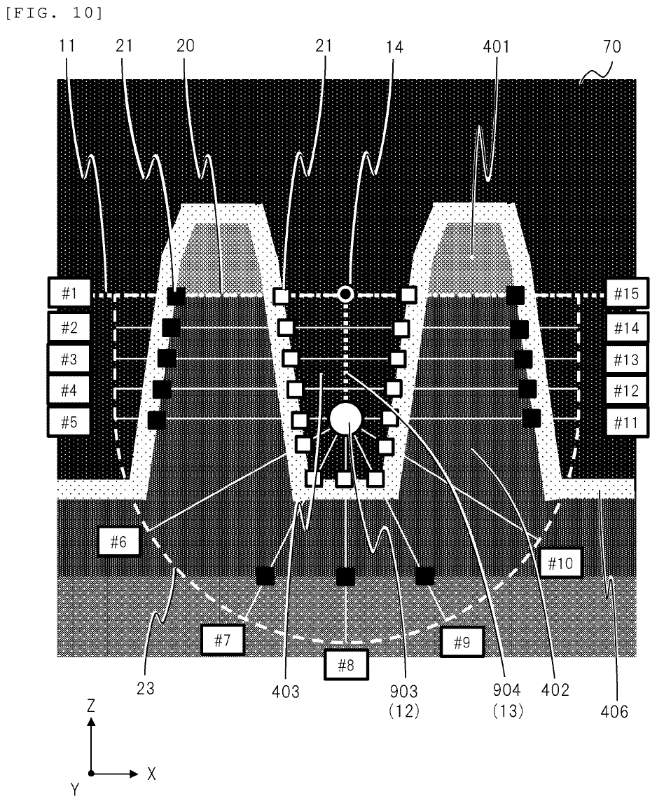

The algorithm for the above-described contour detection process is a new one that differs from examples in the prior art (see FIG. 10 or the like described later), and can detect the contour of a structure more efficiently and accurately. The computer system can then more efficiently and accurately measure the dimensions of a target, based on the information on the detected contour.

### Embodiment 1

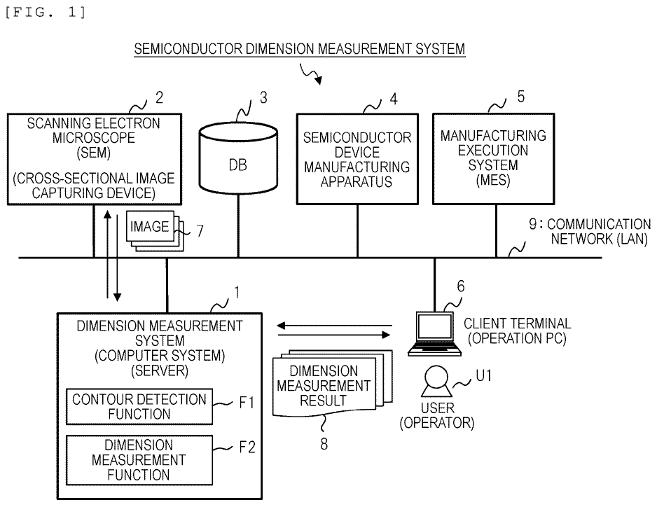

A dimension measurement system and method according to Embodiment 1 will be described with reference to FIG. 1 or the like.

### [Semiconductor Dimension Measurement System]

FIG. 1 shows a configuration example of a semiconductor dimension measurement system which is a system including the dimension measurement system according to Embodiment 1. The entire system in FIG. 1 is the semiconductor dimension measurement system, and includes a scanning electron microscope (SEM) 2 and a computer system 1 which is the dimension measurement system 1 of Embodiment 1. In the configuration example of the system in FIG. 1, a database (DB) 3, semiconductor device manufacturing apparatus 4, a manufacturing execution system (MES) 5, a client terminal (operation PC) 6, and the like are provided on a communication network 9. These components are connected to each other via the communication network 9, for example a LAN, and are capable of communicating with each other. The computer system 1 which is the dimension measurement system 1 according to Embodiment 1 is configured as a server on the communication network 9, and is connected via communication to devices such as a scanning electron microscope (SEM) 2 and the operation PC 6.

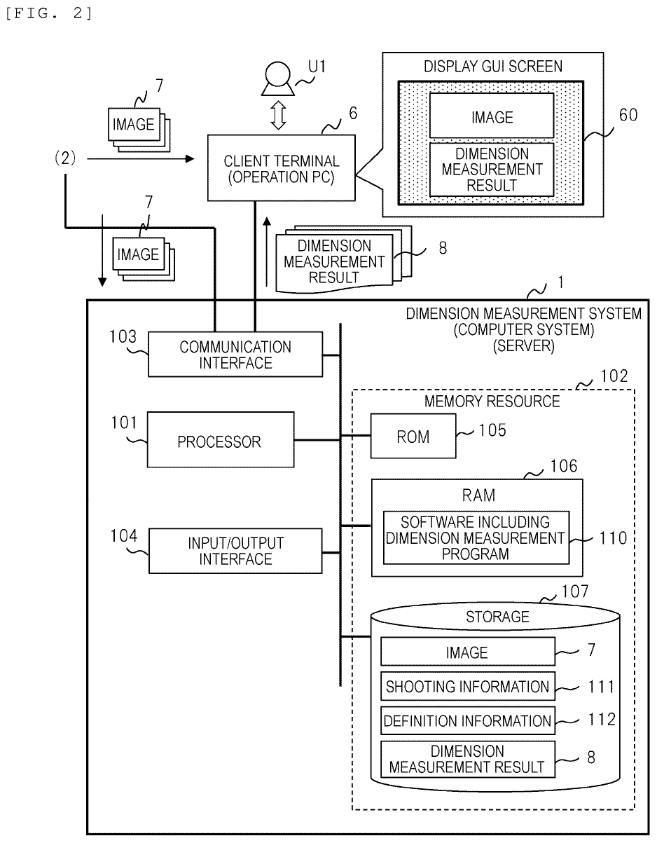

The dimension measurement system 1 of Embodiment 1 is configured by the computer system 1 described later (FIG. 2). This computer system 1 implements the functions of the dimension measurement system 1, based on program processing by a processor. The dimension measurement system 1 has, as functions, at least a contour detection function F1 and a dimension measurement function F2. The contour detection function F1 is a function of detecting the contour of a structure (in other words, a pattern) from an image 7 which is a cross-sectional image of a target sample. The dimension measurement function F2 is a function of measuring the dimensions of a target based on the information on the contour detected by the contour detection function F1, and outputting a dimension measurement result 8.

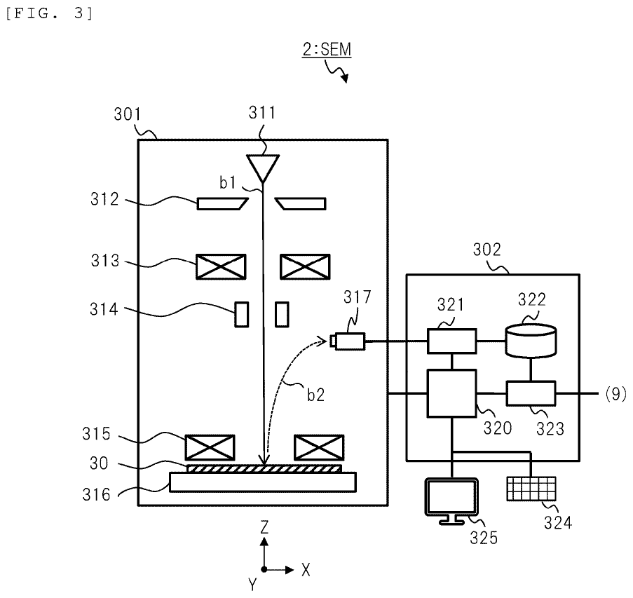

The SEM 2 is an example of a cross-sectional image capturing device. The SEM 2 has a function of obtaining, as the image 7, a cross-sectional image obtained by capturing an image of a cross section of a semiconductor device (for example, a wafer) that is a target sample. As shown in FIG. 3 which will be described later, the SEM 2 includes a main body 301 and a controller 302 connected to the main body 301.

The SEM 2 or other components may have a function of fabricating a cross section of the target sample. For example, the SEM 2 may be an apparatus having a function of fabricating a cross section of the target semiconductor device. For example, the SEM 2 may be an FIB-SEM device equipped with a focused ion beam mechanism. The FIB-SEM apparatus fabricates a cross section of a part of a sample by FIB processing. In addition to the SEM 2, there may be another apparatus having a function of fabricating a cross section. For example, a cleaving apparatus that fabricates a cross section by cleaving a sample may be provided on the communication network 9.

The SEM 2 and the computer system 1 may appropriately communicate with external devices to input and output necessary data and information. For example, the SEM 2 transmits data of the image 7 obtained by photographing to the computer system 1 or the operation PC 6. Alternatively, the SEM 2 may store the data of the image 7 in the DB 3. In this case, the computer system 1 acquires the image 7 from the DB 3. The DB 3 is, for example, a DB server, and may store various types of information such as the data of the image 7 and design data.

The semiconductor device manufacturing apparatus 4 is an apparatus for manufacturing semiconductor devices, which are target samples, and includes an apparatus for each manufacturing process, such as an etching apparatus. The MES 5 is a system for executing and managing the manufacture of semiconductor devices using the semiconductor device manufacturing apparatus 4, and has sample design data, manufacturing process information, and the like. The computer system 1 may refer to the design data, the manufacturing process information, and the like from the MES 5, the semiconductor device manufacturing apparatus 4, and the like.

The client terminal 6 is an operation PC used by a user U1, and is an information processing terminal device having a function of accessing the dimension measurement system 1 (particularly, the server function) via the communication network 9. The user U1 such as an operator may directly operate the dimension measurement system 1, or may use the dimension measurement system 1 by accessing the system from the client terminal 6. The client terminal 6 can be a general PC or the like, and has an input device for input operations and an output device for display or the like built-in or externally connected. The user U1 may access and use the SEM 2 or the like from the client terminal 6.

In Embodiment 1, the server which is the dimension measurement system 1 is configured as a client-server system with the client terminal 6. The dimension measurement system 1 is responsible for the main processing, and the client terminal 6 is responsible for the function as a GUI. The computer system 1 and the client terminal 6 may be integrated into one system. That is, the computer system 1 may have input/output and GUI functions.

The dimension measurement system 1 of Embodiment 1 is not limited to the configuration example of FIG. 1. For example, the dimension measurement system 1 may be integrated into the controller 302 (FIG. 3) of the SEM 2. The dimension measurement system 1 may be integrally mounted on other components shown in FIG. 1. The computer system 1 is not limited to a single computer, and may be implemented as a cloud computing system or the like.

The present invention is not limited to the example shown in FIG. 1, and may have, as an example of an external device which is another component, a cross-section observation device which observes a cross section of a sample and performs analysis, inspection, or the like The cross-section observation device may be, for example, a TEM device. Alternatively, the SEM 2 may be used as a cross-section observation device. The SEM 2 may be a scanning transmission electron microscope (STEM) or other type of microscope or image capturing device.

The communication network 9 may be provided with a program distribution server (not shown). The program distribution server distributes data such as a program for implementing the dimension measurement system 1 of Embodiment 1 (software 110 in FIG. 2) to the computer system 1. Furthermore, data such as the image 7 and programs are not limited to be input and output via communication but may be input and output in a form stored in a storage medium such as a memory card.

### [Computer System]

FIG. 2 shows a configuration example of the dimension measurement system 1 according to Embodiment 1 as the computer system 1. The computer system 1 includes predetermined hardware and software, which work together to implement functions. The computer system 1 in FIG. 2 includes a processor 101, a memory resource 102, a communication interface 103, an input/output interface device 104, and the like. These components are connected to a bus and can communicate with each other. The memory resource 102 includes a ROM 105, a RAM 106, a storage 107, and the like.

The processor 101 is configured by a semiconductor device such as a CPU, an MPU, or a GPU. The processor 101 may include a ROM, a RAM, various peripheral functions, and the like. The processor 101 executes processes according to a control program stored in the memory resource 102, for example, software 110 including a dimension measurement program that is read from the ROM 106 or storage 107 to the RAM 105 and loaded therein. Thus, the contour detection function F1, the dimension measurement function F2, and the like in FIG. 1 are implemented as predetermined functions. The software 110 controls all the functions and operations described in Embodiment 1. When the computer system 1 is started, an execution module based on the processor 101 and the software 110 operates.

The storage 107 stores various types of data and information, such as the image 7, shooting information 111, definition information 112, and dimension measurement results 8. The image 7 is image data or the like acquired from the SEM 2. The dimension measurement result 8 is data such as the dimension measurement result by the dimension measurement function F2. The shooting information 111 is shooting information when the image 7 is photographed by the SEM 2, and includes, for example, the photographing conditions and optical setting information of the SEM 2, attribute information of the image 7, and the like. The shooting information 111 includes at least information on pixel size, which is the size in real space per pixel in the image 7, or information such as a magnification with which the pixel size can be calculated.

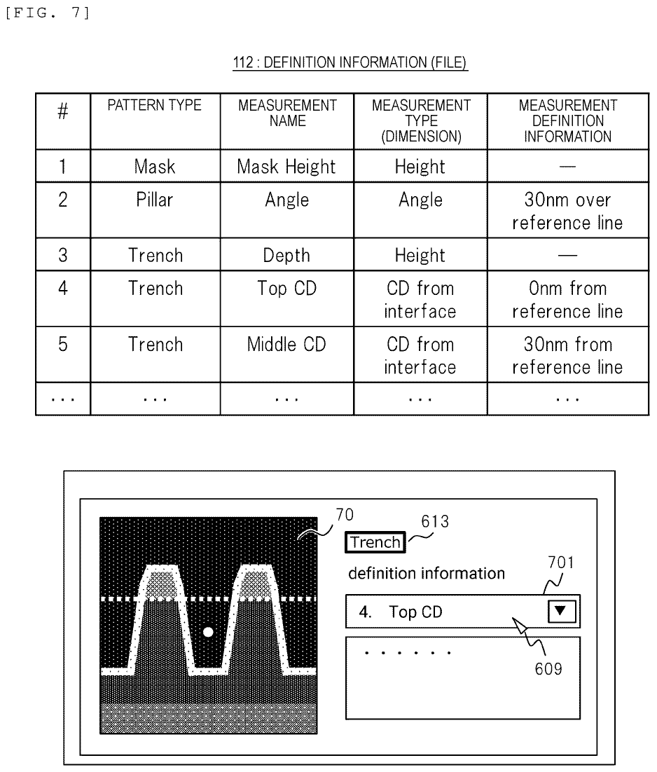

The definition information 112, which will be described later (FIG. 7, or the like), is definition information and setting information required for the functions of the dimension measurement system 1, and includes system setting information, user setting information, and the like. Additionally, the memory resource 102 stores data and the like that are generated during the processing as appropriate. The dimension measurement system 1 may use external memory resources (for example, the DB 3 or an external storage device) as appropriate.

In the computer system 1, for example, data such as the image 7 acquired from the SEM 2, the DB 3, or the operation PC 6 in FIG. 1 is stored in advance in the storage 107. The image 7 is managed in association with the shooting information 111, the definition information 112, the dimension measurement results 8, and the like.

The communication interface 103 is a device in which a communication interface for the SEM 2, the communication network 9, or the like is mounted. The input/output interface 104 is a device in which an input/output interface is mounted, and allows external input devices and output devices to be connected. Examples of input devices include a keyboard, a mouse, and a microphone. Examples of output devices include a display, a printer, and a speaker. The computer system 1 may include built-in input and output devices.

Based on input such as instructions from the user U1 on the GUI screen 60, the computer system 1 uses the input image 7, shooting information 111, and definition information 112 of the dimension measurement target to detect contours of the structure pattern in the image 7 of the target, measures the designated type of dimension, and generates and stores the dimension as dimension measurement result 8. Then, the computer system 1 transmits the dimension measurement result 8 to the operation PC 6. The operation PC 6 displays the image 7 and the dimension measurement result 8 together with the GUI on a GUI screen 60. The user U1 can check the dimension measurement results 8 and the like on the GUI screen 60.

The user U1, such as an operator, uses the computer system 1 through the operation of the input device and the display of a screen on the output device of the client terminal 6, which is an operation PC. Although not shown, the operation PC 6 includes a processor, a memory, a communication interface, a monitor display, a mouse, a keyboard, and the like. The GUI screen 60 is displayed on the screen of the monitor display.

Client-server communication is performed between the computer system 1 and the client terminal 6, and the following communications and operations are performed, for example. The user U1 operates the client terminal 6 to access the computer system 1. The client terminal 6 accesses the server function of the computer system 1 through the communication network 9 and sends a request. In response to the request, the server function of the computer system 1 generates screen data including a Graphical User Interface (GUI) and transmits the screen data to the client terminal 6. The screen data may be a Web page or the like. Alternatively, instead of the screen data, the data/information on the target may be directly transmitted and received. The client terminal 6 displays the GUI screen 60 such as a web page on the display screen, based on the received screen data, or the like. The user U1 views the GUI screen 60, checks information about the functions of the dimension measurement system 1, and inputs settings, instructions, or the like as necessary.

The client terminal 6 transmits requests and information based on user input information to the computer system 1. The computer system 1 executes processing related to the function, based on the received request or information, and stores the results. The computer system 1 transmits screen data including, for example, an image 7 and a dimension measurement result 8 to the client terminal 6. The client terminal 6 displays the GUI screen 60 including the image 7, the dimension measurement result 8, and the like, based on the received data. The user U1 can view and check the image 7, the dimension measurement results 8, and the like on the GUI screen 60.

Although FIG. 1 shows one user U1 and one client terminal 6, a plurality of users and a plurality of client terminals 6 may exist in this system. The number of computer systems 1 and processors 101 is not limited to one physically, and there may be a plurality of computer systems and processors 101.

### [SEM]

FIG. 3 shows a configuration example of the SEM 2. The SEM 2 mainly includes the main body 301 of the SEM and the controller 302 connected to the main body 301. The main body 301 further includes an electron optical column (hereinafter referred to as the “column”) and a sample chamber provided below the column. The controller 302 is a system that controls the imaging performed by the main body 301. The controller 302 includes an overall control unit 320, a signal processing unit 321, a storage unit 322, a communication interface 323, or the like, and is also externally connected to an input device 324 and an output device 325.

The column of the main body 301 includes, as components, an electron gun 311, an acceleration electrode 312, a focusing lens 313, a deflection lens 314, an objective lens 315, a detector 317, and the like. The electron gun 311 emits an electron beam b1, which is a charged particle beam. The acceleration electrode 312 accelerates the electron beam b1 emitted from the electron gun 311. The focusing lens 313 focuses the electron beam b1. The deflection lens 314 deflects the trajectory of the electron beam b1. The objective lens 315 controls the focusing height of the electron beam b1. The sample chamber is a chamber in which samples such as wafers and coupons (broken pieces of wafers) are stored, and is equipped with a stage 316 for moving the observation position on the sample to the irradiation point of the electron beam.

The stage 316 is a sample stage on which a semiconductor device, which is the target sample 30, is placed. The stage 316 has a function of moving not only in the X and Y directions but also in the Z direction, and a function of rotating about the XY, YX, or Z axes, and can move the captured field of view in horizontal and vertical directions relative to the front-facing image, or in a rotational direction within the field of view. Thus, the imaging field of view can be set.

The detector 317 detects particles b2 such as secondary electrons and backscattered electrons generated from the sample 30 irradiated with the electron beam b1 as electrical signals. The detector 317 outputs a detection signal which is an electrical signal.

The overall control unit 320 controls the operations of the controller 302 and the main body 301. The overall control unit 320 issues instructions such as drive control to each unit. Each unit such as the overall control unit 320 can be implemented by a computer or a dedicated circuit. The signal processing unit 321 receives an input of the detection signal from the detector 317, performs processing such as analog/digital conversion to generate an image signal, and stores the image signal in the storage unit 322 as data such as an image. The storage unit 322 can be implemented by a non-volatile storage device or the like. The overall control unit 320 also stores shooting information of an image and the like in the storage unit 322 in association with the image.

The communication interface 323 is a device in which a communication interface for the communication network 9 and the computer system 1 is mounted. For example, in response to the request from the computer system 1, the overall control unit 320 transmits data such as images and shooting information stored in the storage unit 322 to the computer system 1 via the communication interface 323. The computer system 1 stores data such as the image 7 received from the controller 302 of the SEM 2 in the memory resource 102.

### [Semiconductor Device]

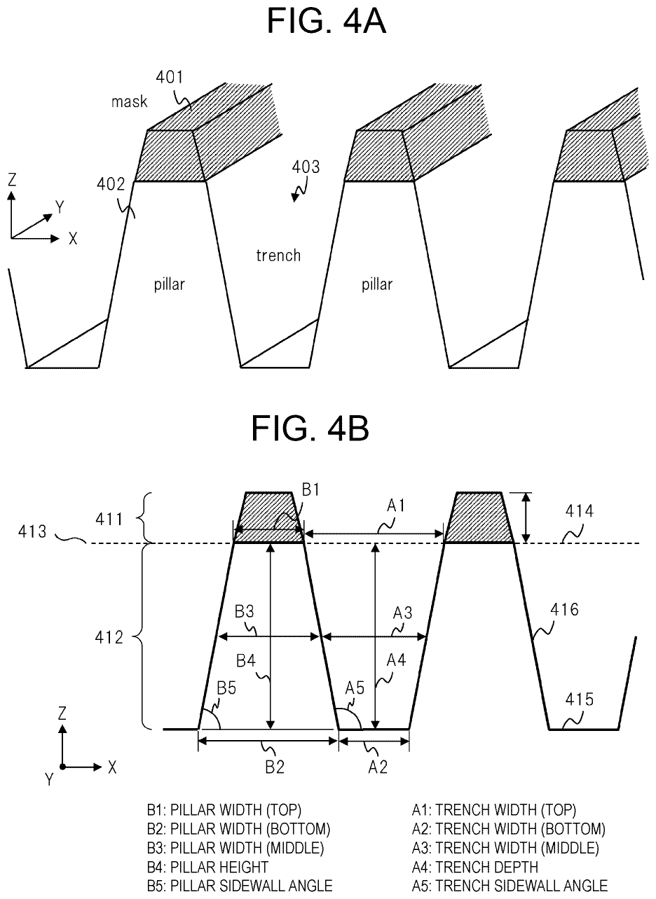

FIG. 4 shows an example of a structure pattern or the like of the semiconductor device which is a target sample in Embodiment 1. (A) in FIG. 4 shows a perspective view of a design pattern shape of a three-dimensional structure, showing, for example, a cross section in the XZ plane. The cross section is formed by, for example, cleaving or FIB processing. The structure includes a mask 401, a pillar 402, and a trench 403. The mask 401 and the pillar 402 are structures having a trapezoidal cross section, and the trench 403 is a structure having an inverted trapezoidal cross section, with the pillar 402 formed below the portion where the mask 401 is present and the trench 403 formed below the portion where the mask 401 is not present.

(B) in FIG. 4 is a cross-sectional view corresponding to the cross section on the XZ plane of (A), and shows examples of dimensions to be measured. The semiconductor device has, in the Z direction, a mask layer 411 formed of a first material on top of a target etching layer 412 formed of a second material. The mask 401 is formed on the mask layer 411, and the pillar 402 and the trench 403 are formed in the target etching layer 412. A material interface 413 between the mask 401 and the pillars 402 in the Z direction is indicated by a dashed line.

Dimension A1 is the trench width at the upper surface (in other words, top) 414 of the trench 403. The position of the upper surface 414 of the trench 403 corresponds to the position of the material interface 413 between the mask 401 and the pillar 402. Dimension A2 is the trench width at the lower surface (in other words, bottom) 415 of the trench 403. Dimension A3 is the trench width, for example, at the middle position (for example, the 50% position) in the height/depth direction (Z direction) of the trench 403. The position of the dimension A3 is not limited to being defined by a percentage (%), but may be defined by the distance from the top 414, the distance from the bottom 415, or the like. The dimensions A1 to A3 are lengths in the X direction.

Dimension A4 is the trench depth, which is the length from the top 414 to the bottom 415 of the trench 403 in the Z direction. Dimension A5 is the trench sidewall angle, for example the angle formed by sidewall 416 (the slope portion of the trapezoid) with the bottom 415 of the trench 403. The trench sidewall angle may be defined as the angle at a predetermined position in the Z direction.

Dimension B1 is the pillar width at the upper surface (in other words, top) of the pillar 402. The position of the top of the pillar 402 corresponds to the position of the material interface 413. Dimension B2 is the pillar width at the lower surface (in other words, bottom) of the pillar 402. The position of the bottom of the pillar 402 corresponds to the position of the bottom of the trench 403. Dimension B3 is the pillar width, for example, at the middle position (for example, the 50% position) in the height direction (Z direction) of the pillar 402. The position of the dimension B3 is not limited to being defined by a percentage, but may be defined by a distance from the top, a distance from the bottom, or the like. The dimensions B1 to B3 are lengths in the X direction.

Dimension B4 is the pillar height, which is the length from the top to the bottom of the pillar 402 in the Z direction. Dimension B5 is the pillar sidewall angle, for example, the angle formed by the sidewall with the lower surface of the pillar 402. The pillar sidewall angle may be defined as the angle at a predetermined position in the Z direction.

The dimension measurement target structure and dimensions are not limited to the example shown in FIG. 4. Examples of other structures include holes and fins. Other examples of dimension include the area of the trench 403, or the like.

### [Dimension Measurement Method]

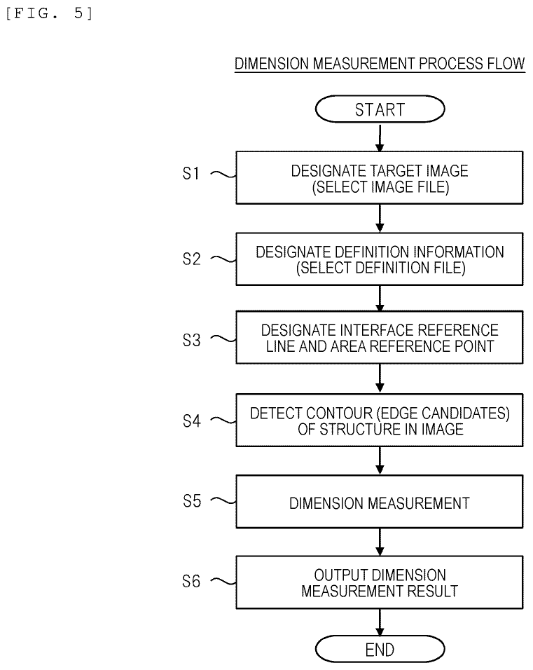

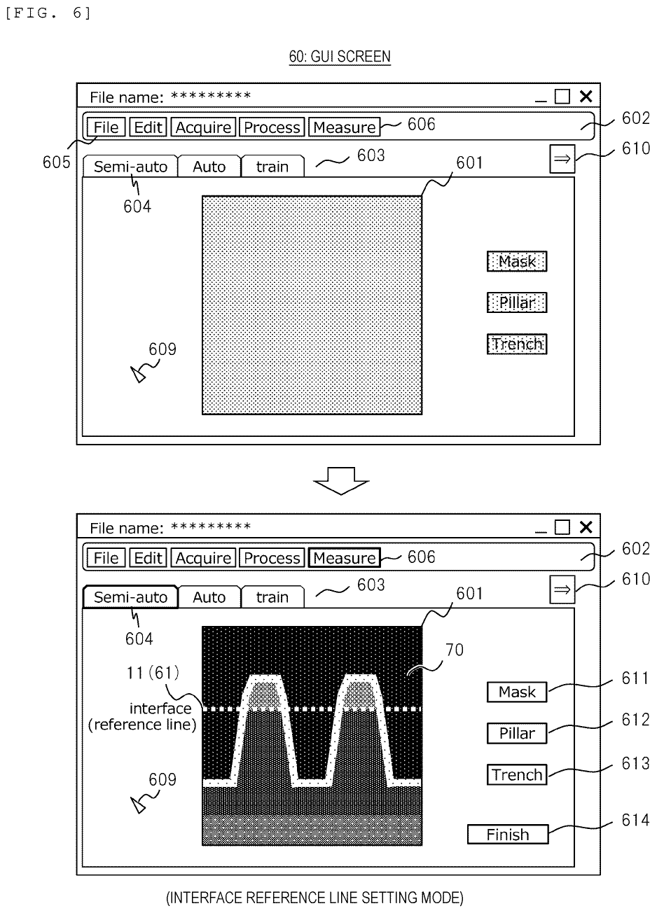

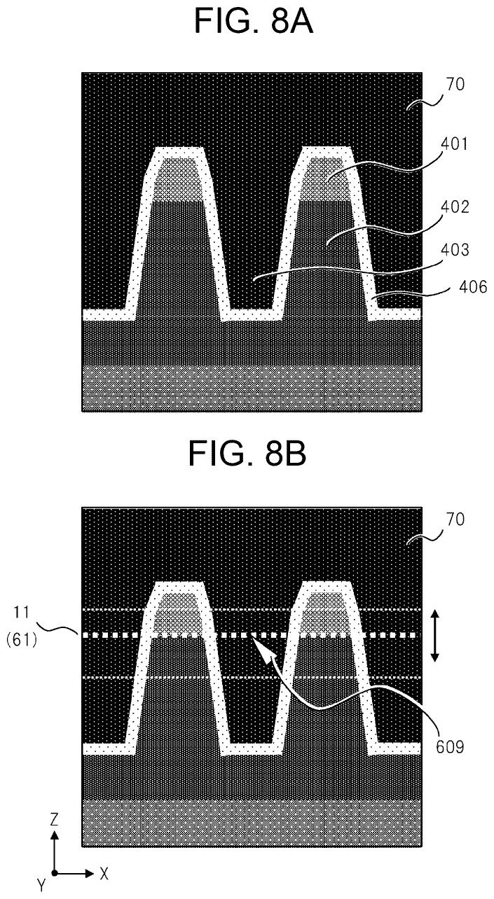

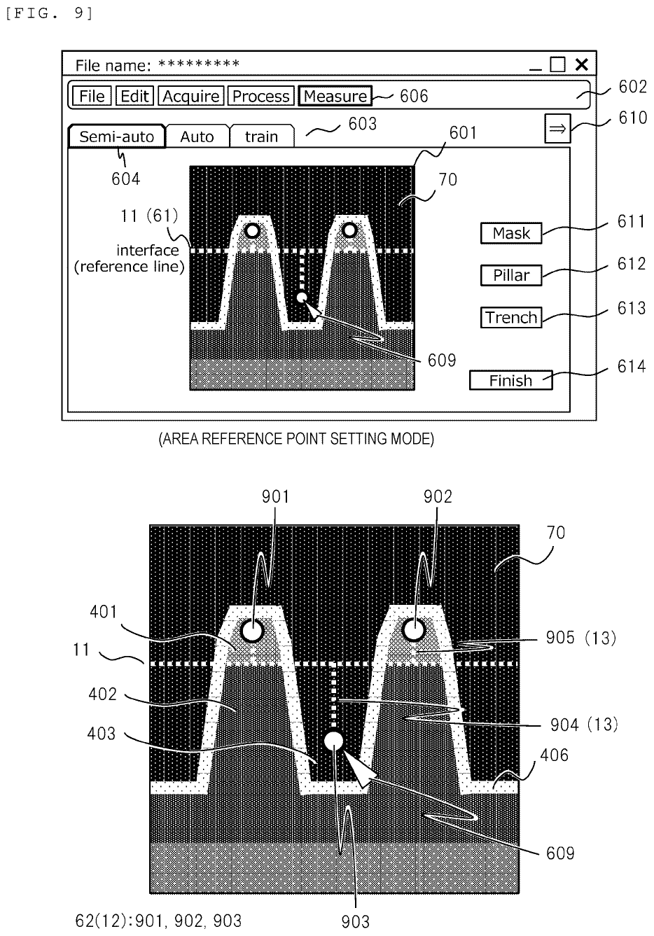

The dimension measurement method according to Embodiment 1 will be described. FIG. 5 shows a flow diagram of a dimension measurement process executed by the computer system 1 which is the dimension measurement system 1 according to Embodiment 1. This flow includes steps S1 to S6. The dimension measurement system 1 executes the dimension measurement method of Embodiment 1 in accordance with the flow shown in FIG. 5. As an overview, the user U1 selects and displays a target image 70 on the GUI screen 60 (FIG. 6) (step S1), and manually designates and sets an interface reference line 11 (FIG. 8) and an area reference point 12 (FIG. 9) (step S3). The computer system 1 specifies the area of the dimension measurement target structure and detects its contour based on those pieces of set information (step S4), measures the designated type of dimension based on the information on the detected contour (step S5), and displays the dimension measurement results 8 on the GUI screen 60 (FIG. 20) (step S6).

In step S1, the computer system 1 designates the image 7 which is a dimension measurement target. In this example, the user U1 operates the mouse or the like of the operation PC 6 to move a cursor 609 on the GUI screen 60 (FIG. 6) and operates the GUI such as menus and buttons to select an image file of the target image 7.

In step S2, the computer system 1 designates the definition information 112 (FIG. 2) to be applied to the current dimension measurement. When the definition information 112 to be applied has been designated and set in advance, it is sufficient to simply refer to that setting. In this example, the user U1 selects the file of the definition information 112 on the GUI screen 60. The definition information 112 may be prepared in advance by the business operator as a part of the software 110 (FIG. 2), or may be set and stored by the user U1 on the GUI screen 60. As described later (FIG. 7), the definition information 112 defines the structure pattern of dimension measurement target, the dimensions to be measured (in other words, the type of dimension), details of the measurement of the dimensions, or the like, to be applied to the target image 7.

In step S3, the computer system 1 designates the interface reference line 11 and the area reference point 12 for the target image 70 on the GUI screen 60 (FIG. 6, FIG. 9, or the like), based on a manual operation of the user U1. A plurality of area reference points 12 can be collectively designated as necessary. In addition, information (also referred to as reference information) such as the position coordinates of the interface reference line 11 and the area reference point 12 set for the image 7 is appropriately stored in the memory resource 102 (FIG. 2). For example, those pieces of reference information are stored as a part of the dimension measurement result 6.

In step S4, the computer system 1 detects the contour of the area of the structure pattern of dimension measurement target within the target image 70, based on the interface reference line 11 and the area reference point 12 designated in step S3 and the definition information 112 to be applied. In Embodiment 1, a distinction is made between contours and edges, and in particular, edges that form a contour are detected. Edges are represented in data structures such as edge points or contour lines. In addition, information about the detected contour (information about edge points and contour line. also referred to as contour information) is also appropriately stored in the memory resource 102 (FIG. 2). For example, those pieces of contour information are stored as a part of the dimension measurement result 8.

In step S5, the computer system 1 measures the designated type of dimension of the target structure by using information on the interface reference line 11 and the area reference point 12 designated in step S3 and the contour information detected in step S4. The computer system 1 stores the data of the dimension measurement result 8 generated as a result in the memory resource 102.

In step S6, the computer system 1 outputs the dimension measurement result 8 to the user U1. The computer system 1 transmits the dimension measurement result 8 to the operation PC 6, thereby causing the image 7 and the dimension measurement result 8 to be displayed on the GUI screen 60.

Details and specific examples of each step will be described below with reference to the drawings.

### [Step S1: Target Image]

First, the GUI screen 60 such as the example shown in FIG. 6 is displayed on the display of the operation PC 6. An initial display state of the GUI screen 60 is displayed in the upper part of FIG. 6, and the state in which the target image 70 is displayed in an image field 601 is displayed in the lower part. The GUI screen 60 includes the image field 601, a toolbar 602, tabs 603, and the like. In the initial display state, since the target image has not yet been designated, no image is displayed in the image field 601. The Tabs 603 such as “Semi-auto” and “Auto” are also not activated.

The user U1 clicks on a “Semi-auto” tab 604, and selects the image file of the dimension measurement target image by using a “File” button 605 on the toolbar 602. The target image is an image 7 desired to be displayed in the image field 601. Operations such as clicking and selecting on the GUI screen 60 can be performed using input devices such as a mouse and keyboard of the operation PC 6 and a GUI corresponding to those operations.

The “Semi-auto” tab 604 is for selecting the “semi-automatic method” as a mode. This “semi-automatic method” mode corresponds to the dimension measurement method of Embodiment 1, and is a method in which the interface reference line 11 and the area reference point 12 are manually designated as described above. The “Auto” and “train” tabs are modes used in Embodiment 4 described below.

When the user U1 wants to measure the dimensions of the target image, the user U1 presses a “Measure” button 606. In response to this operation, the computer system 1 transitions the screen to the state shown in the lower part of FIG. 6. On the screen showing the state on the lower part, the designated target image 70 is displayed in the image field 601. On this screen, buttons such as a “Mask” button 611, a “Pillar” button 612, and a “Trench” button 613 are also activated. The state on the lower part corresponds to the interface reference line setting mode described below. The “Mask” button 611 and the like are buttons provided for each type of structure.

The user U1 clicks one button out of the “Mask” button 611, the “Pillar” button 612, and the “Trench” button 613 depending on the structure pattern of dimension measurement target within the target image 70. These buttons are used to select, for example, a mask 401, a pillar 402, a trench 403, or the like as shown in FIG. 4 as the type of structure pattern for which the interface reference line 11 and the area reference point 12 are to be designated. By designating the type of target structure pattern in this manner, the target and content of processes by the computer system 1 can be limited, making the process easier. When there are other types of structure patterns, other buttons are similarly provided.

For example, when the user U1 in FIG. 1 wants to measure a trench in the target image 70, in other words, wants to set an interface reference line 11 and an area reference line 12 for the trench, the user U1 first presses the “Trench” button 613. Thus, the computer system 1 grasps the type of the structure pattern to be processed.

### [Step S2: Definition Information]

In step S2, a file of the definition information 112 to be applied to the target image 70 is selected. The file of definition information 112 is a file in which definition information, setting information, and the like required for dimension measurement of a target structure pattern are stored for each target structure pattern.

An example of the file of the definition information 112 is shown in a table format at the upper part of FIG. 7. This file has, in the illustrated table, column items such as row number (#), “pattern type”, “measurement name”, “measurement type”, and “measurement definition information”. The “pattern type” item indicates the type (such as the above-described trench) of a target structure pattern of dimension measurement. The “measurement name” item indicates the name of the measurement to be performed. This measurement name represents the target dimension as shown in FIG. 4 described above, and the user U1 can give it any name. The “measurement type” item indicates the type of measurement to be performed. For example, the value “CD from interface” means “Critical Dimension (CD) at a position a predetermined distance from the interface”.

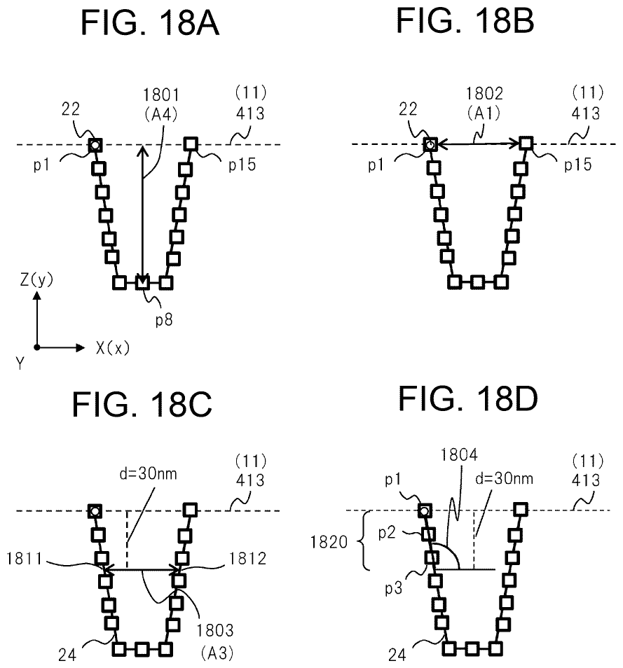

The “measurement definition information” item indicates definition information of measurement for each “measurement type”. For example, the value “0 nm from reference line” means that the length is measured at “a position 0 nm from the interface reference line”. This corresponds to information defining the vertical positions of dimensions A1 to A3, or the like in FIG. 4. The predetermined distance corresponds to, for example, a distance d in (C) in FIG. 18, which will be described later.

The definition information 112 required for length measurement may be set and stored in a file in advance. For example, on the GUI screen 60, it is possible to set a file of the definition information 112, to select a file to be applied, and to reuse the same information for each length measurement. Without being limited thereto, the definition information 112 may be input in step S2 each time a length measurement is performed. In dimension measurement using images of semiconductor devices, dimensions at a determined location of samples of the same structure are likely to be measured repeatedly. When performing such measurements, if setting information related to dimension measurement, such as the measurement position and measurement type information, is set once as definition information 112, in the next and subsequent dimension measurements, it is no longer necessary to set the setting information each time a measurement is performed.

A configuration example of a GUI screen for selecting the definition information 112 is shown in the lower part of FIG. 7. After the target is designated as a trench by using, for example, the “Trench” button 613 for the target image 70, a definition information selection GUI 701 such as a list box is displayed on the GUI screen, and the user U1 can select and apply one or more files of the definition information 112 to be applied, in this example, the definition information of a designated row in the table shown at the upper part. Such a function is implemented by cooperation between the processor 101 and the software 110. Alternatively, a program for selecting the definition information 112 may be stored in the storage provided in the client terminal 6, and the operations shown in the lower part of FIG. 7 may be implemented by the processor in the client terminal 6. Furthermore, when a program for editing the definition information 112 is stored in the client terminal 6, the definition information 112 can be set in advance on the client terminal 6 side.

When for a designated target structure pattern (for example, a trench), there are a plurality of pieces of candidate definition information associated with the pattern, it is possible to select one or more pieces of definition information to be applied on the GUI screen 60 by the operation of the user U1. For example, in the example of the definition information 112 in FIG. 7, there are three types of candidates for the trench 403, as shown in the rows numbered #3 to #5. The user U1 selects one or more pieces to be applied among these candidates. In this way, it is possible to measure a plurality of types of dimensions simultaneously, making processing and work more efficient.

### [Designating and Setting of Target Dimensions Using Definition Information]

In Embodiment 1, as described above, the measurement target dimensions (including the dimension type, the measurement position, or the like as shown in FIG. 4) can be designated and set by the operation of the user U1, for each target structure pattern in the target image, by using the definition information 112 (in other words, dimension measurement setting information, dimension setting information) In summary, the definition information 112 is information that defines what types of dimensions are to be measured and how to measure, for the interface reference line 11, the area reference point 12, and the contour information to be detected.

Alternatively, the target dimensions and definition information 112 may be designated and set on the GUI screen 60 as follows. In the modification, the computer system 1 displays an image relating to dimensions, such as (B) of FIG. 4, as a GUI image on the GUI screen 60 based on design pattern information, or the like, and also displays a table of the definition information 112, such as FIG. 7. The computer system 1 displays on the GUI screen 60 an image (for example, an arrow image) of a dimension measurement target line indicating a candidate dimension (for example, dimension A1) for each structure pattern such as the trench 403. The computer system 1 accepts an operation of the cursor or the like by the user U1 on the GUI screen 60 to select a target dimension, and sets detailed definition information in the table of the definition information 112 for each selected target dimension. For example, the vertical position defining the dimension A3 can be set as a ratio, distance, or the like.

### [Step S3: (1) Interface Reference Line]

In step S3, on the GUI screen 60, for the target image 70, by the user U1 manually operating a mouse or the like, an interface reference line 11 is designated and set for a structure pattern of dimension measurement target, for example, a trench designated by the “Trench” button 613 or the like in FIG. 6. This interface reference line 11 is designated to coincide with the material interface 413 as shown in FIG. 4. At the same vertical position as the material interface 413, there are the bottom of mask 401, the top of pillar 402, and the top of trench 403.

In the interface reference line setting mode, the user U1 operates the interface selection GUI 61 displayed in the image field 601 to designate the interface reference line 11 at a desired position aligned with the material interface 413 in the target image 70. The computer system 1 sets the interface reference line 11 at a designated position in the vertical direction (Z direction) in the target image 70.

The interface selection method and interface reference line setting method according to Embodiment 1 will be described with reference to FIG. 8 or the like. (A) of FIG. 8 shows an example of the target image 70 in the image field 601 corresponding to FIG. 6, and (B) of FIG. 8 shows a state in which the interface reference line 11 as the interface selection GUI 61 is displayed on the target image 70 in (A).

The example of the target image 70 in (A) includes a mask 401, a pillar 402, and a trench 403. In addition, depending on the image, only some of the mask, the pillar, and the trench may be included. In the drawings, the color luminance of the image is represented in black and white as a schematic diagram. In this example, the vacuum area, which is the background area including the trench 403, has the lowest luminance and is dark, and is illustrated with a black pattern. The luminance increases and becomes brighter in the order of the area of the pillar 402 and the area of the mask 401 compared to the trench 403. Furthermore, a white band 406 occurs near the boundary between the background area including the trench 403 and the areas of the mask 401 and the pillar 402. This area 406 has the highest luminance and is the brightest, and is illustrated by a white pattern.

In the example of (B), in the initial state, the interface reference line 11 as the interface selection GUI 61 is displayed at any position in the target image 70, for example, at the middle position in the Z direction. The interface selection GUI 61 is displayed as a dotted straight line extending in the X direction, and corresponds to the interface reference line 11. The user U1 operates the cursor 609 in the image field 601 based on the operation of an input device such as a mouse, to operate the interface reference line 11 of the interface selection GUI 61. Thus, the user U1 designates the interface reference line 11 at a position in the vertical direction (Z direction) aligned with the material interface 413 (FIG. 4), in this example, aligned with the interface between the mask 401 and the pillar 402.

In the interface selection GUI 61, for example, the position in the Z direction (vertical direction) of the interface reference line 11, which is indicated by a dotted straight line, can be changed by clicking or dragging the cursor 609. For example, the user U1 places the cursor 609 on the interface reference line 11, clicks and drags the cursor 609 up and down, thereby changing the position of the interface reference line 11 up or down. Since the user U1 can roughly know the position of the material interface 413 from the difference in luminance between different materials (for example, the mask 401 and the pillar 402) in the image 70, the user U1 places the interface reference line 11 in accordance with the position of the material interface 413. The user U1 determines the position of the interface reference line 11 by performing a predetermined operation (for example, releasing the click button).

In this example, the interface reference line 11 is a straight line extending in the X direction as shown in the figure, and the designation of the interface reference line 11 can be implemented by simply designating the height position of one point at a minimum in the target image 70, which reduces the time and effort required for input work.

The computer system 1 sets the interface reference line 11 at the position in the target image 70 designated by the above operation. The setting information of the interface reference line 11 includes, for example, position coordinate information in the shown vertical direction (Z direction). The computer system 1 displays the set interface reference line 11 in a predetermined representation. For example, the interface reference line 11 in the interface selection GUI 61 may change from a dotted line of a predetermined color to a solid line of a predetermined color. The interface selection GUI 61 is not limited to the above example. For example, up and down buttons or a vertical slide bar may be used, or a form for inputting vertical position coordinates may be used.

In this example, since the material interface 413 extends in the horizontal direction (X direction) in the cross-sectional image, a case is shown in which an interface reference line 11 extending in the horizontal direction (X direction) is set, corresponding to the X direction. Without being limited thereto, the interface reference line 11 may extend in a direction other than the horizontal direction in accordance with the actual situation such as the direction of the material interface in the cross-sectional image. As a modification, the extension direction of the interface reference line 11 may be designated and set by the user U1 on the GUI screen 60.

After setting the interface reference line 11, the user U1 operates a “Next” button 610 in the GUI screen 60 (FIG. 6). In response to this operation, the computer system 1 transitions the GUI screen 60 from the interface reference line setting mode as shown in FIG. 6 to an area reference point setting mode as shown in FIG. 9.

### [Regarding Function of Interface Reference Line]

In Embodiment 1, the interface reference line 11 is a line for supporting contour detection and dimension measurement processes and for reference. In particular, the interface reference line 11 is a line that allows the user U1 to determine and designate the material interface 413. In particular, the interface reference line 11 is a line that can also be used as a reference for detecting and determining dimension measurement target structure areas and the measurement target dimension.

In Embodiment 1, as described below, when measuring dimensions, the measurement target dimensions can be determined based on the detected contour line and definition information 112, with the designated interface reference line 11 as a reference. For example, in FIG. 4, the trench width, which is dimension A1, and the trench depth, which is dimension A4, are defined in accordance with the position in the Z direction of the designated interface reference line 11 based on the detected contour line. For example, the position of the top, which is one end of the trench depth, is defined by the interface reference line 11. Moreover, the dimension A3 is defined as a position at a predetermined distance or ratio below the position of the designated interface reference line 11.

### [Step S3: (2) Area Reference Point]

Further, in step S3, on the GUI screen 60, for the target image 70 of the image field 601, by the manual operation of user U1, an area reference point 12 that roughly represents the area of the structure pattern of dimension measurement target is designated and set. At that time, for the structure pattern of the type designated by the above-described button, one or more area reference points 12 are designated using the area selection GUI 62 as a predetermined GUI.

A method for selecting the area reference points 12 of the dimension measurement target structure area will be described with reference to FIG. 9. FIG. 9 shows the state of the area reference point setting mode on the GUI screen 60. The lower part of FIG. 9 shows an enlarged target image 70 in the image field 601. In this mode, in addition to the interface reference line 11 that has been set as described above, area reference points 12 and the like as an area selection GUI 62 are displayed on the target image 70 in the image field 601. In the initial state, the area reference point 12 is not displayed. The user U1 operates the area selection GUI 62 by operating the cursor 609 based on a mouse or the like, and designates the area reference point 12 within an area such as a trench which is a dimension measurement target.

In addition, in a modification, the area reference point 12 and a perpendicular line 13 may be displayed at any position within the target image 70, from the initial state.

In this example, area reference points 901, 902, and 903 are displayed at positions designated by the user U1 as the area reference points 12 in the area selection GUI 62. In this example, after clicking the “Mask” button 611, the area reference points 901 and 902 are designated within the areas of the two masks 401, and after clicking the “Trench” button 613, the area reference point 903 is designated within the area of the trench 403. The computer system 1 displays the area reference points 12 in a predetermined manner (for example, as a circle, in a predetermined color, or the like) at the designated positions. As shown in the figure, the area of the mask 401 and the area of the trench 403 are partially separated by the interface reference line 11.

In addition, upon designating the area reference point 12, the computer system 1 draws perpendicular lines 13, which are straight lines perpendicular to the interface reference line 11 in the vertical direction (Z direction) from the positions of the designated area reference points 12, and displays the perpendicular lines 13 in a predetermined manner (for example, dotted lines). In this example, a perpendicular line 904 is drawn upward from the area reference point 903, and perpendicular lines 905 are drawn downward from the area reference points 901 and 902, respectively. In this embodiment, the perpendicular lines 13 are also displayed as part of the area selection GUI 62, but the display of the perpendicular lines 13 may be omitted.

Not limited to the above example, in other examples of the area selection GUI 60, the user U1 may move and place the initially displayed area reference points 12 to the desired positions by clicking, dragging, or the like with the cursor 609. Not limited to the above example, the area reference points 12 can be similarly designated for the pillar 402 as well. If necessary, the user can return to the interface reference line setting mode and set the interface reference line 11 again. In a modification, the interface reference line 11 and the area reference point 12 may be set simultaneously in parallel within the target image 70 in the image field 601.

In the example of FIG. 9, one point at any position included in the area of a certain trench 403 (the area in the shape of an inverted trapezoid enclosed by the interface reference line 11 as shown) is designated as the area reference point 903. The area reference point 903 indicates the area of the trench 403. A perpendicular line 13 (904) is drawn vertically upward from the area reference point 903, that is, in the direction toward the interface reference line 11. The perpendicular line 13 is automatically determined when the area reference point 11 is designated, so there is no need for the user U1 to perform an operation to draw the perpendicular line 13. As described above, the area selection GUI 62 requires only an operation of designating a single point at a rough position for each structure pattern by clicking or the like, and does not require designating a precise position, so that the time and effort required for the operation is small.

Furthermore, in the target image 70, a plurality of area reference points 12 and the associated perpendicular lines 13 can be designated collectively as necessary. In this example, when two masks 401 and one trench 403 are dimension measurement targets, three area reference points 12 are designated. In response to the designation of the type of structure using the “Mask” button 611 or the like, the computer system 1 grasps the type of structure associated with the designated area reference points 12. The computer system 1 sets a designated area reference point 12 for each structure pattern, for the target image 70.

When the user U1 finishes designating and setting the interface reference line 11 and the area reference point 12, the user U1 presses the “Finish” button 614 on the GUI screen 60. In response to this operation, the computer system 1 finishes the area reference point setting mode. Thus, step S3 is finished. Thereafter, based on those pieces of setting information, the computer system 1 automatically executes contour detection and dimension measurement (steps S4 and S5).

### [Regarding Function of Area Reference Point]

In Embodiment 1, the area reference points 12 are points for supporting contour detection and dimension measurement processes. In particular, the area reference point 12 is a point for the user U1 to roughly designate the area of the structure pattern that is the dimension measurement target.

For example, the dimension measurement target structure is a trench 403, and the measurement target dimensions (in other words, the type of dimension) is the trench width (for example, dimension A3 in FIG. 4, dimension 1803 in (C) in FIG. 18, which will be described later). In this case, the area reference point 12 only roughly indicates the area of the trench 403 of the target. By processing based on the area reference points 12 and the interface reference line 11 using an algorithm described below, the area of the trench 403 is specified and the contour is detected. With respect to the area reference point 12, the height position at which the trench width is measured is not designated, and the two points at both ends of the dimension measurement target line that defines the trench width are not designated. Therefore, the time and effort required for operations related to the area reference point 12 is small.

In Embodiment 1, the area reference point 12 has not only a function of indicating the dimension measurement target structure area, but also the following function. That is, as shown in FIG. 10 or the like described later, the position in the Z direction of the area reference point 12 separates an area into an upper rectangular area from which the line profile 20 is extracted in the X direction, and a lower semicircular area from which the line profile 20 is extracted in the radial direction. The method for generating these line profiles 20 varies depending on the position of the area reference point 12.

In a modification (described later), the area reference point 12 can also be used as a reference for determining the measurement target dimension by the computer system 1.

### [Regarding Material Interface and Dimension Measurement Target Area]

A material interface of a structure pattern in a cross-sectional image (for example, the material interface 413 in FIG. 4) can be a reference for dimension measurement. For example, there are cases where it is desired to measure a dimension (for example, trench depth) with the material interface as the start point. Therefore, it is effective to grasp the material interface as accurately as possible. However, as described above, in image processing and other techniques in the prior art, it is difficult to determine and detect the material interface from a cross-sectional image, which is not efficient. Therefore, in Embodiment 1, a semi-automatic method is adopted, in which for a material interface in the cross-sectional image, the user U1 designates and sets the interface reference line 11 indicating the material interface by subjective determination and manual operation. This enables the computer system 1 to perform dimension measurement and the like based on the interface reference line 11, enabling efficient processing.

Furthermore, in the prior art, it is difficult for a computer to automatically determine and detect the area of a dimension measurement target structure (such as a trench) from the cross-sectional images. In a typical prior art (for example, Comparative Example 2), a user manually designates a dimension measurement target location. However, such prior arts require a lot of time and effort from the user. Therefore, in Embodiment 1, a semi-automatic method is adopted, in which the user U1 manually designates and sets an area reference point 12 that roughly indicates the dimension measurement target area in the cross-sectional image, and then the computer system 1 automatically specifies the target structure area and measures the dimensions.

### [Step S4: Contour Detection Part 1]

In step S4, a contour detection process for the structure pattern of dimension measurement target is performed by using the position coordinate information of the selected and designated interface reference line 11 and the position coordinate information of the area reference point 12. In the following, the algorithm and the like of the process for detecting the contour of the trench 403 will be described with reference to FIG. 10 and the like.

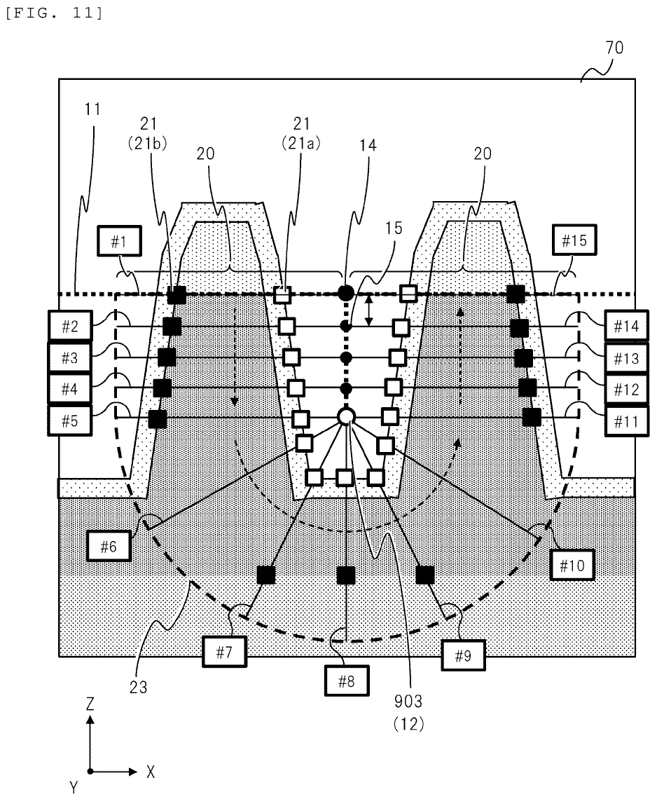

FIG. 10 is a schematic explanatory diagram for contour detection using the interface reference line 11 and the area reference point 12 in a target image 70. In this example, a case of contour detection using the area reference point 903 and the perpendicular line 904 for the trench 403 is shown. Further, FIG. 11 corresponds to FIG. 10 and is an explanatory diagram showing supplementary information about the line profile 20 and the like, in which the image content has been simplified by making the background area white for ease of viewing.

### [Line Profile]

The computer system 1 acquires a line profile 20, with the perpendicular line 13 side as the start point, in the X direction (horizontal direction in the image), which is perpendicular to the perpendicular line 13 (904) extending upward in the Z direction (vertical direction in the image) from the area reference point 12 (903). The line profile 20 is data that is configured by the luminance values of pixels on the line on the pixel data of the image 7. In the example of FIG. 10, 15 line profiles 20 numbered #1 to #15 are acquired as the plurality of line profiles 20.

The plurality of line profiles 20 are acquired, for example, as follows. In FIGS. 10 and 11, the computer system 1 draws a perpendicular line 13 upward from the area reference point 12 to the interface reference line 11, and extracts an intersection 14 between the perpendicular line 13 and the interface reference line 11. The computer system 1 first extracts line profiles 20 (#1, #15) on the interface reference line 11, with the intersection 14 as the start point, in both the left and right directions in the X direction. In this example, the line segment extending from intersection 14 to the left to the end of range 23 is the line profile 20 numbered #1, and the line segment extending from intersection 14 to the right to the end of range 23 is the line profile 20 numbered #15. It should be noted that these left and right line profiles 20 are set as two lines, not one line.

Next, the computer system 1 sets a plurality of points (division points 15) on the perpendicular line 13 connecting the intersection 14 on the interface reference line 11 and the area reference point 12, for example, at a predetermined interval or number. These division points 15 are points that define the positions for extracting a plurality of X-direction line profiles 20. The computer system 1 similarly extracts line profiles 20 that extend in the X direction within a range 23 on the left and right in the X direction, with each division point 15 as a start point. In this example, three division points 15 (FIG. 11) have been added, and line profiles 20 numbered #2 to #4 have been acquired on the left side, and line profiles 20 numbered #12 to #14 have been acquired on the right side. Through the above process, first, eight line profiles 20, indicated by numbers #1 to #4 and #12 to #15, are acquired in the range above the area reference point 12.

The range 23 is a range for extracting the line profiles 20. The range 23 is a rectangular area extending a predetermined length to the left and right from the perpendicular line 13 above the area reference point 12 in the Z direction, and is a semicircular area extending a predetermined radius from the area reference point 12 below the area reference point 12 in the Z direction.

In the algorithm for the contour detection process in the dimension measurement method of Embodiment 1, as shown in the figure, line profiles 20 extending in the X direction are set in the rectangular area above the area reference point 12, and line profiles 20 extending in the radial direction at respective positions in the radial direction are set in the semicircular area below the area reference point 12. In Embodiment 1, a method of using these two types of line profiles 20 (in other words, luminance profile information) to detect the contour (particularly the edges that form the contour) of the target structure pattern is adopted.

Next, the computer system 1 acquires a plurality of line profiles 20 extending in the radial direction within the semicircular range 23 below the area reference point 12 (903). First, the computer system 1 acquires a line profile 20 numbered #5 extending leftward in the X direction from the position of the area reference point 12, and a line profile 20 numbered #11 extending rightward in the X direction. Further, the computer system 1 sets a plurality of radial directions by dividing the semicircular area from the line profile 20 numbered #5 to the line profile 20 numbered #11, with the area reference point 12 as the center point, at intervals or numbers of a predetermined angle, for example. The computer system 1 then acquires line profiles 20 extending in respective radial directions (in other words, in the directions of the rotation angle). In this example, five line profiles 20, numbered #6 to #10, are acquired.

In addition, the two line profiles 20 numbered #5 and #11 extend in the X direction and can be said to belong to both the upper range and the lower range, so it can be considered that a total of 10 line profiles 20 are acquired in the upper range, including these two line profiles 20.

In the example of FIG. 11, when setting the plurality of line profiles 20, numbers for identification (IDs) are assigned in an order starting from the left side and working around to the right side as shown by the dashed arrows, but the present invention is not limited thereto. Furthermore, the processing order of the plurality of line profiles 20 may not be limited to the numerical order.

The range 23 (for example, the length from the area reference point 12) and quantity (for example, the interval and number of divisions) for acquiring the line profile 20 may be preset as fixed setting values implemented in the software 110, or may be user-settable as setting values according to the structure pattern in the definition information 112.

The method of using the line profiles 20 in two types of directions in Embodiment 1 corresponds to the characteristics such as the shape of the target structure pattern. For example, the structure pattern of the trench 403 or the like generally has an uneven or trapezoidal shape. For the shape of such a structure pattern, it is suitable to extract a line profile 20 in the X direction or the radial direction. In the example of FIG. 10, when detecting the contour of an area of the trench 403 having a concave, inverted trapezoidal shape, in the range below the area reference point 12, a line profile 20 is set in the radial direction (in other words, the radial direction) centered on the area reference point 12. Radial line profiles 20 (set for numbers #6 to #10 in FIG. 11) pass through the vicinity of the sidewalls and lower part of the trench 403 as shown in the figure, so that it is possible to extract edge candidate points 21 (edge candidate points present on respective line profiles numbered #6 to #10) near the sidewalls and lower part of the trench 403.

In Embodiment 1, the method of setting two types of line profile 20 can be automatically selected depending on the designation of the target structure pattern or depending on the positional relationship, such as whether the area reference point 12 is above or below the interface reference line 11 in the Z direction.

### [Extraction of Edge Candidates]

Next, with respect to the plurality of acquired line profiles 20, the computer system 1 extracts edge candidate points 21 which are edge candidates relating to the contour of the area of the dimension measurement target structure, on each of the line profiles 20. The computer system 1 extracts the edge candidate points 21 on one line profile 20 based on a predetermined rule. The edge candidate points 21 are points of candidates that become edges configuring the contour of the target structure pattern. On each line profile 20, no edge candidate points 21 may be extracted or two or more edge candidate points 21 may be extracted.

It should be noted that a distinction is made here between contours and edges. In FIG. 10, the edge candidate points 21 extracted on the line profile 20 are indicated by white square points and black square points. In this example, when two edge candidate points 21 are extracted, in order to distinguish between the two points, the first point is designated as an edge candidate point 21a indicated by a white square point, and the second point is designated as an edge candidate point 21b indicated by a black square point. The contour of the trench 402 or the like may be vague, such as the white bands 406. Here, the edge (end point) means, for example, pixels (or the positions or coordinates of the pixels) at the most likely positions as the contour of a structure among the pixels that configure the white band 406, or a line formed by a collection of the pixels at the most likely positions. The coordinates of pixels can also be defined as an edge.

The computer system 1 determines the luminance change on each line profile 20 and extracts edge candidate points 21 according to a predetermined rule. In this process for each line profile 20, the change in luminance value in a single direction, for example, the X direction may be determined. Therefore, detection of contours or edges is made easier than in examples of the prior art where luminance changes in each direction within a two-dimensional image are determined.

The predetermined rule is a definition regarding the direction and amount of luminance change for determining the edge candidate points 21. Examples of the predetermined rule include that the location where the luminance increases from low to high, the amount of luminance change is equal to or greater than a threshold value, and the intermediate value of the difference in luminance change is adopted. The details of the predetermined rule are not limited.

### [Extraction of Edge Candidate Points on Line Profile]

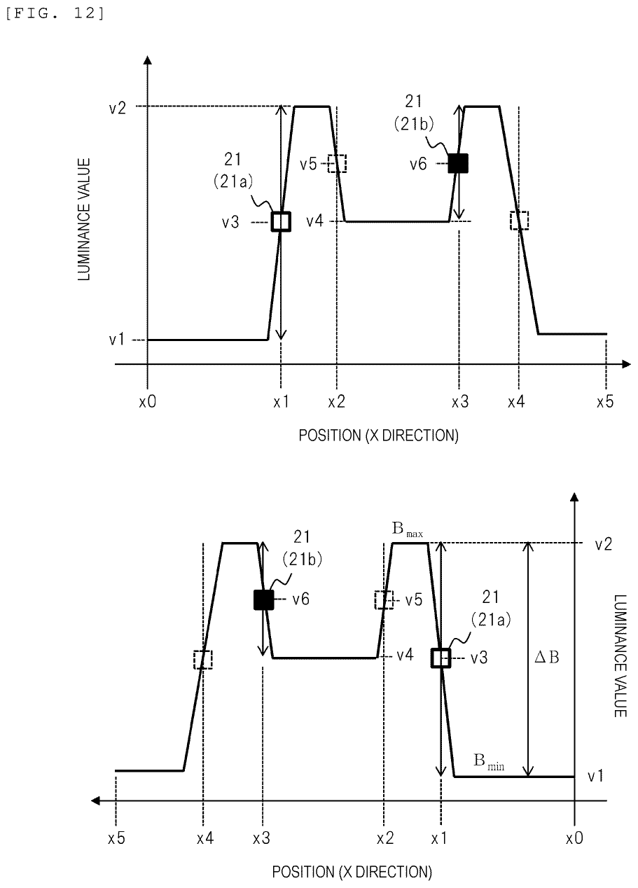

FIG. 12 shows a graph plotting the line profile 20 numbered #1 in FIG. 10, in which the horizontal axis represents the position coordinate in the horizontal direction (X direction) in the target image 70 and the vertical axis represents the luminance value of a pixel on the target image 70. In this example, the position coordinate on the horizontal axis is such that the left side in the drawing is the side closer to the perpendicular line 13 (positive X direction) and the right side is the side farther from the perpendicular line 13 (negative X direction). The position of the origin on the graph (coordinate x0) corresponds to the position of the intersection 14, and the position on the right end of the graph (coordinate x5) corresponds to the position where the end of range 23 is reached.

In the lower part of FIG. 12, a graph with the X-axis polarity reversed for the graph in the upper part is shown, and this graph coincides with the directions in FIG. 10 and the like.

On the line profile 20 numbered #1, in the move to the left from the position of intersection 14 (coordinate x0), the area changes from the area of trench 403 corresponding to the background to the area of pillar 402 or mask 401, so the luminance value increases. In this case, since the white band 406 is passed through, the luminance value increases significantly at that location. In this example, the luminance value increases from v1 to v2. The vicinity of the area from coordinate x1 to coordinate x2 corresponds to the white band 406. After that, in the vicinity of coordinate x2, the area falls within the pillar 402 or mask 401, so the luminance value decreases. In this example, the luminance value decreases from v2 to v4. The area from coordinate x2 to coordinate x3 corresponds to the area of the pillar 402 or the mask 401 (particularly the material interface 413). In the vicinity of coordinate x3, the area falls again within the white band 406, so the luminance value increases significantly, increasing from luminance value v4 to luminance value v2 in this example. The vicinity of the area from coordinate x3 to coordinate x4 corresponds to the white band 406. In the vicinity of coordinate x4, the area leaves the white band 406 and enters the background area again, so the luminance value decreases significantly, decreasing from luminance value v2 to luminance value v1 in this example.

In Embodiment 1, the following rules are applied as an example of the process for extracting edge candidate points 21 on the line profile 20. In the graphs shown in FIG. 12, the positions of edge candidate points 21 to be extracted are defined as positions between the minimum value and the maximum value of the luminance. In this example, in the vicinity of coordinate x1, edge candidate point 21 is determined to be a position between luminance value v1, which is a minimum value, and luminance value v2, which is a maximum value. For example, the coordinate x1 of the position corresponding to the luminance value v3 intermediate between the minimum value and the maximum value is the edge candidate point 21 (first edge candidate point 21a) indicated by a white square point. The position for extracting the edge candidate point 21 is defined as, for example, an intermediate value between the minimum value and the maximum value, but is not limited to this.

The definition of which position among the luminance change locations should be extracted as the edge candidate point 21 is not limited to the above example of the intermediate value, but may be any other value. For example, a threshold value Th [%] relating to the ratio of luminance value is provided as a setting. Here, when the luminance value is B, the maximum value in the luminance change around the edge candidate is Bₘₐₓ, the minimum value is Bₘᵢₙ, and the luminance value to be the edge candidate is Bₜₕ, then Bₜₕ is calculated using, for example, the following Equation 1. The position that is Bₜₕ is set as an edge candidate point 21.

$${B}_{th} = ( {B}_{m ax} - {B}_{m i n} ) ⋆ Th / 100 + {B}_{m i n} \qquad Equation 1$$

In Equation 1, the position of the luminance value according to the ratio of the threshold value Th to the difference between the maximum value and the minimum value is set as the position of the edge candidate point 21. The case where the threshold value Th is set to 50% corresponds to the example of the intermediate value in FIG. 12.

The definition for determining the edge candidate points 21 is only one example. As another example of the definition for determining the edge candidate points 21, a method in which a position shifted by a certain amount from the position of the maximum value or the minimum value is set as the edge candidate point 21 can also be applied.

In addition, in Embodiment 1, one of the rules for extracting edge candidate points 21 is that, in contour detection of the area of trench 403 in FIG. 10 or the like, edge candidate points 21 are extracted at locations where the side closer to perpendicular line 13 is dark and the side farther from perpendicular line 13 is bright. In other words, the rule is to determine the edge candidate points 21 in locations where luminance increases in the direction of the line profile 20. For example, in the graphs of FIG. 12, the portions where the luminance changes significantly are near coordinate x1 and coordinate x2. In the vicinity of coordinate x1, the luminance value v1 in the positive X direction closer to the perpendicular line 13 is smaller, and the luminance value v2 in the negative X direction farther from the perpendicular line 13 is larger, and the luminance change increases from low to high. In the vicinity of coordinate x2, the luminance value v2 in the positive X direction closer to the perpendicular line 13 is larger, and the luminance value v4 in the negative X direction farther from the perpendicular line 13 is larger, and the luminance change decreases from high to low.

Therefore, according to this rule, an edge candidate point 21 (21a) is extracted in the vicinity of coordinate x1, for example, where the luminance change increases from low to high, out of two locations where the luminance changes significantly. No edge candidate point 21 is extracted in the vicinity of the coordinate x2, for example, where the luminance change decreases from high to low. Based on this rule, in this example, an edge candidate point 21a (white square point) is extracted at the position of coordinate x1, and an edge candidate point 21b (black square point) is extracted at the position of coordinate x3.

The computer system 1 determines the amount of luminance change at a location where the luminance value increases from a minimum luminance value v1 to a maximum luminance value v2, in the vicinity of the coordinate x1, for example, calculates a luminance value v3, for example, which is an intermediate value, and extracts an edge candidate point 21a at the coordinate x1 corresponding to the luminance value v3. The computer system 1 determines and extracts edge candidate points 21 for each line profile 20 using similar rules.

In a modification, with regard to the rules regarding locations where luminance changes for extracting the above-described edge candidate points 21, if a rule of extracting in locations where the luminance increases is defined as a first rule, and a rule of extracting in locations where the luminance decreases is defined as a second rule, the second rule may be applied instead of the first rule. When the above first rule is applied, an edge candidate point 21 is extracted on the side of the white band 406 closer to the perpendicular line 13 (for example, near coordinate x1) as described above, whereas when the second rule is applied, an edge candidate point 21 (for example, the position of luminance value v5) is extracted on the opposite side of the white band 406, that is, the side away from the perpendicular line 13 (for example, near coordinate x2). For example, in the vicinity of coordinate x2, the luminance value decreases from a luminance value v2 which is a maximum value to a luminance value v4 which is a minimum value, and the coordinate x2 of the position corresponding to, for example, a luminance value v5 which is an intermediate value is extracted as an edge candidate point 21.

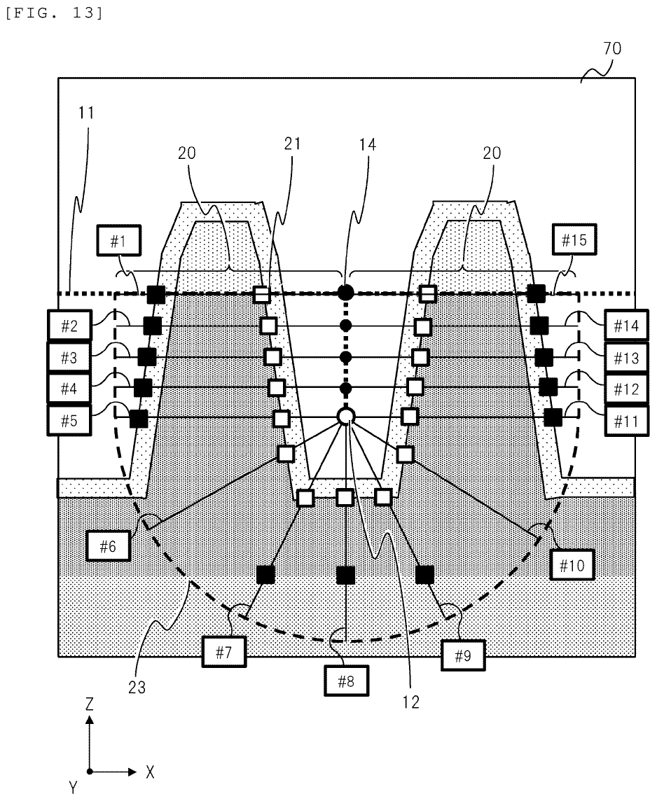

FIG. 13 shows edge candidate points 21 extracted for the trench 403 when the rule applied to the same target image 70 as in FIG. 10 is changed from the first rule to the second rule in a modification. These edge candidate points 21 are disposed at positions that are expanded outward as a whole (positions closer to the pillar 402), compared to the edge candidate points 21 according to the first rule in FIG. 11.

A rule to be applied may vary depending on the type of structure pattern. For example, when the target is the trench 403, the first rule of extracting in locations where the luminance increases may be applied, and when the target is the mask 401 or the pillar 402, the second rule of extracting in locations where the luminance decreases may be applied. The edge candidate points 21 to be extracted vary depending on the rule to be applied. For example, the contour line of the trench 403 and the contour line of the pillar 402 can be detected as separate contour lines having different position coordinates, or these contour lines can be detected as contour lines having similar position coordinates.

Regarding which of the various rules and methods including the rule for extracting the edge candidate points 21 is to be applied, this may be a fixed setting in advance during implementation of the software 110, or the computer system 1 may allow the user U1 to perform setting on the GUI screen 60. Based on the definition information 112, a rule may be selected and applied according to the structure pattern.

In the example of FIG. 10 or the like, for example, on the line profile 20 numbered #1, in addition to the first edge candidate point 21a (white square point), a second edge candidate point 21b (black square point) is also extracted. This viewpoint will be described. In the above example of the rule, the luminance change on the line profile 20 is examined in the direction from the perpendicular line 13 to the end of the range 23, and a position corresponding to the intermediate value at a location where the amount of luminance change is sufficiently large, for example, a location where there is a significant luminance change near the white band 406, is extracted as an edge candidate point 21. According to such rules and methods, the second edge candidate point 21b (black square point) may also be extracted as shown in the figure.

In this example, the first edge candidate point 21a is an edge that configures the contour of the target trench 403, but the second edge candidate point 21b does not correspond to an edge that configures the actual contour of the trench 403. However, in other examples, the second edge candidate point 21b may also be an edge that configures the contour of the target structure pattern.

The computer system 1 in Embodiment 1 obtains a plurality of edge candidate points 21 by extracting the edge candidate points 21 on the line profile 20 in the above-described manner for all of the plurality of line profiles 20 in the same manner. For example, as shown in FIG. 10 or the like, a plurality of (for example, 15) edge candidate points 21a indicated by white square points and a plurality of (for example, 13) edge candidate points 21b indicated by black square points are obtained. The computer system 1 in Embodiment 1 performs a comprehensive determination based on these plurality of edge candidate points 21, and detects the edges that form the contour of the target structure pattern.

Line profiles 20 numbered #1 to #5 and #11 to #15 correspond to the transition from the trench 403 to the pillar 402, and edge candidate points 21a, 21b corresponding to the sidewalls of the trench 403 and the pillar 402 are obtained. It should be noted that the line profiles 20 numbered #1 and #15 are on the interface reference line 11. Therefore, for example, the luminance value v4 in FIG. 12 is a luminance value in the vicinity of the material interface, and is a constant value in the example of FIG. 12, but may be a fluctuating value in reality.

For the line profiles 20 numbered #6 to #10 in the radial direction, edge candidate points 21 can be similarly extracted in the direction of each line profile 20. For example, in the line profile 20 numbered #6, only one edge candidate point 21 (white square point) is extracted. In the line profile 20 numbered #7, an edge candidate point 21a near the lower surface of the trench 403 and an edge candidate point 21b corresponding to the boundary with the underlying material layer are extracted.

It should be noted that the same process as the process for the trench 403 can also be applied in a case of extracting edge candidate points 21 for the mask 401 or pillar 402.

### [Step S4: Contour Detection Part 2]

Next, an embodiment of a method for determining edges configuring the contour of a structure pattern of dimension measurement target, for example, a trench 403, based on a plurality of edge candidate points 21 of the plurality of line profiles 20 will be described.

The computer system 1 selects any edge candidate points 21 for each line profile 20 and creates combinations of a plurality of edge candidate points 21. At this time, the computer system 1 calculates an evaluation value of the edge-likeness of the contour, in the combination of the edge candidate points 21. The computer system 1 determines the combination of edge candidate points 21 with the highest evaluation value as the edges of the contour (in other words, the edge points). The computer system 1 determines which edge points to select, based on the positional relationships between the plurality of edge candidate points 21 in the combination. An algorithm for such determination is also installed in the software 110.

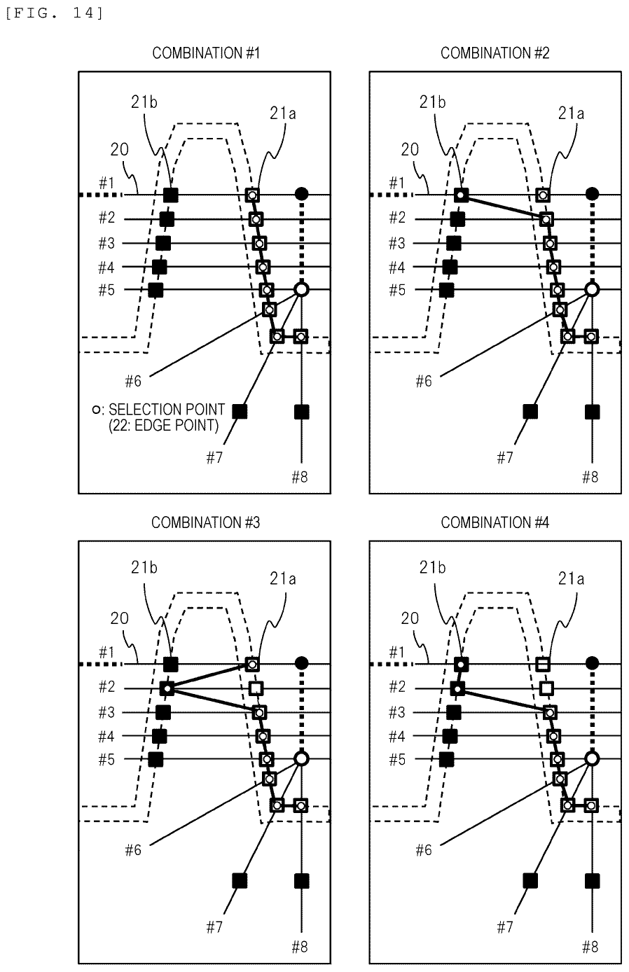

FIG. 14 shows examples of the combination of the edge candidate points 21. Combination #1 is an example of a correct solution. A small white circle indicates one edge point 22 selected from the edge candidate points 21 for each line profile 20. By connecting the selected edge points 22, a contour line that configures the contour of the sidewall of the trench 403 is formed. Combination #2 is an example of an incorrect solution, in which a second edge candidate point 21b is selected in the line profile 20 numbered #1. Combination #3 is an example of an incorrect solution, in which a second edge candidate point 21b is selected in the line profile 20 numbered #2. Combination #4 is an example of an incorrect solution, in which the second edge candidate point 21b is selected in the line profiles 20 numbered #1 and #2.

There are various cases where there are no edge candidate points 21 on one line profile 20, where there is only one edge candidate point 21, or where there are three or more edge candidate points 21. Even in those cases, combinations can be made in a similar manner.

### [Evaluation of Edge-Likeness]

Here, there are at least two evaluation viewpoints for evaluating edge-likeness. The first evaluation viewpoint is the amount of change in luminance value. FIG. 10 and other figures are schematic diagrams and therefore only clear edges are shown, but in an actual cross-sectional image taken with an electron microscope, the edges may be unclear. For example, due to the above-described collapse or contamination, minute changes in luminance due to dust adhesion, noise during imaging, or the like may occur near the contours of structures, in the cross-sectional images. It would be an error to determine an edge based on such a luminance change as an edge candidate point 21.

In Embodiment 1, in order to reduce the influence of these factors, it is defined that the greater the amount of luminance change, the higher the edge-likeness, that is, the larger the evaluation value, during the above evaluation. A specific evaluation value calculation may be defined as the difference (ΔB=(Bₘₐₓ−Bₘᵢₙ)) between the maximum value and the minimum value of luminance in a luminance changing area around the edge candidate point 21. Alternatively, it may be defined as a gradient value of luminance. As an example of the evaluation of the amount of change in luminance value, in the example of FIG. 12, the difference AB near the coordinate x1 can be calculated.

The second evaluation viewpoint is the distance between the edge candidate points 21. Since the contour of a structure should be continuously connected, it is defined that the closer the distance between edge candidate points 21, the higher the edge-likeness. When the distance between the edge candidate points 21 is large, there is a high possibility that the edge of an object other than the target, such as dust adhering to the cross section of the structure, has been detected. For example, in the examples of FIGS. 10 and 14, the edge candidate point 21a indicated by the white square point in the line profile 20 numbered #2 is close to and the edge candidate point 21b indicated by the black square point in the line profile 20 numbered #2 is farther away from the edge candidate point 21a indicated by the white square point in the line profile 20 numbered #1. These correspond to combination #1 and combination #3 in FIG. 14.

Therefore, when the edge candidate point 21a of the line profile 20 numbered #1 is connected to the edge candidate point 21a of the line profile 20 numbered #2 (combination #1, or the like), it is considered that the edge-likeness of the contour is higher. That is, the computer system 1 performs calculations such that the smaller the distance between the edge candidate points 21 is, the larger the evaluation value becomes for the combination.

When calculating the evaluation value quantitatively, it can be said that the greater the amount of luminance change, the higher the edge-likeness of the location of the edge as in the first viewpoint described above, but from the viewpoint alone, the evaluation value of edge candidates in locations other than the structure currently of interest may also be high. Therefore, in Embodiment 1, in addition to the first viewpoint, the second viewpoint is also applied to calculate the evaluation value of edge-likeness in order to include the continuity of the contour in the evaluation. Based on the evaluation results, the computer system 1 selects a plurality of edge points 22 that are considered to have the highest edge-likeness. For example, combination #1 is selected.

In order to calculate the specific evaluation value for the distance between the edge candidate points 21, or the like, any edge candidate points 21 are selected from each line profile 20 to generate a combination as shown in FIG. 14, and the evaluation value E of the contour line consisting of these edge candidate points 21 is calculated. The evaluation value E is an evaluation value of the continuity of the contour, and can be defined, for example, by the following Equation 2.

$$E = {\sum }^{∧} ( N - 1 ) \_ ( n = 1 ) \{ Δ {B}_{n} / {D}_{n , n + 1} \} \qquad Equation 2$$

In Equation 2, ΔBₙ is a difference between the maximum value and the minimum value of luminance around the edge candidate point 21 selected in the n-th line profile 20. D_{n,n+1} is a distance between the edge candidate point 21 selected in the n-th line profile 20 and the edge candidate point 21 selected in the (n+1)-th line profile 20. The computer system 1 selects and determines, from among all the combinations of edge candidate points 21, a combination that has the maximum evaluation value E as the edge points 22. The computer system 1 may create a contour formed by those edge points 22, for example, a contour line connecting the edge points 22 in order, and use that contour line as the contour detection result.

However, the calculation by the method for determining the edge with the maximum evaluation value E may be NP-hard in some cases. For example, when there are 100 line profiles 20 and each line profile 20 has 10 edge candidate points 21, there are 10 to the power of 100 combinations, so it is difficult to calculate the evaluation value E for all combinations. Therefore, a combination of edge candidate points 21 having approximately the maximum evaluation value E may be obtained using an approximation method. For example, any edge candidate point 21 in the n-th line profile 20 is denoted as Pₙ, and any edge candidate point 21 in the (n+1)-th line profile 20 adjacent to the n-th line profile 20 is denoted as Pₙ₊₁. The distance between Pₙ and Pₙ₊₁ is D, and the difference between the maximum value and the minimum value of luminance around the edge candidate point 21 of Pₙ₊₁ is ΔBₙ. In this case, the temporary evaluation value is denoted as Eₜₑₘₚ and is defined by the following Equation 3.

$${E}_{temp} = Δ B / D \qquad Equation 3$$

Then, the computer system 1 selects one edge candidate point 21 from the edge candidate points 21 of the first line profile 20, and determines the edge candidate point 21 of the second line profile 20 in which the evaluation value Eₜₑₘₚ is maximum. The edge candidate points 21 of the third and subsequent line profiles 20 are determined in a similar manner. The computer system 1 calculates an evaluation value E from the combination of the obtained edge candidate points 21. Thereafter, the computer system 1 selects another edge candidate point 21 of the first line profile 20, performs the same process, and calculates an evaluation value E from the combination of the obtained edge candidates. The computer system 1 determines, as the combination of edge candidate points 21 having approximately the maximum evaluation value E, the combination of edge candidate points 21 having the highest evaluation value E among the combinations of edge candidate points 21 obtained by each edge candidate point 21 selected in the first line profile 20. Such an approximation method can significantly reduce the calculation time and implement automatic contour detection within a finite time. The method for determining the edge points 22 is not limited to the above method.

### [Detection of Edge Points and Contour Lines]

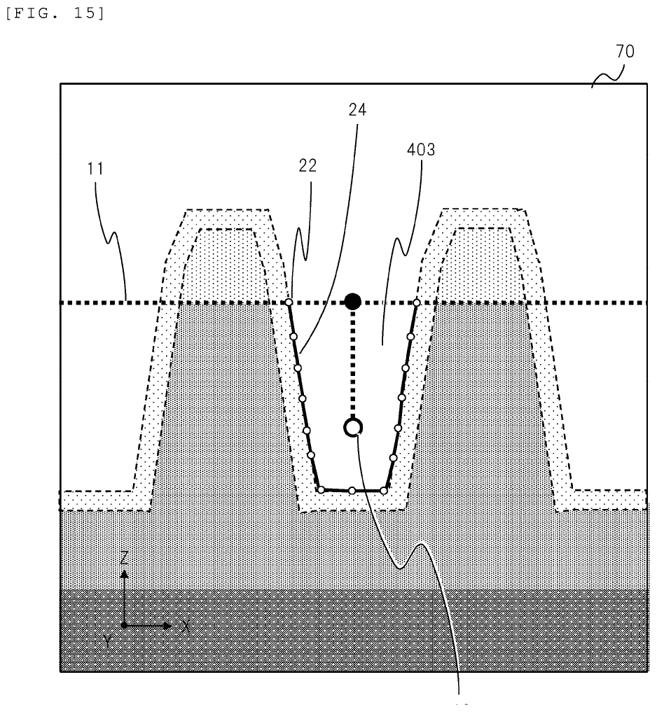

In the example of the trench 403 designated by area reference point 12 in FIG. 10, edge points 22 corresponding to 15 edge candidate points 21 (21a) indicated by white square points are obtained as the contour of the trench 403. FIG. 15 shows an example of the contour detection result. The computer system 1 may form a contour line 24 of the trench 403 by connecting these edge points 22 with a line, as shown in FIG. 15. This contour line 24 corresponds to a part of the contour detection result.

In the example of FIG. 15, in the target image 70, the detected edge points 22 (indicated by white circles) are connected in order by a straight line to form a contour line 24. In the example of FIG. 15, the contour line 24 represents the contours of the sidewalls and lower part in the area of the trench 403. The upper surface of the area of the trench 403 is open and is separated by an interface reference line 11.

Without being limited thereto, the computer system 1 may create an approximation curve, as a smoothing process, for example, based on a plurality of edge points 22 and use the curve as the contour line 22. Further, the contour line 24 may be omitted, and the contour may be represented by only a plurality of edge points 22. When the number of edge points 22 is large enough, the contour can still be represented.

Further, the computer system 1 may display the edge points 22 or the contour line 24, which are the contour detection results, in the GUI screen 60, for example, on the target image in the image field 601, as shown in FIG. 15. The computer system 1 may display dimensional values of the dimension measurement result 8 (described later) on the GUI screen 60 together with the contour line 24 and the like.

### [Contour Detection for Mask and Pillar]

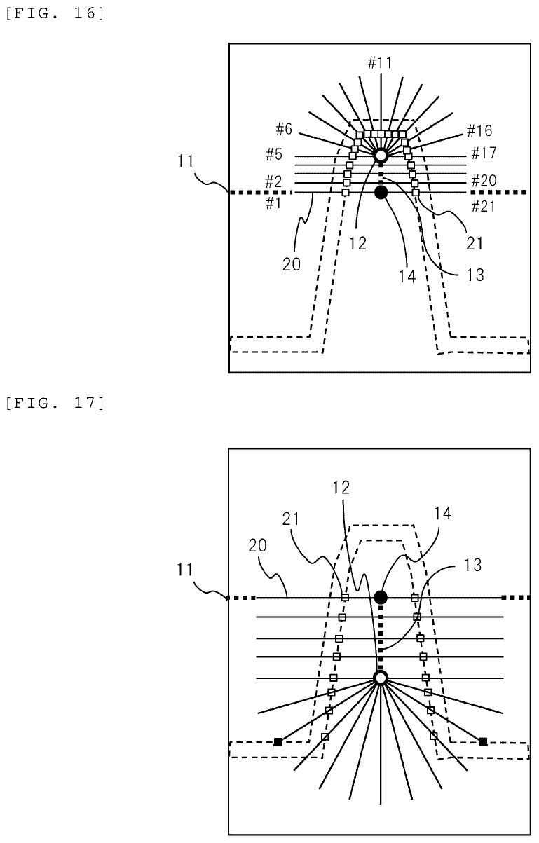

Although the above example shows the case of the trench 403, the same is also possible in the case of the pillar 402 or the like. Similarly, FIG. 16 shows the case of contour detection (particularly, edge candidate point extraction) for the mask 401, and FIG. 17 shows the case of contour detection (particularly, edge candidate point extraction) for the pillar 402. In addition, in the examples of FIGS. 16 and 17, as a rule when the edge candidate points 21 are extracted, the above-described first rule of extracting edge candidate points in locations where the luminance increases is applied. In this case, for example, the edge of the contour of the trench 403 and the edge of the contour of the pillar 402 will differ from each other.

In the example of FIG. 16, an area reference point 12 is designated within the area of a certain mask 401. The computer system 1 draws a perpendicular line 13 downward from the area reference point 12 to the interface reference line 11 and extracts an intersection 14. The computer system 1 extracts a plurality of X-direction line profiles 20 in the area from the area reference point 12 to the intersection 14. The computer system 1 extracts a plurality of radial line profiles 20 in the area above the area reference point 12. The computer system 1 extracts edge candidate points 21 from each line profile 20 based on the above-described first rule and the like. The computer system 1 determines edge points 22 for the mask 401, based on a combination of a plurality of edge candidate points 21.

As shown in the figure, in the case of the mask 401, a radial line profile 20 is applied in the range above the area reference point 12. Thus, the radial line profile 20 passes through the contour of the mask 401 having a convex, trapezoidal shape, so that edge candidate points 21 of the contour of the mask 401 can be extracted.

In the example of FIG. 17, an area reference point 12 is designated within the area of a certain pillar 402. The computer system 1 draws a perpendicular line 13 upward from the area reference point 12 to the interface reference line 11 and extracts an intersection 14. The computer system 1 extracts a plurality of X-direction line profiles 20 in the area from the area reference point 12 to the intersection 14. The computer system 1 extracts a plurality of radial line profiles 20 in the area below the area reference point 12. The computer system 1 extracts edge candidate points 21 from each line profile 20 based on the above-described first rule and the like. The computer system 1 determines edge points 22 for the pillar 402, based on a combination of a plurality of edge candidate points 21.

### [Step S5: Dimension Measurement]

In step S5, the computer system 1 performs dimension measurement process on the contour information detected in step S4 by referring to the definition information 112 selected in step S2, obtains the dimension measurement result 8, and displays the result on the GUI screen 60.

FIG. 18 is a schematic explanatory diagram showing an example of measuring the dimensions of the trench 403, based on, for example, contour information of the trench 403. As a premise, contour information of the two-dimensional target image 70 has information on the edge points 22 and the contour lines 24 as described above.

(A) in FIG. 18 shows the case where the trench depth (dimension A4 in FIG. 4) is measured. The computer system 1 sets a dimension measurement target line 1801 for measuring the dimension A4 of the trench depth. First, the dimension measurement target line 1801 of the trench depth can be defined as a line drawn perpendicular to the edge (edge point p8 in this example) of the contour that is the furthest away in the vertical direction, from the interface reference line 11 designated in step S1. The computer system 1 measures the dimension A4 along the set dimension measurement target line 1801.

(B) in FIG. 18 shows a case where the trench width (dimension A1 in FIG. 4) in the position of interface reference line 11 corresponding to the material interface 413 is measured as a trench width. The computer system 1 sets a dimension measurement target line 1802 for the dimension A1. The computer system 1 can take edge points p1 and p15, which are the two intersections between the interface reference line 11 designated in step S3 and the contour of the trench 403, and define the dimension measurement target line 1802 as a line drawn between these edge points.

(C) in FIG. 18 shows a case where the trench width is measured at a position 30 nm as a predetermined distance d below the position of the interface reference line 11 corresponding to the material interface 413 as a trench width. Here, d=30 nm is the distance designated and set by the user U1 in the definition information 112. Like the dimension A3 in FIG. 4 described above, this can be designated as a ratio (%) instead of a distance. The computer system 1 sets a dimension measurement target line 1803 at a position at a predetermined distance. Based on information such as the pixel size of the target image, the computer system 1 calculates, based on information such as pixel size of the target image, how many pixels away from the interface reference line 11 on the target image the distance 30 nm corresponds to. The computer system 1 extracts two intersections (end points 1811 and 1812 in this example) between the horizontal line (a straight line extending in the X direction) in the calculated position and the contour (contour line 24) of the trench 403. The computer system 1 can define the dimension measurement target line 1803 as a line drawn between these two intersections.

The dimensions of the pillar 304 and the mask 303 can be measured in a similar manner. Other types of dimensions can also be measured in a similar manner. For example, the computer system 1 may measure an angle (for example, the angle of a sidewall) calculated from a partial area of the contour of a structure.

(D) in FIG. 18 shows the case where the sidewall angle 1804 of the trench 403 is measured. In this example, based on the definition information 112, an angle 1804 formed by the left sidewall is measured with a position at a designated distance (for example, 30 nm) below the interface reference line 11 as a reference. The computer system 1 calculates an approximate straight line for the sidewall, from edge points (in this example, edge points p1 to p3) in a partial area of the contour of the trench 403, in this example, the left sidewall and in an area 1820 up to a position 30 nm below the interface reference line 11. Alternatively, the computer system 1 may refer to a portion of the contour line 24 that has already been calculated from the edge points 22 described above. The computer system 1 then calculates the angle 1804 that the approximate straight line or contour line 24 makes with the horizontal line at the designated position. In this manner, the sidewall angle at a designated position can be measured.

As an example of other types of dimensions, the computer system 1 may measure the area of an area surrounded by the contour (contour line 24) of a structure and the material interface 413 (interface reference line 11), for example, a trench area. The computer system 1 can measure the area of the target structure area, based on the interface reference line 11, the area reference point 12, the definition information 112, the detected contour line 24, and the like.

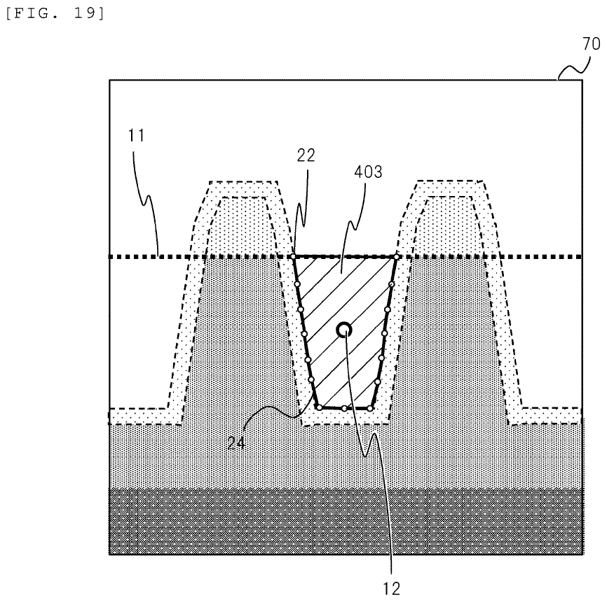

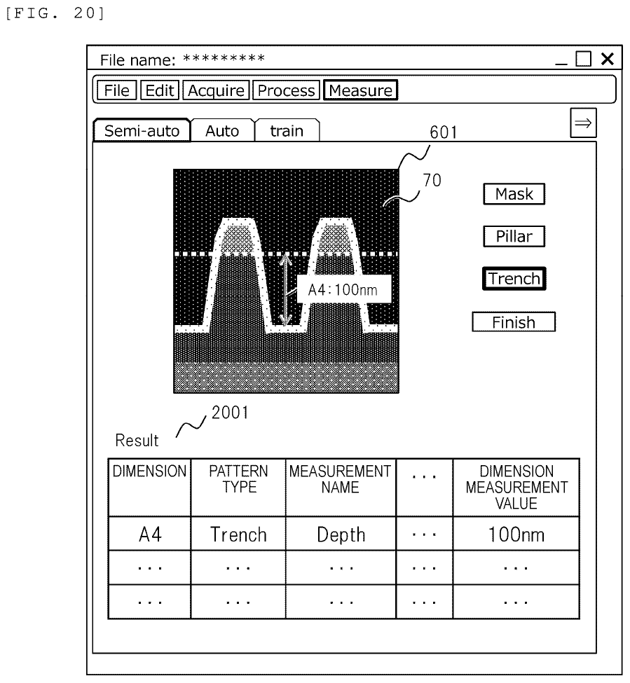

FIG. 19 shows an example of measuring the area of the trench 403. On the GUI screen 60, the user U1 designates area as the type of measurement target dimension based on the definition information 112, and designates the interface reference line 11 and the area reference point 12 on the target image 70. The computer system 1 detects edge points 22 and a contour line 24 as described above, based on the designated interface reference line 11 and area reference points 12. The computer system 1 extracts a closed area including the area reference point 12, the closed area being configured by the interface reference line 11 and the contour line 24 defined by a plurality of edge points 22. The closed area corresponds to the area of the trench 403. The computer system 1 counts the number of pixels contained in the extracted area of the trench 403, and calculates the area based on the pixel information and the like. Thus, the measurement result of the area is obtained.

### [Step S6: Output of Dimension Measurement Result]

The computer system 1 stores the data of the dimension measurement result 8, which is the result of step S5, in the memory resource 102, and displays the result on the GUI screen 60 to the user U1. The dimension measurement result 8 may include position coordinate information of the interface reference line 11 and position coordinate information of the area reference point 12 designated in step S3.

FIG. 20 shows an example of a GUI screen 60 that displays the dimension measurement result 8. In the GUI screen 60 in FIG. 20, the dimensions of the measurement target (for example, trench width dimension A4) of the dimension measurement target structure (for example, trench 403) are displayed superimposed on the target image 70 in the image field 601 described above. For example, a dimension measurement target line (indicated by a white arrow) for the target dimension is displayed, and the target dimension (for example, “A4”/“Depth”) and the dimension measurement value (for example, “100 nm”) are displayed with a leader line added to the dimension measurement target line as necessary. Additionally, in a Result field 2001 in the lower part, information such as dimension measurement values for each target dimension is displayed in a table. Without being limited thereto, as another display example, information such as the position coordinates of two points defining the dimension measurement target line may be further displayed.

### [Advantages of Embodiment 1]

According to Embodiment 1, a semi-automatic method is adopted in which a user U1 manually designates and sets a material interface, which is difficult to automatically detect, and the rough position of the dimension measurement target structure area in the cross-sectional image as the interface reference line 11 and area reference point 12, and then the computer system 1 automatically performs contour detection and dimension measurement based on the interface reference line 11 and the area reference point 12. Therefore, the time required for processing and work of dimension measurement on the cross-sectional image can be shortened, and the time and effort of the user U1 can be reduced. It is also possible to reduce the influence of errors caused by manual operation by a person. In the case of examples in the prior art (Comparative Examples 1 and 2), a person designates the contour of the structure or the dimension target location by eye, resulting in a large amount of error, which is reflected in the accuracy of the dimension measurement. In contrast, according to Embodiment 1, after the contour is detected in a semi-automatic method, automatic dimension measurement is performed, so there is less error and the precision of the dimension measurement is high.

In Embodiment 1, the user U1 may only designate an interface reference line 11 for a material interface and roughly designate an area reference point 12 for a dimension measurement target structure area, on a cross-sectional image, by subjective determination and manual operation. The computer system 1 detects edges that form the contour of a structure pattern in the cross-sectional image by processing a predetermined algorithm, based on the designated interface reference line 11 and area reference point 12. The computer system 1 measures a designated type of dimension, based on the information of the detected edge. Thus, according to Embodiment 1, the main manual operation of the user U1 is only the operation of designating the interface reference line 11 and the area reference point 12, so that the amount of input is small and the time and effort of the user U1 can be reduced. Furthermore, since the computer system 1 accurately detects contours and measures dimensions, based on the interface reference line 11 and the area reference point 12, human error is unlikely to be reflected in the dimension measurement result.

The semi-automatic method in Embodiment 1 has at least the following first and second advantages, compared to the automatic dimension measurement method in examples of the prior art.

### [Regarding First Advantage]

A first advantage is that it is possible to perform dimension measurement while excluding structure patterns that are not suitable for the dimension measurement target. Examples of “structure patterns that are not suitable for dimension measurement target” include structures that are collapsed or have dust adhered thereto, as described above.

As an example of the prior art, there is a method of recognizing a cross-sectional structure of a semiconductor based on pattern matching/template matching and detecting the contour/edge of the recognized cross-sectional structure. However, in such a method, dimensions are measured for all objects including dust, that are recognized and detected within the target image based on pattern matching/template matching. Based on pattern matching/template matching, portions caused by collapse, dust, noise during shooting, or the like may be recognized and detected as contours/edges and may end up being a dimension measurement target. Such portions with dust or other contaminants are unsuitable for measurement and should therefore be excluded from the dimension measurement target.

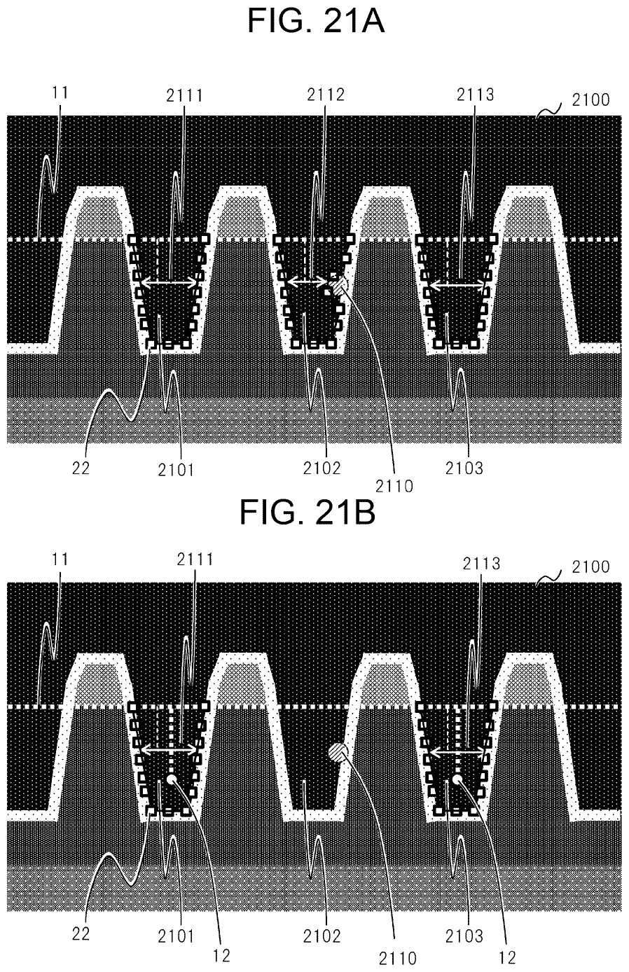

FIG. 21 shows an example of the results of contour detection and dimension measurement in a target image 2100 that includes a structure pattern with dust attached thereto. It is assumed that dust due to contamination is adhered to the cross section of the target sample. In an SEM used for observing a cleaved substrate, such adhesion of dust may occur. In the example of FIG. 21, a dust portion 2110 corresponding to the dust is present on the right side wall of a trench 2102 in the target image 2100.

In (A) in the upper part of FIG. 21, the contour edges (edge points 22 and the contour lines connecting the edge points 22) of each of the three trenches 2101 to 2103 are detected, and the trench width is measured at a position, for example, 30 nm below the interface reference line 11 corresponding to the material interface. Dimension measurement target lines 2111 to 2113 in each of the trenches 2101 to 2103 are indicated by arrows.

Δt this time, in this example, the contour detection and dimension measurement are performed on the dust portion 2110. The dust portion 2110 adhering to the right sidewall of the trench 2102 protrudes into the area of the trench 2102, and a contour line including an edge point 2105 is detected at the protruding portion. The dimension measurement target line 2112 in the trench 2102 is set between the contour line of the left side wall and the contour line of the dust portion 2110. Therefore, the measured length of the dimension measurement target line 2112 is shorter than the measured length of a trench structure without any dust (for example, the trench 2101).

In contrast, according to Embodiment 1, even in the case of the target image 2100 including a dust portion 2110 as shown in (A), it is possible to exclude the dust portion 2110. (B) in the lower part of FIG. 21 shows the correspondence in Embodiment 1. In the manual operation step described above, the user U1 visually checks the contents of the target image 2110, and if user U1 determines that a trench 2102 containing the dust portion 2110 is unsuitable for length measurement, the user U1 does not designate an area reference point 12 for that trench 2102. Thus, for example, the length of trenches 2101 and 2103 for which the area reference point 12 is designated is measured, but the length of trench 2102 is not measured. In this way, portions that will result in inappropriate length measurements can be excluded.

Other modifications may be as follows. As in (A) in FIG. 21, area reference points 12 (not shown) are designated for the three trenches, and once the dimension measurement results are obtained, the user U1 checks the dimension measurement results on the GUI screen 60. When the user U1 wants to exclude the dimension measurement results for the trench 403 including the dust portion 2110, the user U1 operates the area reference point 12 displayed in the target image by clicking to change the state from ON to OFF. In response to this operation, the computer system 1 rejects the dimension measurement result for that trench 403, and erases the display of the dimension measurement result, as in (B).

### [Regarding Second Advantage]

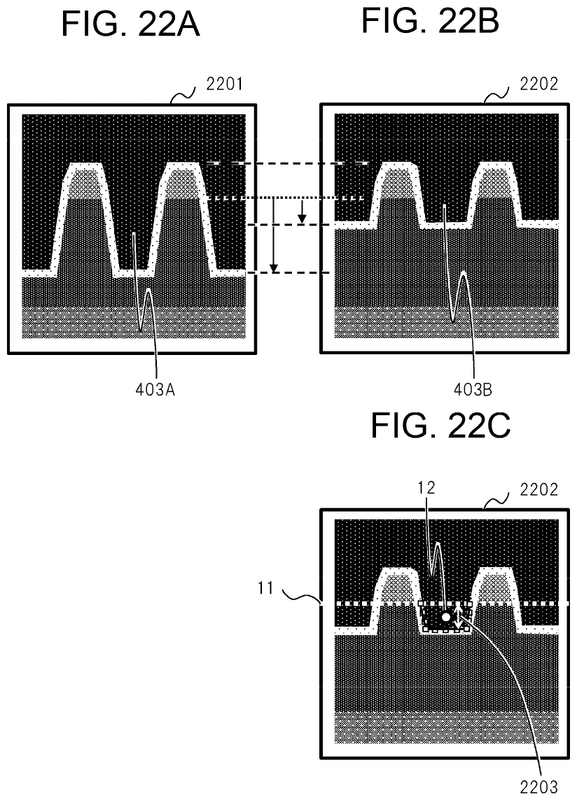

A second advantage is that it is possible to perform dimension measurement even for a structure pattern deviating from a design pattern or a template pattern. Examples of “structure pattern deviating from a design pattern or a template pattern” include a structure pattern as shown in FIG. 22.

For example, (A) in FIG. 22 shows an image 2201 of a cross-sectional structure of a target shape of etching, and (B) in FIG. 22 shows an image 2202 of the actual processed shape after etching. (A) corresponds to a design pattern, or the like. As can be seen by comparing (A) and (B) of FIG. 22, a trench depth of the structure of trench 403B shown in (B) is shallower and differs from the structure of trench 403A in (A). In other words, the trench 403B has a large difference in trench depth from the trench 403A.

In such a case, it is difficult to match a template image using the image 2201 in (A) in FIG. 22 with the image 2202 in (B) in FIG. 22, by using the template matching method of an example in the prior art. In this case, since matching is not possible, the computer system determines that there is no dimension measurement target.

Further, it is difficult to prepare in advance a template image corresponding to the image 2202 in (B) in FIG. 22. In general, when observing the cross-section of a semiconductor that has been processed under certain processing conditions to check its structure, the target structure for processing can be known, but the structure that results from the actual processing cannot be known until it is checked under an electron microscope. Of course, in many cases, electron microscope images taken under optimal etching conditions are not available.

In contrast, according to Embodiment 1, as shown in (C) in FIG. 22, even without a template image, the dimensions of the trench 403B (for example, trench depth 2203) can be measured simply by designating the interface reference line 11 and the area reference line 12 for the image 2202.

### [Plural Target Structures]

According to Embodiment 1, in step S3, on the GUI screen 60, the user U1 can also set interface reference line 11 and area reference points 12 collectively for a plurality of structure patterns in the cross-sectional image 70.

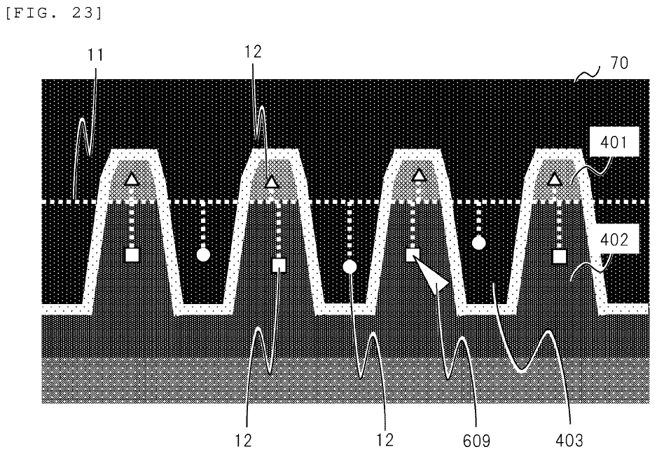

FIG. 23 shows an example in which a plurality of area reference points 12 or the like are set collectively for a plurality of structure patterns, for the target image 70. In the example of FIG. 23, four masks 401, four pillars 402, and three trenches 403 are included in the target image 70. The user U1 performs an operation to designate one interface reference line 11 at the material interface between the mask 401 and the pillar 402. Further, the user U1 performs an operation to designate an area reference point 12 in the area of each structure. For example, the user U1 operates a mouse or the like to sequentially click the position of each area with the cursor 609, thereby designating a plurality of area reference points 12. In this example, the area reference points 12 for the mask 401 are displayed as triangles, the area reference points 12 for the pillars 402 are displayed as squares, and the area reference points 12 for the trenches 403 are displayed as circles.

In this way, according to Embodiment 1, when measuring the lengths of a plurality of structures, the time and effort required for manual operation are less than in an example of the prior art. When the plurality of material interfaces are at the same height position, it is sufficient to designate one interface reference line 11. With respect to the areas of the plurality of structures, any position within each area may be roughly designated, and the position of the area reference point 12 does not need to be precise.

### [Two or More Interface Reference Lines]

In Embodiment 1, a case has been described in which one interface reference line 11 is set for one material interface in a cross-sectional image, but the present invention is not limited to this. It is also possible to set two or more interface reference lines 11 for two or more material interfaces in a cross-sectional image.

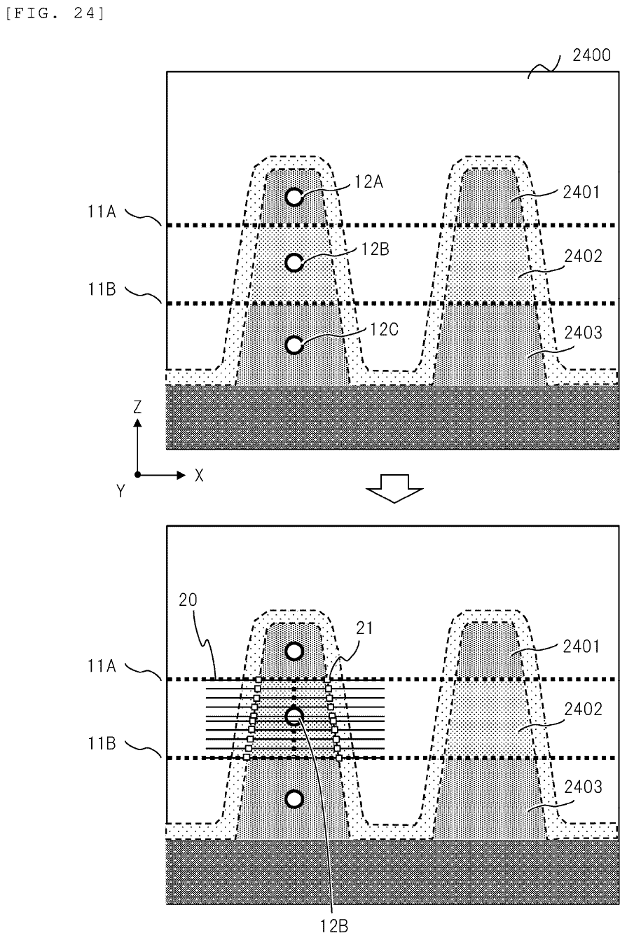

FIG. 24 shows a case where two interface reference lines 11 (11A, 11B) are set in a cross-sectional image 2400. In this example, in the cross-sectional image 2400, there is a three-layer structure having a first layer structure 2401, a second layer structure 2402, and a third layer structure 2403 on a base layer. Each layer is made of a different material and has a different luminance. As material interfaces, there are a first interface between the first layer structure 2401 and the second layer structure 2402, and a second interface between the second layer structure 2402 and the third layer structure 2403. On the GUI screen 60, the user U1 sets an interface reference line 11 at each of the two material interfaces for such a cross-sectional image 2400. An interface reference line 11A is designated for the first interface, and an interface reference line 11B is designated for the second interface.

Further, the user U1 can designate area reference points 12 for the areas separated by interface reference lines 11 corresponding to the respective material interfaces. In this example, area reference points 12A, 12B, and 12C are designated for the first layer structure 2401, the second layer structure 2402, and the third layer structure 2403. Contour detection and dimension measurement are possible for the respective areas designated by the area reference points 12. For example, in the case of the area reference point 12B, as shown in the lower part of FIG. 24, perpendicular lines 13 are drawn from the area reference point 12B to the upper and lower interface reference lines 11A and 11B. In this example, the computer system 1 applies the X-direction line profile 20 to the area that includes the area reference point 12B. The computer system 1 extracts edge candidate points 21 on a plurality of X-direction line profiles 20 within the area. Based on these types of information, the computer system 1 can detect the contour line of the second layer structure 2402 including the area reference point 12B and measure a designated dimension (for example, width).

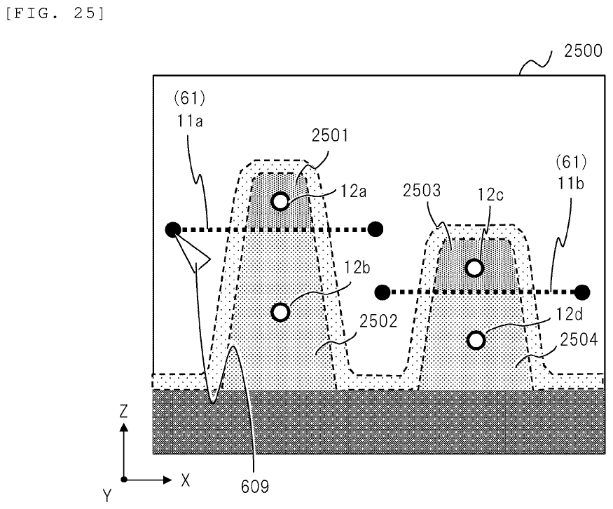

FIG. 25 shows an example in which, when there are two material interfaces at different height positions in a cross-sectional image 2500, two interface reference lines 11 (11a, 11b) at different height positions are set. In this example, the cross-sectional image 2500 includes a structure 2501 at a first height, a structure 2502 at a second height, a structure 2503 at a third height, and a structure 2504 at a fourth height. The material interfaces include a first material interface between the structure 2501 and the structure 2502 and a second material interface between the structure 2503 and the structure 2504. The height of the first material interface is different from the height of the second material interface.

The user U1 uses the interface selection GUI 61 on the GUI screen 60 to designate the interface reference line 11 in accordance with the height position of each material interface. An interface reference line 11a is designated for the first material interface, and an interface reference line 11b is designated for the second material interface. In this example, the interface selection GUI 61 is a GUI that allows each location in the cross-sectional image 2500 to be designated as a line segment. For example, the user U1 operates the cursor 609 with a mouse or the like to designate the start point and the end point of each interface reference line 11. Thus, it is possible to draw interface reference lines 11a and 11b at desired positions. Thereafter, the computer system 1 can detect the contours and measure the dimensions of the structures 2501 to 2504 based on the interface reference lines 11 and area reference points 12, respectively.

In this way, when the height positions of material interfaces at a plurality of locations in a cross-sectional image are different, it is possible to designate interface reference lines 11 at different height positions.

In Embodiment 1, a case has been described in which the interface reference line 11 is set for a material interface between different materials, but without being limited to this, as another modification, a reference line for supporting contour detection or the like may be set at a location other than the material interface. For example, in FIG. 4 and FIG. 10, a reference line in the X direction may be set to the lower part (bottom) of the pillar 402. Furthermore, when it is desired to divide the area of any structure in an image into a number of sections, reference lines indicating the sections may be set. The computer system 1 can use these reference lines as boundaries or edges for predetermined processes such as contour detection.

### [Contour Detection System]

In the dimension measurement system and method of the Embodiment 1, the functional portion up to step S4 in FIG. 5 can be regarded as a contour detection system and method, and may be implemented as such a contour detection system and method. The computer system 1 in this contour detection system and method stores and outputs information relating to the contour or edges of the structure pattern detected from the target image in step S4. For example, the computer system 1 displays an image including edge points 22 and contour lines 24 as shown in FIG. 15, on the GUI screen 60, for the user U1. Any system (for example, an observation device, inspection device, or the like) can use the information regarding the contour or edge generated and output by the contour detection system.

### [Modification]

Regarding Embodiment 1, various modifications are possible, as described below.

In Embodiment 1, the interface reference line 11 is a straight line extending in the horizontal direction (X direction) according to the direction of the material interface in the cross-sectional image, but is not limited to this. In a modification, depending on the content of the cross-sectional image of the target sample, the interface reference line 11 may be a line extending in the vertical direction (Z direction), for example.

### [Modification 1: Interface Reference Line Adjustment Function]

The dimension measurement system and method of Modification 1 of Embodiment 1 may have an adjustment function for adjusting a positional deviation between the material interface of the structure pattern and the interface reference line 11 designated by the user U1.

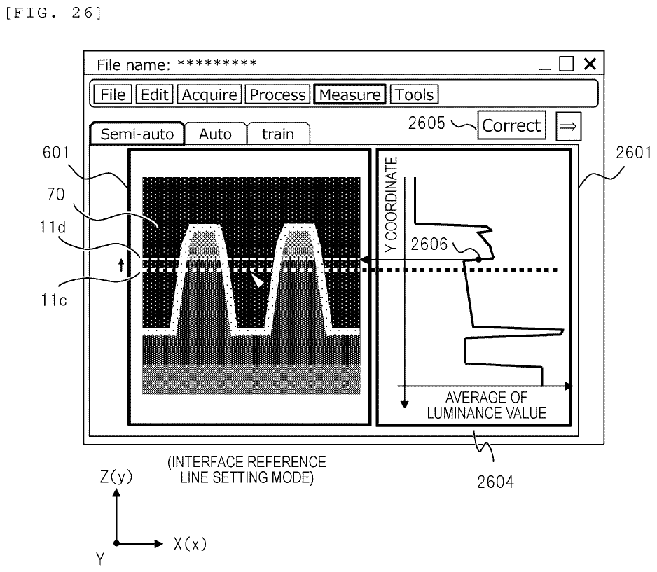

FIG. 26 is an explanatory diagram of the adjustment function (in other words, the interface reference line adjustment function) in Modification 1. In FIG. 26, an example of the GUI screen 60 has an adjustment field 2601 for the interface reference line 11 in addition to an image field 601.

The position of the interface reference line 11 designated and set on the GUI screen 60 of FIG. 6 described above can be a reference for defining the dimension measurement target structure area and the measurement target dimension. This interface reference line 11 can be set by selection by manual operation of the user U1 as shown in FIG. 8 described above, or by estimation by AI, which will be described later. However, the interface reference line set by a human being or estimated by AI may not necessarily coincide with the actual material interface, such as a case where the boundaries between the areas that configure the cross-sectional image are not clear. When this deviation is larger than a certain level, the device may have a significant effect on the accuracy of the dimension measurement.

Therefore, the computer system 1 in Modification 1 adjusts the deviation related to the position of the interface reference line 11 by using the vertical luminance information of the pixels of the target image. In Modification 1, when an image file is selected in step S1 of FIG. 2, a GUI screen 60 as shown in FIG. 26 is displayed. The computer system 1 displays an average graph 2604 of luminance values (in other words, an average profile of luminance values of the y coordinates) in the adjustment field 2601 on the right side of the target image 70 in the image field 601. This average graph 2604 of luminance values is an average graph of a luminance value for each y coordinate (the vertical coordinate in the image) of pixel data configuring the target image 70. In this example, this graph is displayed with the y coordinate of the target image 70 as the vertical axis in the screen, and the average luminance value at each y coordinate as the horizontal axis in the screen.

It is assumed that the user U1 sets the interface reference line 11c on the target image 70 by manual operation in step S3 of FIG. 2. In this case, this interface reference line 11c has a certain level or higher of deviation from the actual interface between the mask and the pillar, and is in the area on the pillar side, for example.

In this state, when the user U1 wants to make an adjustment, the user U1 presses a “Correct” button 2605. Then, the computer system 1 detects a position (position 2606) corresponding to the interface, on the average profile of the luminance values of the y coordinates (average graph 2604). This detection can be based on determining the luminance change as shown. The processor then modifies the interface reference line 11 to match that position 2606. In this example, the post-modified interface reference line 11d is shifted vertically upward from the pre-modified interface reference line 11c, compared to the pre-modified interface reference line 11c, and displayed.

As an algorithm for detecting the interface position using the average graph 2604, since the average luminance values of the profile differ between the mask 401 portion and the pillar 402 portion, a method for calculating and obtaining the first derivative of the profile can be applied. Alternatively, a method for obtaining a local minimum of the profile can be applied. Examples include a method for setting the search range for the interface as a range limited by an appropriate number of pixels in the vertical direction relative to the interface reference line 11c set by the user U1.

The adjustment function in Modification 1 may be included in the software 110 in FIG. 2, or may be prepared as separate adjustment software and stored in the storage 107 or the like. According to Modification 1, it is possible to reduce the effect on the dimension measurement accuracy when the interface reference line 11 has a large deviation.

As another modification, in the interface selection GUI 61 (FIG. 6) for setting the interface reference line 11, when displaying the interface reference line 11 as the initial state, the above adjustment function may be used from the beginning for the target image to automatically determine and display the interface reference line 11.

[Modification 2: Reference Lines Other than Interfaces]

Modification 2 has a function of designating and setting a location other than an interface in a structure in a cross-sectional image as a reference line.

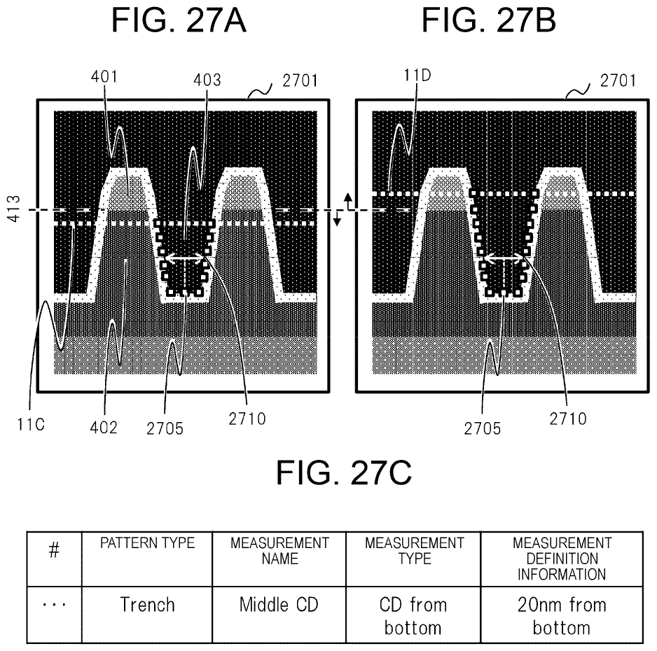

(A) in FIG. 27 shows an example of setting a reference line 11C for a certain cross-sectional image 2701 in Modification 2, and (B) shows an example of setting a reference line 11D for a certain cross-sectional image 2701. In (A), the reference line 11C is set in a position below the material interface 413 in the vertical direction (Z direction) and within the area of the pillar 402. In (B), the reference line 11D is set in a position above the material interface 413 in the vertical direction (Z direction) and within the area of the mask 401.

For example, when the location where the user U1 wants to measure the dimensions is not based on the material interface 413, there is no need to align the position of the reference line (the above-described interface reference line 11) with the material interface 413.

As a specific example, in (A) in FIG. 27, dimension measurement is performed in a position a predetermined distance, for example, 20 nm above the lower part (bottom 2705) of the trench 403. A dimension measurement target line 2710 at that position is shown. In this case, a reference line 11C is designated at a position below the material interface 413. Although not shown, an area reference point 12 is designated below the reference line 11C. The computer system 1 detects the contour of the area corresponding to the trench 403 based on the reference lines 11C and area reference points 12, and measures the dimension at the position of the dimension measurement target line 2710 based on the definition information 112.

Similarly, in (B) in FIG. 27, when performing dimension measurement at the same position as in (A), the reference line 11D is designated at a position above the material interface 413. Similarly, in (B), the dimension can be measured at the position of the dimension measurement target line 2710. In both (A) and (B), the measurement position is the same, and the dimension value at the dimension measurement target line 2710 is the same. Even in either case, the dimension at the position of the dimension measurement target line 2710 is not a dimension that is defined based on the positions of the material interface 413 and the reference lines 11C and 11D, and therefore there is no problem.

In the example of FIG. 27, the lower part (bottom 2705) of the trench 403 can be determined based on the position coordinate information of the edges of the contour detected by the above-described method. For example, among the edge points 22 described above (FIG. 15), the edge point 22 located at the position on the lowest side in the Z direction may be set as the bottom 2705 of the trench 403. Alternatively, the bottom 2705 may be the average value of a plurality of edge points 22 that are close to each other in the Z direction. The dimension measurement target line 2710 can be set at a position, for example, 20 nm above the bottom 2705 in accordance with the definition information 112.

As in Modification 2, the reference line designated in step S3 may be significantly deviated from the material interface 413 in some cases, and may be intentionally designated at a location other than the material interface 413. The reference lines 11C and 11D in Modification 2 do not have the function of indicating the material interface 413, but rather have the function of roughly indicating a portion (for example, the top) of the area of the target trench 403.

(C) in the lower part of FIG. 27 shows an example of setting measurement target dimensions in the definition information 112, such as examples of (A) and (B) of FIG. 27. Such dimensions can also be set or selected on the above-described GUI screen 60.

### [Modification 3: Area Reference Point]

Regarding the function of the area reference point 12, the following modifications are also possible.

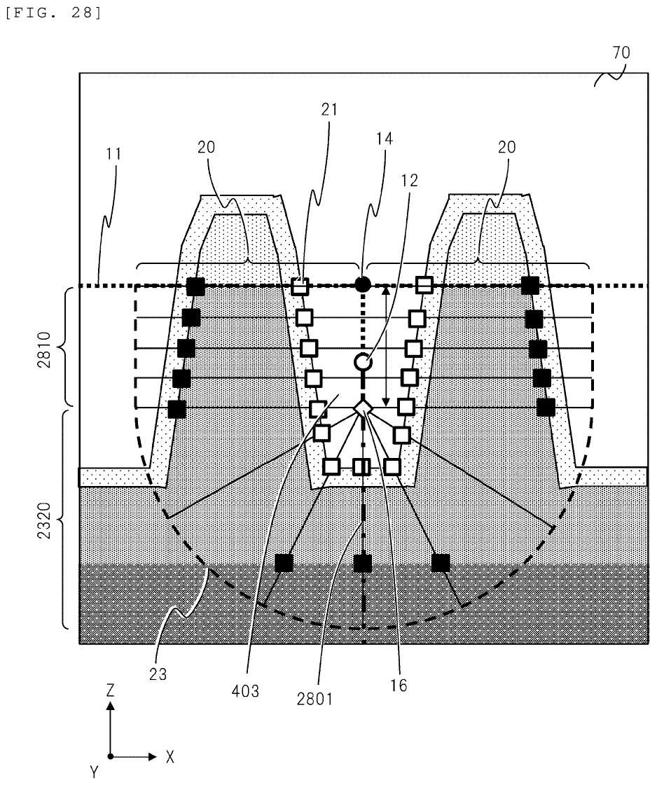

FIG. 28 is an explanatory diagram of Modification 3. In FIG. 28, when an area reference point 12 is designated in the trench 403 in the same target image 70 as in FIG. 10, the area reference point 12 is designated at a higher position in the vertical direction than in the example of FIG. 10. This area reference point 12 roughly indicates the area of trench 403.

In Modification 3, instead of setting an X-direction line profile 20 and a radial line profile 20 with the position of the area reference point 12 as the boundary as in FIG. 10, these two types of line profiles 20 are set using another predetermined method. In FIG. 28, the computer system 1 not only draws a perpendicular line 13 from the area reference point 12 in the direction of the interface reference line 11, but also draws a vertical line 2801 (shown as a dashed line) in the opposite direction, that is, the negative Z direction. For example, as a predefined definition, the computer system 1 takes a reference point 16 (shown as a diamond point) at a predetermined distance position on the perpendicular line 13 and the vertical line 2801 below the intersection 14 of the interface reference line 11 in the Z direction. Then, a rectangular area 2810 from the intersection 14 to the reference point 16 is determined as a first area for extracting the X-direction line profile 20, and a semicircular area 2820 further below the reference point 16 is determined as a second area for extracting the radial line profile 20.

The distance from the intersection 14 to the reference point 16 may be set by the software 110 or the definition information 112. Furthermore, the intervals and number of lines for extracting the line profiles 20 in the first and second areas may be set by the software 110 or the definition information 112.

In Modification 3, two types of line profiles 20 are generated regardless of the position in the Z direction where the area reference point 12 is designated. In the example of FIG. 23, the reference point 16 is set below the area reference point 12, but without being limited thereto, the same applies even when the reference point 16 is set above the area reference point 12.

### [Modification 4: Area Reference Point]

In Modification 4, the area reference point 12 has a function not only to roughly indicate the dimension measurement target structure area, but also to designate a position that defines the measurement target dimension.

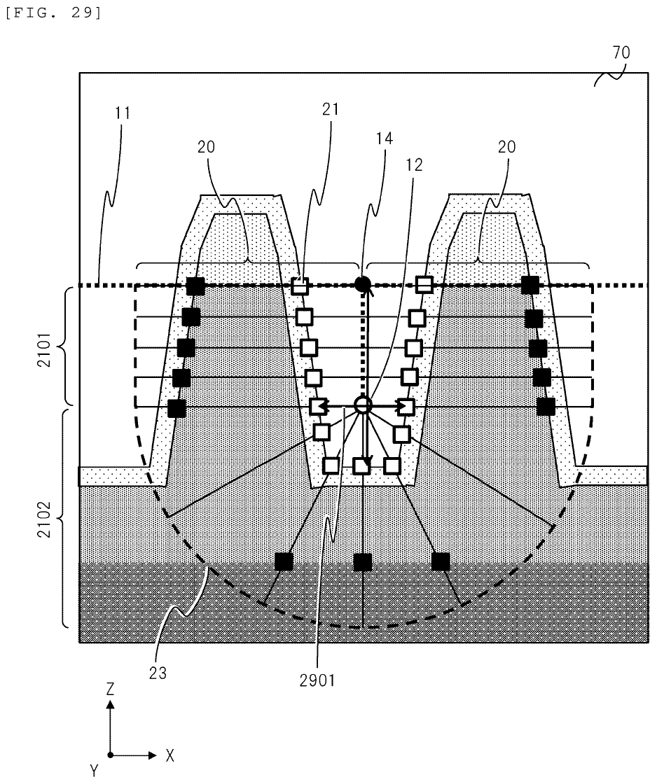

FIG. 29 shows examples of a target image 70, an interface reference line 11, an area reference point 12, a dimension measurement target line 2901, and the like in Modification 4. The designated area reference point 12 not only roughly indicates the area of trench 403, but also designates the vertical position for measuring the trench width (dimension A3 in FIG. 4), as shown by the dimension measurement target line 2901. In other words, in this example, the vertical position for measuring the trench width (dimension A3), as shown by the dimension measurement target line 2901, is not designated by the distance or ratio in the definition information 112 described above, but by the position of the area reference point 12 manually operated by user U1.

The computer system 1 detects the contour of the trench 403 based on the designated interface reference line 11 and area reference point 12, sets a dimension measurement target line 2901 for measuring the trench width (dimension A3) at the position of the designated area reference point 12, and measures the dimension A3.

In another example, by using the area reference point 12, it is possible to designate, for example, a position in the X direction related to the trench depth (dimension A4 in FIG. 4) as a measurement target dimension.

In Modification 4, with respect to the designation of the position of the area reference point 12, a precise position is designated, so that the burden on the user slightly increases, but compared to the method of designating two points of the measurement target dimension as in Comparative Example 2, it is sufficient to designate only one point.

### [Modification 5]

In Embodiment 1, as in the example of FIG. 21 described above, in step S3 of FIG. 5, the user U1 looks at the cross-sectional image on the GUI screen 60 to check whether there is a unsuitable location such as dust, and excludes such a location from the target by not designating the area reference point 12. Thereafter, the computer system 1 automatically executes contour detection and dimension measurement and outputs the results.

As Modification 5, a step of checking by the user U1 may be added between the contour detection process in step S4 and the dimension measurement process in step S5 in FIG. 5. Modification 5 involves the following processing and operations. In Modification 5, a step is provided in which the user U1 checks the contour detection result on the GUI screen 60, after the contour detection process in step S4 in FIG. 5. In this additional step, the result of the contour detection in step S4 is displayed superimposed on the cross-sectional image, on the GUI screen 60, by the computer system 1.

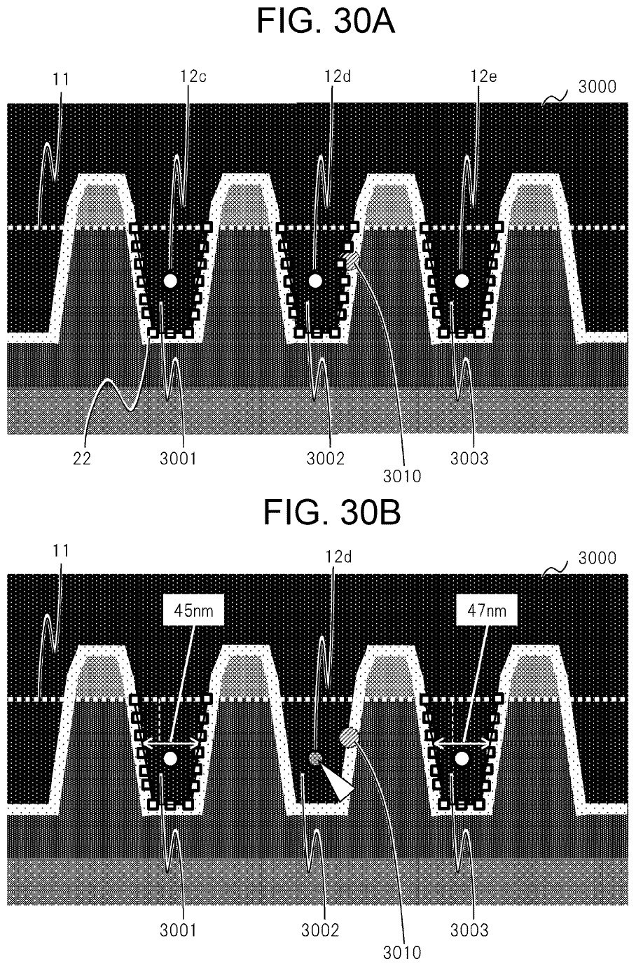

FIG. 30 shows an example of displaying the contour detection result for a target image 3000 in an additional step in Modification 5. In FIG. 30, for example, when area reference points 12 (12c, 12d, 12e) are designated for three trenches 3001 to 3003, the contours (edge points 22, or the like) of those three trenches are detected and displayed as the contour detection results. The user U1 checks and determines whether to perform dimension measurement on these contour detection results as is, and if so, the user U1 presses a dimension measurement execution button (not shown) on the GUI screen 60. Thus, the computer system 1 executes a dimension measurement process based on the contour detection result, and displays the dimension measurement result.

Alternatively, when the user U1 wants to exclude a portion of the contour detection result from the dimension measurement target, the user U1 designates that portion. For example, by the operation of re-designating the displayed area reference point 12 with the cursor 609 or the like, the area reference point 12 can be changed from the ON state to the OFF state. For example, a dust portion 3010 is present in the trench 3002, and is reflected in the contour detection result. When the user U1 does not want to include the trench 3002 in the target, the user U1 operates the area reference point 12d by clicking or the like to change the state to OFF. For example, the display of the area reference point 12d is changed from a display representing the ON state to a display representing the OFF state. Then, the user U1 presses the dimension measurement execution button. Thus, the computer system 1 executes the dimension measurement process while excluding the trench 3002 including the area reference point 12d in the OFF state from the target, and displays the dimension measurement results.

The dimension measurement result is displayed, for example, as (B) in the lower part of FIG. 30. For the trenches 3001 and 3003, for example, the trench widths are displayed as the dimension measurement results. In this manner, in Modification 5, the user U1 can determine a dimension measurement target after viewing the contour detection result.

### Embodiment 2

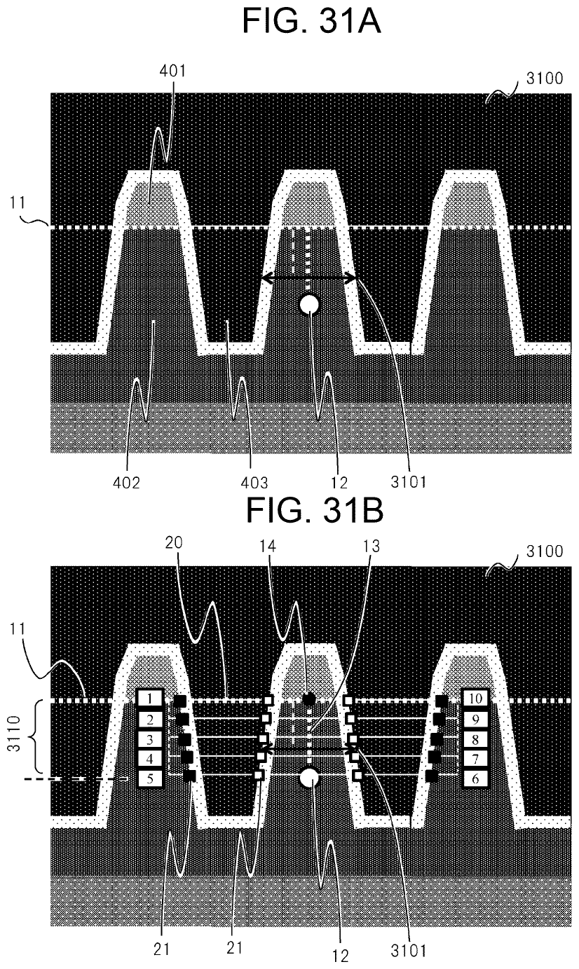

A dimension measurement system or the like according to Embodiment 2 will be described with reference to FIG. 31 or the like. The basic configuration of Embodiment 2 or the like is similar to that of Embodiment 1, and the following mainly describes the configuration of Embodiment 2 or the like that is different from Embodiment 1. In Embodiment 1, as shown in FIG. 10 or the like, a method for detecting the edges of the contour of a structure using two types of line profiles 20, that is, the line profile 20 extending in the X direction and the radial line profile 20 in the radial direction is shown. Without being limited to this, detection of edges using the line profile 20 in the radial direction may not be necessary. Embodiment 2 shows a method for detecting the edge of a contour by using only the line profile 20 extending in the X direction (horizontal direction) without using the radial line profile 20.

### [Contour Detection Using Only Horizontal Line Profile]

FIG. 31 shows an example of detecting edges configuring the contour of a pillar 402 using only a line profile 20 extending in the horizontal direction in Embodiment 2. (A) in FIG. 31 shows an example of an interface reference line 11, an area reference point 12, a dimension measurement target line 3101, or the like in a certain target image 3100. (B) in FIG. 31 shows an example of setting the X-direction line profile 20 based on (A).

As in (A), in the structure of pillar 402, the pillar width (dimension B3 in FIG. 4) is measured in a position a predetermined distance, for example 30 nm, below interface reference line 11 corresponding to the material interface in the Z direction. In this case, a dimension measurement target line 3101 for the pillar width is shown. The user U1 designates an interface reference line 11 in accordance with the material interface, and designates an area reference point 12 within the area of the pillar 402 whose length is to be measured.

In this example, the user U1 designates the area reference point 12 at any position below the dimension measurement target line 3101 in the Z direction. However, here, the position in the Z direction of the area reference point 12 is assumed to be lower than the position in the Z direction at which the pillar width, which is the measurement target dimension, is measured (this is assumed to be condition A).

In this case, the computer system 1 draws a perpendicular line 13 from the designated area reference point 12 to the interface reference line 11 and extracts an intersection 14, as shown in (B). The computer system 1 extracts a plurality of line profiles 20 extending in the X direction in the area 3110 between the area reference point 12 and the intersection 14. The line profile 20 is a straight line perpendicular to the perpendicular line 13 and the direction of the predetermined distance (30 nm). The method for generating the X-direction line profile 20 is the same as in Embodiment 1. In this example, ten line profiles 20 numbered #1 to #10 are extracted.

The computer system 1 uses the acquired plurality of X-direction line profiles 20 to detect the edges that form the contour of the pillar 402 in the same manner as in Embodiment 1. In this example, a plurality of edge candidate points 21 indicated by white square points and edge candidate points 21 indicated by black square points are detected at locations on the line profile 20 where the luminance decreases. For the plurality of edge candidate points 21, an edge point 22 is determined based on the above-described evaluation. For example, a plurality of edge candidate points 21 indicated by white square points are determined as edge points 22 that form the contour line of the pillar 402.

Based on such detected edge information and definition information 112, the computer system 1 can measure the pillar width (dimension B3) for the dimension measurement target line 3101 at a position a predetermined distance (30 nm) below the interface reference line 11 corresponding to the material interface in the pillar 402. Thus, in this example, edge detection using the radial line profile 20 is not necessary.

In order to satisfy the condition A, the following may be performed. The computer system 1 displays within the target image 3100 an image of a guideline corresponding to a dimension measurement target line 3101 at the position where the pillar width, which is the measurement target dimension, is measured based on the definition information 112 and the interface reference line 11, and accepts the designation of an area reference point 12 at a position below the dimension measurement target line 3101. The user U1 can designate the area reference point 12 at a position below the dimension measurement target line 3101, by looking at the image of guideline of the dimension measurement target line 3101.

Alternatively, the following may be performed to cope with the case where the user U1 designates the area reference point 12 above the position where the pillar width is measured. The computer system 1 not only draws a perpendicular line 13 upward from the designated area reference point 12, but also draws a vertical line downward from the area reference point 12. The computer system 1 sets a range on the perpendicular line 13 and the vertical line for extracting a X-direction line profile 20. For example, the computer system 1 may set a range for extracting the X-direction line profile 20, up to a position at a distance set below the intersection 14, or up to a position at a distance set below the area reference point 12. This satisfies the condition A.

As in the above example, in Embodiment 2, contour detection and dimension measurement can be implemented by omitting the radial line profile 20 and performing edge detection using only the X-direction line profile 20, depending on the area reference point 12 and the measurement target structure and dimensions.

In Embodiment 2, only the function of performing edge detection using only the horizontal line profile 20 may be implemented. Alternatively, Embodiment 2 may be configured to have both a function for performing edge detection in the X direction and a function for performing edge detection in the radial direction (Embodiment 3 described below), with the computer system 1 or the user U1 selecting which function to use. For example, the computer system 1 may receive designation of definition information 112 and a measurement target structure (for example, a pillar), as well as designation of the interface reference line 11 and the area reference point 12, on the GUI screen 60, and determine which function to use based on their positional relationship or the like, and automatically apply the function.

### Embodiment 3

Embodiment 3 shows a method for detecting the edge of a contour by using only the radial line profile 20, without using the horizontal line profile 20.

### [Contour Detection Using Only Radial Line Profiles]

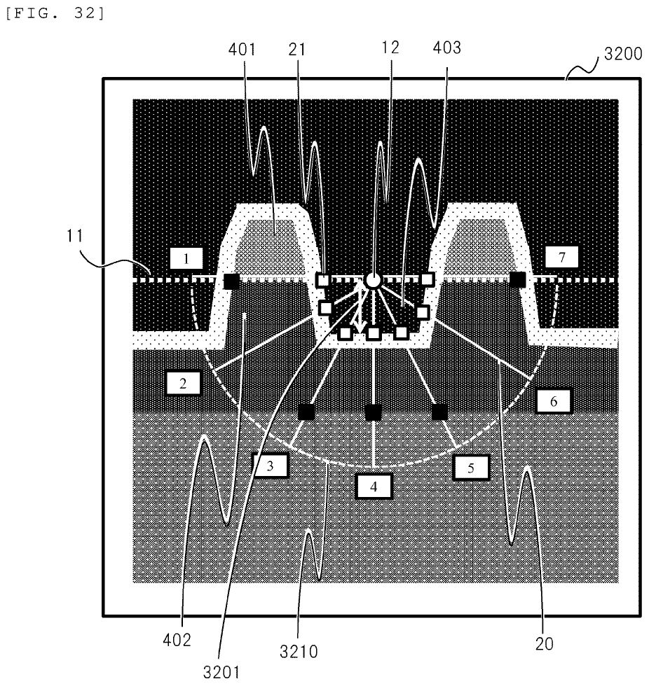

FIG. 32 shows an example of detecting edges configuring the contour of a trench 403 using only a radial line profile 20 in Embodiment 3. FIG. 32 shows an example of an interface reference line 11, an area reference point 12, a dimension measurement target line 3201, a radial line profile 20, or the like in a certain target image 3200.

For example, when detecting the contour and measuring the dimensions of a shallow trench structure (a trench 403 with a relatively small trench depth) as shown in FIG. 32, an area reference point 12 may be designated and positioned on an interface reference line 11 corresponding to the material interface. In that case, as shown, the above-described perpendicular line 13 does not exist. Therefore, in Embodiment 3, the computer system 1 sets only the radial line profile 20 in the semicircular range 3210 below the area reference point 12. In this example, seven line profiles 20 numbered #1 to #7 are set. The computer system 1 detects the edges of the contour of the trench 403 on the radial line profile 20. In this example, edge candidate points 21 are detected on each line profile 20. Based on the edge candidate points 21, the above-described edge points 22 are determined. The contour line of the trench 403 can be formed based on the edge points 22.

In addition, in FIG. 32, regarding the positional relationship between the interface reference line 11 and the area reference point 12 designated by the user U1, even when their vertical positions do not match, if the difference between their positions is small within a predetermined range, the computer system 1 may assume that the area reference point 12 is designated on the interface reference line 11, and apply edge detection in the radial direction.

In this example, the trench depth (dimension A4 in FIG. 4) is an example of the measurement target dimension, and a corresponding dimension measurement target line 3201 (indicated by a white arrow) is shown. Based on such detected edge information and definition information 112, the computer system 1 can measure the trench depth for the dimension measurement target line 3201 set between the interface reference line 11 corresponding to the top of the trench 403 and the bottom of the trench 403 based on the contour line. Thus, in this example, edge detection using the X-direction line profile 20 is not necessary.

Similar to Embodiment 2, in Embodiment 3, only the function of detecting edges in the radial direction may be provided, both functions may be implemented and the user is able to select the function to be used, or the computer system 1 may automatically determine which function to use.

### Embodiment 4

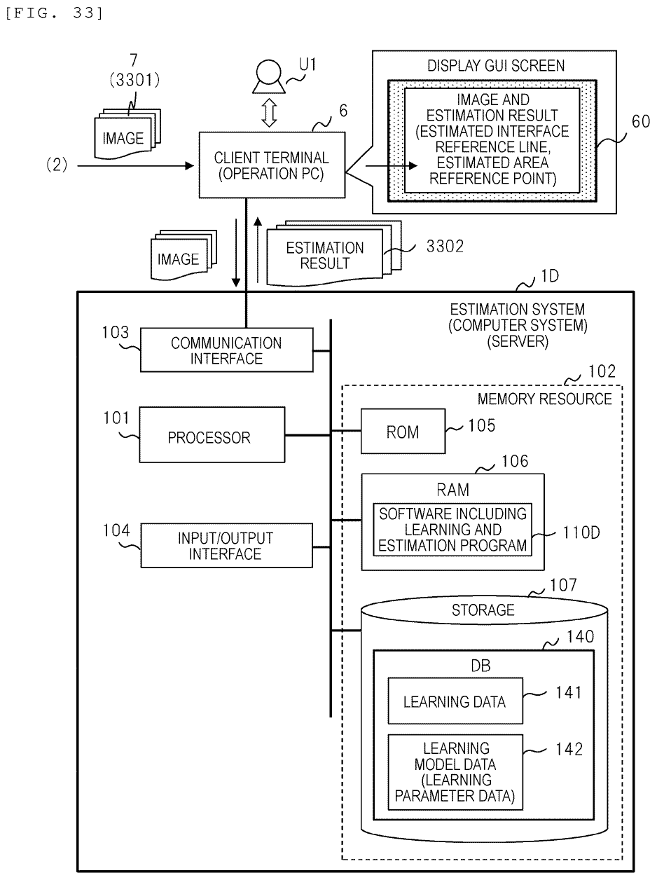

An estimation system and method according to Embodiment 4 will be described with reference to FIG. 33 or the like. In Embodiment 4 and Embodiment 5 described below, the dimension measurement system and method of Embodiment 1 or the like are used as a base, and machine learning by AI is further added. In Embodiments 4 and 5, AI machine learning is applied to the step of designating and setting the interface reference line 11 and the area reference point 12 by manual operation by the user U1 in step S3 of FIG. 5.

In particular, the estimation system and method of Embodiment 4 are an independent system and method in which only the machine learning and estimation parts for the interface reference line 11 and the area reference point 12 in the cross-sectional image are separated. The estimation system and method of Embodiment 4 additionally includes a step in which the computer system 1 performs machine learning on the interface reference line 11 and area reference point 12 for the cross-sectional image, and estimates the interface reference line 11 and area reference point 12 from the input target image based on the learning model and presents the estimated reference line and the estimated reference point to the user U1. Embodiment 5, which will be described later, corresponds to a form in which the functional parts of Embodiment 4 are added to the dimension measurement system and method of Embodiment 1.

This makes it easier to specify a material interface and a structure pattern area from a cross-sectional image in Embodiment 4. In Embodiment 5, the time and effort involved in the steps in which the user U1 manually inputs, designates, and sets the interface reference line 11 and the area reference point 12 can be further reduced, thereby making the overall work more efficient.

In other words, the system in Embodiment 4 is an interface reference line and area reference point estimation system, a material interface estimation system, a dimension measurement target structure area estimation system, a measurement target dimension estimation system, and the like.

### [Machine Learning Target]

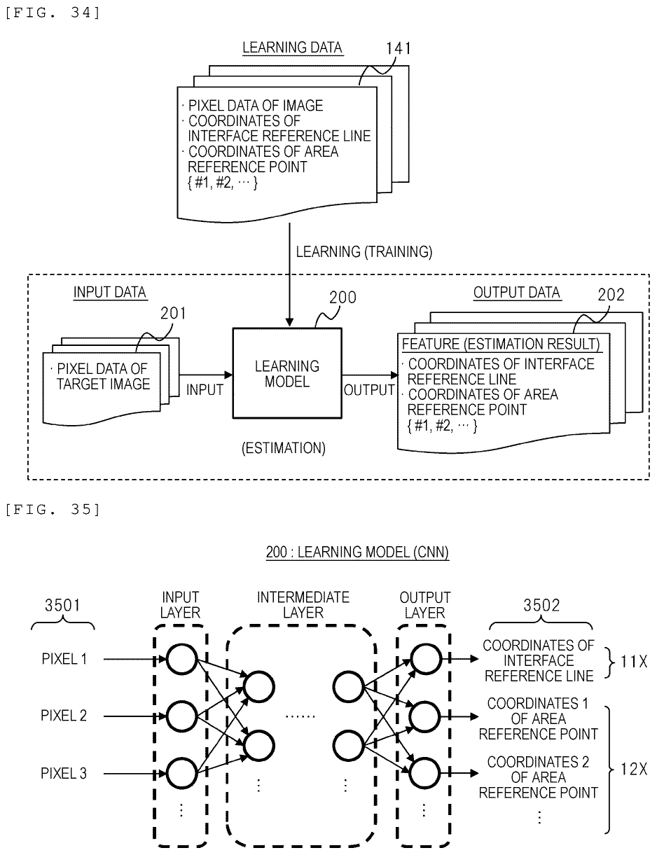

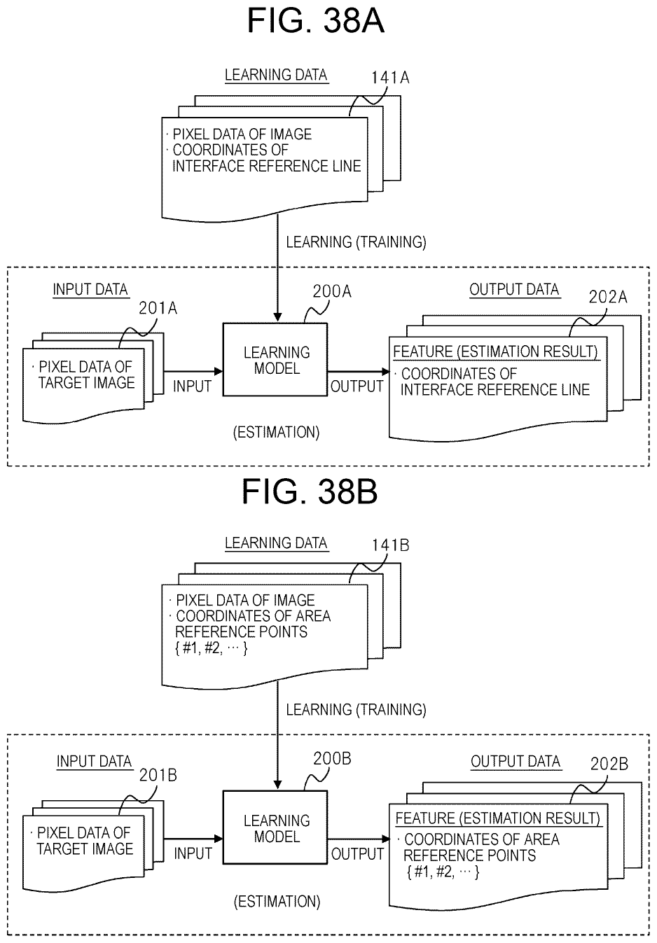

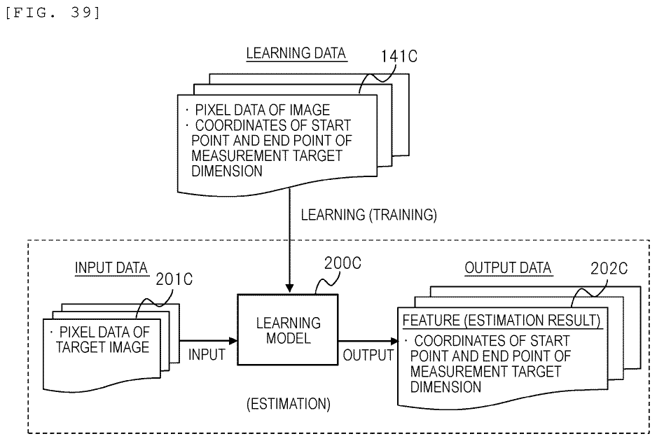

In Embodiment 4, the following three forms are possible with respect to the subject of machine learning. In Embodiment 4, the following case 3 (FIG. 34) will be described in particular, but without being limited thereto, the following cases 1 and 2 are also possible, as shown in modification (FIG. 38).

1. A form in which machine learning and estimation are performed only on the interface reference line 11.

2. A form in which machine learning and estimation are performed only on the area reference points 12.

3. A form in which machine learning and estimation are performed on both the interface reference line 11 and the area reference point 12.

In Embodiment 4, the computer system 1 constructs a DB including a machine learning model, by using the cross-sectional image and information including the position coordinate information of the interface reference line 11 and information including the position coordinate information of the area reference point 12, which are included in the dimension measurement results in Embodiment 1. The computer system 1 utilizes image recognition technique using machine learning or the like to estimate material interfaces (and corresponding interface reference 11) and dimension measurement target structure areas (corresponding area reference points 12), which are difficult to detect using normal image recognition.

The dimension measurement result 8 (FIG. 2) in Embodiment 1 includes information on the interface reference line 11 and the area reference point 12 set in step S3. Alternatively, information on the interface reference line 11 and the area reference point 12 may be stored in a form associated with information such as the dimensional values in the dimension measurement result 8. In Embodiment 4, these types of information are utilized.

### [Computer System]

FIG. 33 shows the configuration of a computer system 1D which is an estimation system according to Embodiment 4. The configuration of FIG. 33 is roughly the same as that of FIG. 2, but has the following different configuration. The computer system 1D has the function of estimating the interface reference line 11 and the area reference point 12 in the cross-sectional image using AI machine learning.

The memory resource 102 of the computer system 1D, for example the RAM 106, stores software 110D including a learning and estimation program. This software 110D is data that implements processing functions including AI machine learning and estimation in Embodiment 4. The computer system 1D stores a DB 140 for AI machine learning and the like in the storage 107. The DB 140 is data handled by the software 110D, and includes learning data 141 related to machine learning and the like, and learning model data 142.

The learning data 141 is a data set for training AI, in other words, a data set necessary for machine learning, a data set for training a model, and includes data such as the above-described image 7. The learning model data 142 is a data set of a machine learning model, and data of a model generated based on the learning data 141, and includes data of learning parameters optimized by learning. The contents of the learning data are as shown in FIG. 34, or the like.

### [Machine Learning and Estimation]

FIG. 34 shows a configuration of the input/output relationship for the learning model 200 of machine learning in Embodiment 4. In the learning phase, the computer system 1D uses the learning data 141 to construct and train the learning model 200. The learning model 200 is a model in which the learning parameters included in the learning model data 142 are set. The learning data 141 is data including pixel data of the cross-sectional image, coordinates of the interface reference line 11, coordinates of the area reference point 12 (if there are a plurality of points, the points are called points #1, #2, . . . ), and the like. The learning data 141 can be data that has been used in the past by the system of Embodiment 1 and is stored, and in which the user U1 has designated the interface reference line 11 and the area reference point 12 in the target image.

In the estimation phase, the computer system 1D inputs input data 201 including cross-sectional images that are actually the subject of dimension measurement, or the like, to the latest trained learning model 200. The computer system 1D performs estimation processing on input data 201 using the learning model 200, and outputs the estimation result as output data 202. The output data 202 is data of features estimated from the input target image, and includes the coordinates of the estimated interface reference line 11 (referred to as an estimated interface reference line 11X), the coordinates of the estimated area reference point 12 (referred to as an estimated area reference point 12X), or the like.

The computer system 1D or any other system can optionally use the estimation result 3302 (FIG. 33), which is the output data 202. For example, the computer system 1D may display the estimated interface reference line 11X and the estimated area reference point 12X, which are the estimation results 3302, on the target image on the GUI screen 60, and present them to the user U1 as suggested or recommended information. The user U1 may check the estimated interface reference lines 11X and estimated area reference points 12X on the GUI screen 60 and use them as they are or can modify them before use.

The processor 101 of the computer system 1D in FIG. 33 executes all processes in accordance with the software 110D loaded from the storage 107 onto the RAM 106. Thus, a processing function relating to learning and estimation as shown in FIG. 34 is implemented. Image data 3301 is image data that is newly input to the AI. For example, the image 7 is acquired from the SEM 2 by the operation PC 6, and the image 7 is set as image data 3301. The image data 3301 is transmitted from the operation PC 6 to the computer system 1D. The computer system 1D stores the image data 3301 as part of the learning data 141. Without being limited thereto, for example, the image data 3301 of the image 7 acquired by the computer system 1D from the SEM 2 may be used as learning data. Image data stored in another storage or DB server, or the like, external to the computer system 1D may be used as learning data.

The estimation result 3302 is data of the estimation result by the AI learning model 200. The computer system 1D generates, stores, and outputs the estimation result 3302 as output data 202 of the learning model 200, for a target image of the input data 201 (for example, an image designated from the operation PC 6). The computer system 1D transmits the estimation result 3302 to the operation PC 6. The operation PC 6 displays, on the GUI screen 60, an estimated interface reference line 11X and an estimated area reference point 12X as the estimation result 3302 on the cross-sectional image corresponding to the input target image (FIG. 37 described later).

### [Accumulation of Learning Data]

The computer system 1D accumulates learning data 141. For that purpose, related information such as image data and shooting information 111 from the SEM 2 and the operation PC 6, and information on the coordinates of the interface reference line 11 and the coordinates of the area reference point 12 contained in the past dimension measurement results 8 is stored in the learning data 141 of the DB 140. In the following, it is assumed that the learning data 141 has already been stored in the DB 140 of the storage 107.

### [Generation of Learning Model]

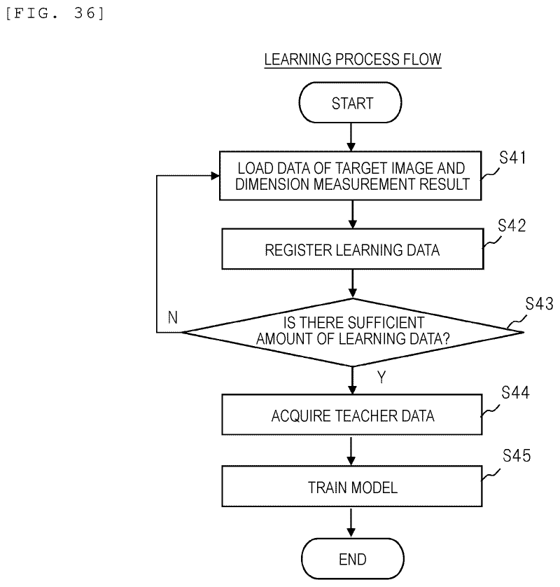

The computer system 1D constructs and generates a learning model 200 based on the learning data 141 in the DB 140. FIG. 35 shows a configuration example of the learning model 200 of machine learning. In this example, a convolutional neural network (CNN), which is an example of a neural network, is used as the learning model 200. This CNN propagates pixel information 3501 of an image input to the input layer, in order, to the intermediate layer and output layer, and performs calculations. Thus, the CNN outputs estimated interface coordinates (coordinates of the estimated interface reference line 11X) and one or a plurality of structure area coordinates (coordinates of the estimated area reference point 12X) from the output layer. In the intermediate layer, a plurality of convolutional layers and the like are repeated. The interface coordinates are estimation values of the position coordinates for the interface reference line 11 that represents the material interface 413. The structure area coordinates are estimation values of the position coordinates for the area reference point 12 that represents an area of a structure pattern that is the target of dimension measurement or the like.

In the learning phase of FIG. 34, the parameters of the intermediate layer (included in the learning model parameters 142) are adjusted such that the error between the interface coordinates and structure area coordinates, output by the learning model 200 which is a CNN, and the interface coordinates and structure area coordinates of a correct solution is minimized.

The specific layer structure of the CNN varies depending on the learning model employed, and the details are not limited thereto. In Embodiment 4 (FIG. 35), a case where the learning model 200 to be applied is CNN has been shown, but the application is not limited to this. Any machine learning model that can output interface coordinates and structure area coordinates for the input of image information such as pixel data can be applied.

### [Flow of Learning Phase]

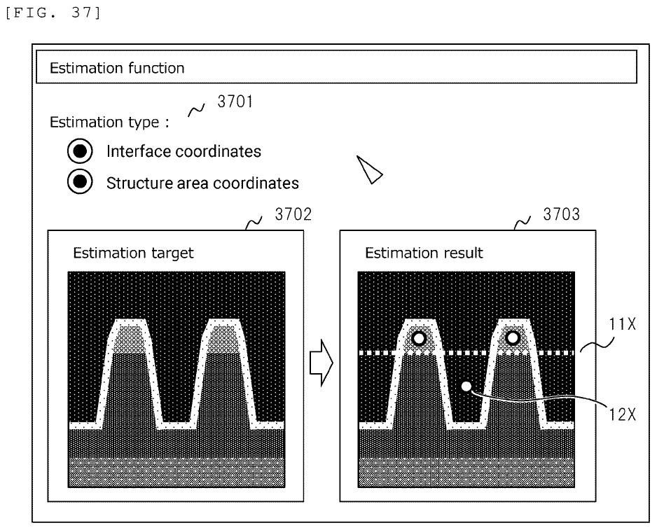

FIG. 36 shows a learning process flow of the learning phase in Embodiment 4, and has steps S41 to S45. In step S41, the user U1 operates the GUI on the GUI screen 60 on the display of the operation PC 6, and loads the data of the target image and the dimension measurement result 8 of the target image into the computer system 1D. In step S42, the computer system 1D registers and stores in the DB 140 as learning data 141 the data including the coordinates of the interface reference line 11 and the coordinates of one or more area reference points 12 contained in the data of the target image and dimension measurement result 8 loaded in step S41.

In order to train the AI learning model 200, sufficient learning data is required to achieve accuracy. Therefore, the computer system 1D does not perform learning of the learning model 200 until the amount of registered and accumulated learning data is a certain amount or more set in advance. That is, in step S43, the computer system 1D determines whether the amount of learning data accumulated as learning data 141 has reached a certain amount set in advance, and if the amount has not yet reached the certain amount (N), the computer system 1D returns to step S41 and repeats the process, whereas if the amount has reached the certain amount (Y), the computer system 1D proceeds to step S44.

In step S44, the computer system 1D acquires the pixel data of the target image and the coordinates of interface reference line and the coordinates of one or more area reference points, in the learning data 141 stored in the storage 107, as teacher data for the learning model 200 (learning data 141 in FIG. 34).

Then, in step S45, the computer system 1D uses the teacher data acquired in step S44 (learning data 141 in FIG. 34) to learn and train the learning model 200, and generates and updates the learning model. As described above, in learning, pixel data of the target image of the teacher data is input as input data 201 to the learning model 200 (CNN in FIG. 35), and learning is performed such that the interface coordinates and structure area coordinates in the output data 202 output as the estimation result are close to the coordinates of the interface reference point 11 and the coordinates of the area reference point 12 of the correct solution of the teacher data.

Examples of GUIs on the GUI screen 60 relating to the learning phase include the followings. On the GUI screen 60 of FIG. 6 described above, a “train” tab is provided as one of the tabs 603. When performing model learning, the user U1 performs an operation such as clicking on the “train” tab. In response to the operation, the computer system 1D switches the content/mode of the GUI screen 60 to a model learning GUI screen. The user U1 operates the “File” button on the model learning GUI screen to select the file of the target image to be used for learning, with a mouse or the like, and operates the “Enter” button to load the data of the selected file. The computer system 1D also reads data such as the interface reference line 11 and area reference point 12 in the dimension measurement result 8 as various types of data associated with the image, in addition to the pixel data of the selected target image.

### [GUI Screen: Estimation Phase]

FIG. 37 shows a display example of a GUI screen 60 in the estimation phase. FIG. 37 shows an example of a screen of the estimation function. This screen has an estimation type field 3701. In the estimation type field 3701, interface coordinates (in other words, interface reference line coordinates) and structure area coordinates (in other words, area reference point coordinates) can be selected as the estimation target by turning on or off. In an estimation target image field 3702, the estimation target image to be input is selected and displayed. In an estimation result image field 3703, the output estimation result information is displayed superimposed on the estimation target image. In this example, the estimated interface reference line 11X and the estimated area reference point 12X relating to the mask and trench are displayed in the estimation result image field 3703. The type of structure to be estimated may also be selectable on this screen.

### [Effects of Embodiment 4]

According to the estimation system and method of Embodiment 4, the manual setting steps in the semi-automatic method in Embodiment 1 can be automated using machine learning, thereby reducing the time and effort of the manual operation by the user U1.

Of course, it is also possible to add various functions and steps of Embodiments 1 to 3 to the system and method of Embodiment 4.

### [Modification (1)]

As a modification of Embodiment 4, the following is possible. In Embodiment 4, as shown in FIG. 34, the learning by the learning model 200 is assumed to be learning of both the interface reference line 11 and the area reference point 12. In contrast, in the modification, the learning is divided into two parts: learning of the interface reference line 11 and learning of the area reference point 12.

FIG. 38 shows a learning model or the like in a modification. (A) shows a first learning model 200A, and (B) shows a second learning model 200B. In this modification, for example, the coordinates of the interface reference line 11 representing a material interface are learned using the first learning model 200A, and the coordinates of the area reference point 12 representing an area of a structure pattern that is the subject of dimension measurement, or the like are learned using the second learning model 200B. The structure of the learning models 200A and 200B can be, for example, a CNN similar to that shown in FIG. 35.

In the learning phase, the first learning model 200A in (A) is trained using learning data 141A including the coordinates of the interface reference line 11, and the second learning model 200B in (B) is trained using learning data 141B including the coordinates of one or more area reference points 12.

In the estimation phase, a target image is input to the first learning model 200A in (A) as input data 201A, and data including the coordinates of an estimated interface reference line 11X is output as output data 202A. A target image is input to the second learning model 200B in (B) as input data 201B, and data including the coordinates of an estimated area reference point 12X is output as output data 202B.

As a modification, a system and method may be adopted that only performs learning and estimation using the first learning model 200A of (A), or a system and method may be adopted that only performs learning and estimation using the second learning model 200B of (B).

### [Modification (2)]

As another modification of Embodiment 4, the following is possible. This modification has a function of estimating the reference point coordinates for dimension measurement. In this modification, the estimation target is not the coordinates of the area reference point 12 of the structure pattern area, but is the position of the measurement target dimension in the structure pattern area. In particular, the estimation target is the start point coordinates and end point coordinates of the measurement target dimension, in other words, the coordinates of two points that define the dimension measurement target line.

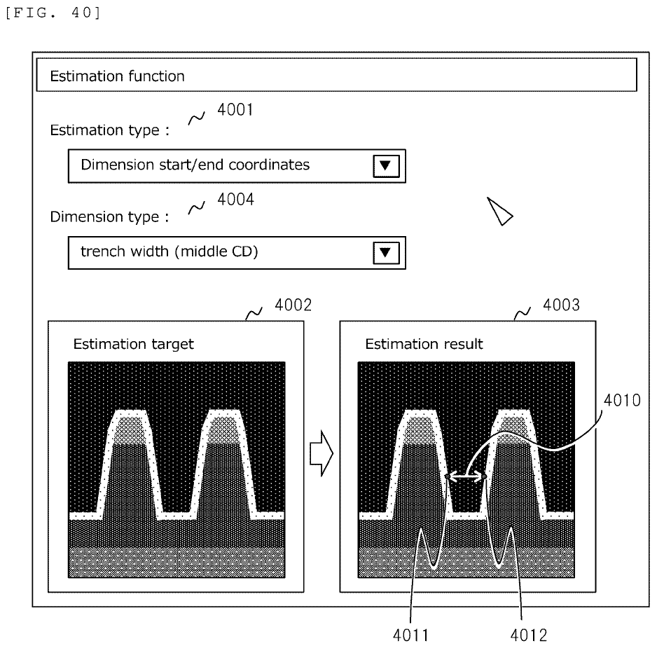

FIG. 39 shows a learning model 200C or the like in this modification. The learning data 141C in the learning phase includes data on the start point coordinate and the end point coordinate of the measurement target dimension of the target image. The output data 202C that is output as an estimation result from the learning model 200C in the estimation phase includes the data on the start point coordinate and the end point coordinate of the measurement target dimension.

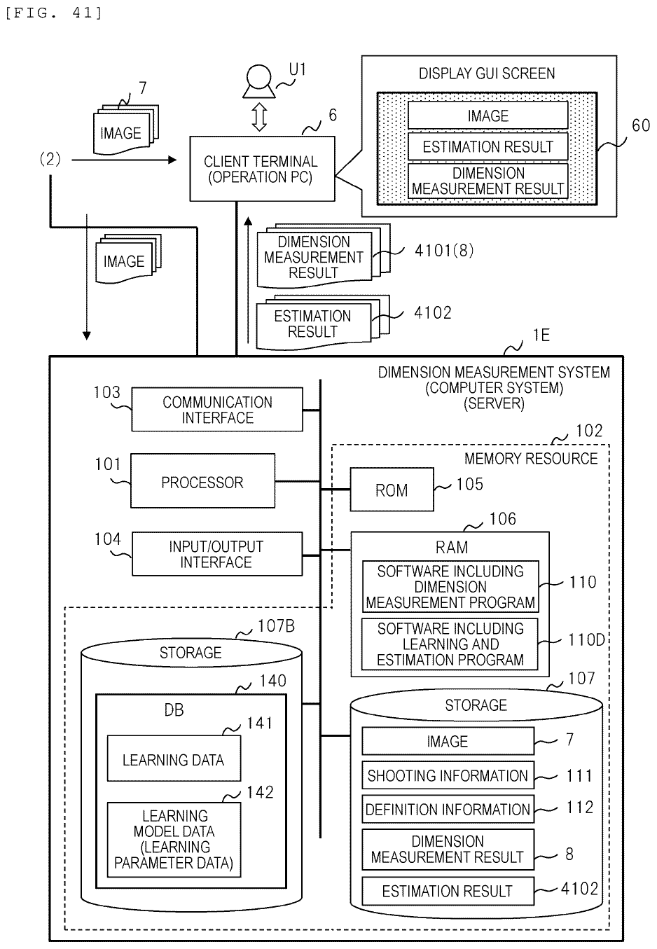

FIG. 40 shows an example of displaying the estimation result on the GUI screen 60 in this modification. In this example, “the start point coordinate and the end point coordinate of dimension” are selected in an estimation type field 4001. In a dimension type field 4004, for example, trench width (middle CD) is selected as the dimension type to be estimated. In an estimation target image field 4002, the estimation target image is displayed. In an estimation result image field 4003, the coordinates of the start point 4011 and an end point 4012 of the measurement target dimension as the estimation result are plotted on the estimation target image, and are displayed together with the dimension measurement target line 4010.

### Embodiment 5

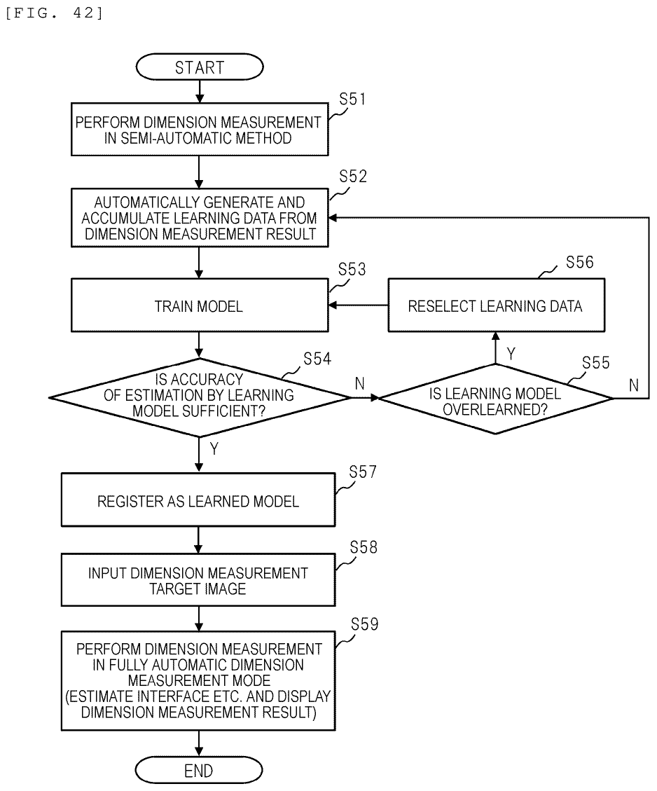

A dimension measurement system and the like according to Embodiment 5 will be described with reference to FIG. 41 or the like. Embodiment 5 is a form in which Embodiment 1 and Embodiment 4 are merged into one, and has both the contour detection and dimension measurement functions in the semi-automatic method described above and the estimation function by machine learning.

The system and method of Embodiment 5, in the learning phase, using the functions of the system in Embodiment 1, the user U1 designates an interface reference line 11 and an area reference point 12 for a target image, performs contour detection and dimension measurement in a semi-automatic method, and accumulates data including the interface reference line 11 and the area reference point 12 at this time as learning data 141. The system and method of Embodiment 5 uses the learning data 141 to train the learning model 200.

In the estimation phase, the system and method of Embodiment 5 uses the functions of the system of Embodiment 4 to output an estimated interface reference line 11X representing the material interface and one or more estimated area reference points 12X representing the dimension measurement target structure area, as output of estimation results, using the learning model 200, for an input target image. The system and method of Embodiment 5 detects the contour and measures the dimensions of the target image, based on the estimation results. The system and method of Embodiment 5 may display the estimated interface reference line 11X and the estimated area reference point 12X to the user U1 on the GUI screen 60, allowing the user U1 to check and modify them.

### [Dimension Measurement System]

FIG. 41 shows a configuration example of a computer system 1E which is a dimension measurement system according to Embodiment 5. This computer system 1E is a system in which the computer system 1 in FIG. 2 and the computer system 1D in FIG. 33 are merged into one. This computer system 1E automatically accumulates the dimension measurement results in the semi-automatic method as learning data 141, and learns and estimates the interface reference line 11 and area reference point 12 by the learning and estimation function. This computer system 1E displays the estimation results 4102 (estimated interface reference line 11X and estimated area reference point 12X) based on the learning model on the GUI screen 60, performs automatic dimension measurement using the estimation results 4102, and displays the dimension measurement results 4102 (8) on the GUI screen 60.

In the memory resource 102 of the computer system 1E, for example, in the RAM 106, software 110 including the dimension measurement program in Embodiment 1 and software 110D including the learning and estimation program in Embodiment 4 are stored. The processor 101 implements each function by performing processing in accordance with the software 110 and the software 110D. The software 110 also implements a function of automatically performing dimension measurement using the estimation result 4102 by the software 110D. In addition, in Embodiment 5, the user U1 can select whether to use manual setting in the semi-automatic method as in Embodiment 1 or automatic estimation using the estimation function as in Embodiment 4, depending on the mode setting.

In addition to the same data and information as in Embodiment 1, the storage 107 also stores the estimation results 4102 by the software 110D. Further, another storage 107D includes the same DB 140 as in Embodiment 4. The storage 107 and the storage 107D may be integrated into one.

Similar to Embodiment 4, the image 7 of a target and the associated shooting information 111 and definition information 112 can be input from the SEM 2 or the operation PC 6 to the computer system 1E and stored in the storage 107 or storage 107D. The computer system 1E transmits the estimation result 4102 and the dimension measurement result 4101(8) to the operation PC 6, and the operation PC 6 displays the image 7 of the target, the estimation result 4102, the dimension measurement result 4101(8), or the like on the GUI screen 60.

### [Automatic Dimension Measurement]

FIG. 42 shows a process flow of automatic dimension measurement in Embodiment 5, and has steps S51 to S59. In step S51, the computer system 1E inputs an image 7 of a dimension measurement target, shooting information 111, and definition information 112, based on the input operation of the user U1 on the operation PC 6, performs dimension measurement using the dimension measurement function in the semi-automatic method in Embodiment 1, and obtains the dimension measurement result 8. The image 7 and the dimension measurement result 8 are displayed on the GUI screen 60 of the operation PC 6.

In step S52, the computer system 1E automatically generates learning data 141 for learning purposes from the dimension measurement result 8 in step S51 (data including the interface reference line 11 and the area reference point 12), and registers the data in the DB 140. In step S53, the computer system 1E uses the selected learning data 141 to construct and train a learning model 200 (similar to that shown in FIG. 34, for example).

In step S54, the computer system 1E checks whether the accuracy of the estimation by the learning model is sufficient. If it is sufficient (Y), the process proceeds to step S57; if it is insufficient (N), the process proceeds to step S55. In step S55, the computer system 1E checks whether the learning model is overlearned, and if it is overlearned (Y), the process proceeds to step S56, and if it is not overlearned (N), the process returns to step S52. In step S56, the computer system 1E reselects the learning data 141 to be used for learning, and returns to step S53.

In step S57, the computer system 1E registers the learning model with sufficient accuracy as a learned model. In step S58, the computer system 1E inputs the image 7 of the dimension measurement target, based on the operation of the user U1 on the operation PC 6. Furthermore, the user U1 selects the fully automatic dimension measurement mode on the GUI screen 60. In step S59, the computer system 1E performs dimension measurement on the target image, which is the input image, in the fully automatic dimension measurement mode. Details of step S59 may be as follows, for example.

As a first processing example, the computer system 1E automatically performs contour detection and dimension measurement without presenting the estimation result 4102 to the user U1. In this case, the computer system 1E inputs pixel data of the input image into a learning model of the estimation function, and obtains the estimated interface reference line 11X and the estimated area reference point 12X as the estimation result 4102. The computer system 1E detects the contour of the target structure from the target image using the position coordinate information of the estimated interface reference line 11X and the estimated area reference point 12X, measures the designated dimensions based on the detected contour, or the like, and obtains the dimension measurement result 4101. The computer system 1E transmits the dimension measurement result 4101(8) to the operation PC 6, and causes the dimension measurement result 4101(8) to be displayed on the GUI screen 60.

As a second processing example, the computer system 1E presents the estimation result 4102 to the user U1, and after the user U1 checks the estimation result 4102, the computer system 1E performs contour detection and dimension measurement. In this case, the computer system 1E inputs pixel data of the input image into a learning model of the estimation function, and obtains the estimated interface reference line 11X and the estimated area reference point 12X as the estimation result 4102. The computer system 1E transmits the estimation result 4102 including the estimated interface reference line 11X and the estimated area reference point 12X, to the operation PC 6. The operation PC 6 displays the estimated interface reference line 11X and estimated area reference point 12X of the estimation result 4102 on the target image on the GUI screen 60. The user U1 checks the estimation result 4102 on the GUI screen 60, and if the user U1 wants to apply the estimation result as is, the user applies it as is by operating a predetermined button, or the like, if the user U1 wants to modify the estimation result, the user U1 manually modifies it and then applies it, and if the user U1 wants to reject (not apply) it, the user U1 rejects the estimation result by operating a predetermined button, or the like. When user U1 checks and applies the estimation result 4102, the computer system 1E detects a contour from the target image using the applied estimated interface reference line 11X and estimated area reference point 12X, measures the designated dimensions based on the detected contour, or the like, and obtains the dimension measurement result 4101. The computer system 1E transmits the dimension measurement result 4101(8) to the operation PC 6, and causes the dimension measurement result 4101(8) to be displayed on the GUI screen 60.

### [Effects of Embodiment 5]

The dimension measurement system and method according to Embodiment 5 have the following advantages. Because the user U1 performs the length measurement work in the semi-automatic method according to Embodiment 1, it is possible to accumulate learning data without being particularly conscious of it. According to Embodiment 5, the learning model in Embodiment 4 can be trained using accumulated learning data, thereby improving the accuracy of estimation of material interfaces, structure areas, and the like. Then, by using the estimation results from the learning model, the interface reference line 11 and the area reference point 12 can be set more easily and more accurately, making the length measurement work more efficient.

Although the embodiments of the present disclosure have been specifically described above, the present disclosure is not limited to the above-described embodiments and can be modified in various ways without departing from the spirit and scope of the present disclosure. In each embodiment, except for essential components, components can be added, deleted, or replaced. Unless otherwise specified, each component may be singular or plural. It is also possible to combine each embodiments and modifications.

### REFERENCE SIGNS LIST

1: dimension measurement system (computer system)
2: SEM
6: client terminal device (operation PC)
7: image
8: dimension measurement result
11: interface reference line
12: area reference point
13: perpendicular line
14: intersection
20: line profile
21: edge candidate point
60: GUI screen
70: target image
101: processor
102: memory resource
111: shooting information
112: definition information
401: mask
402: pillar
403: trench
U1: user

1. A dimension measurement system which measures a dimension of a structure displayed as an image including a plurality of areas having different luminance, comprising:
a computer system including a processor and a memory resource that stores data to be processed by the processor; and
a display that displays a graphical user interface (GUI) where a user performs a manual operation, wherein
the processor
obtains a reference line for specifying a portion of boundaries between the plurality of areas and position information of the reference line, and a reference point set within any one of the plurality of areas and position information of the reference point, based on the manual operation by the user performed on the GUI,
detects a contour or edge of the structure in the image, by using the reference line and the reference point, and
measures the dimension of the structure by using information on the detected contour or edge.

2. The dimension measurement system according to claim 1, wherein
the processor
sets a plurality of line profiles extending in a direction parallel to the reference line, on a perpendicular line set between the reference point and the reference line,
extracts candidates for the contour or edge on the line profiles, based on a luminance change of pixels configuring each line profile, and
detects the contour or edge based on the extracted candidates.

3. The dimension measurement system according to claim 1, wherein
the processor
sets a plurality of line profiles on positions extending in a radial direction from the reference point,
extracts candidates for the contour or edge on the line profiles, based on a luminance change of pixels configuring the line profile, and
detects the contour or edge based on the extracted candidates.

4. The dimension measurement system according to claim 1, wherein
the processor
sets a plurality of first line profiles extending in a direction parallel to the reference line, on a perpendicular line set between the reference point and the reference line,
sets a plurality of second line profiles on positions extending in a radial direction from the reference point,
extracts candidates for the contour or edge on the first and second line profiles, based on a luminance change of pixels configuring the first and second line profiles, and
detects the contour or edge based on the extracted candidates.

5. The dimension measurement system according to claim 1, wherein
the processor
obtains the dimension of the structure by using the information on the detected contour or edge and definition information that defines a measurement target dimension.

6. The dimension measurement system according to claim 1, wherein
the reference line is designated relative to a material interface within the image.

7. The dimension measurement system according to claim 1, wherein
the computer system provides
an adjustment function for adjusting the reference line set on the GUI to a most likely reference line position on the structure.

8. The dimension measurement system according to claim 1, wherein
the image is a cross-sectional image of a semiconductor device of which at least one of a mask, a pillar, or a trench is formed.

9. The dimension measurement system according to claim 2, wherein
the processor creates a combination of the candidates for the contour or edge in the plurality of the line profiles, and
detects the contour or edge by selecting the contour or edge based on an evaluation value based on a distance between the candidates or an amount of change in luminance.

10. The dimension measurement system according to claim 1, wherein
the processor causes the designated reference line and reference point to be superimposed on the image displayed on the GUI.

11. The dimension measurement system according to claim 1, wherein
the processor causes the detected contour or edge to be superimposed on the image displayed on the GUI.

12. The dimension measurement system according to claim 1, wherein
the processor causes the measured dimension to be superimposed on the image displayed on the GUI.

13. The dimension measurement system according to claim 1, wherein
the computer system includes a storage in which learning data including the image, the reference line, and the reference point is stored,
a learning model is mounted in the memory resource, the learning model receiving the image as input and outputting the reference line and the reference point for the image, and
the processor detects a contour or an edge of the structure included in a new input image by using information on the reference line and the reference point for the new input image, estimated by the learning model, and
measures the dimension of the structure by using information on the detected contour or edge.

14. The dimension measurement system according to claim 13, wherein
the processor trains the learning model by using the learning data stored in the storage.

15. The dimension measurement system according to claim 13, wherein
the processor accumulates, in the storage, the image, and position information of the reference line and the position information of the reference point obtained for the image based on a manual operation by the user, as the learning data.

16. A dimension measurement method for measuring a dimension of a structure displayed as an image including a plurality of areas having different luminance, by using a dimension measurement system including a processor, a memory resource that stores data to be processed by the processor, and a display that displays a graphical user interface (GUI), the method comprising:
setting a reference line for specifying a portion of boundaries between the plurality of areas and a reference point designated within any one of the plurality of areas, based on a manual operation by a user in the dimension measurement system, performed on the image of the structure displayed on the GUI;
acquiring position information of the reference line and the reference point; and
detecting a contour or edge of the structure by using the reference line and the reference point, and measuring the dimension of the structure by using information on the detected contour or edge.

17. The dimension measurement method according to claim 16, wherein
a plurality of line profiles extending in a direction parallel to the reference line are set on a perpendicular line set between the reference point and the reference line,
on the line profiles, candidates for the contour or edge are extracted based on a luminance change of pixels configuring each line profile, and
the contour or edge is detected based on the extracted candidates.

18. The dimension measurement method according to claim 16, wherein
a plurality of line profiles are set on positions extending in a radial direction from the reference point,
on the line profiles, candidates for the contour or edge are extracted based on a luminance change of pixels configuring each line profile, and
the contour or edge is detected based on the extracted candidates.

19. A non-volatile recording medium having stored thereon a program for causing a computer to execute the following steps to measure a dimension of a structure displayed as an image including a plurality of areas having different luminance by using the computer equipped with a display that displays a graphical user interface (GUI):
a step of setting a reference line for specifying a portion of boundaries between the plurality of areas and a reference point designated within any one of the plurality of areas, based on a manual operation by a user in a dimension measurement system, performed on the image of the structure displayed on the GUI;
a step of acquiring position information of the reference line and the reference point;
a step of detecting a contour or edge of the structure, by using the reference line and the reference point; and
a step of measuring the dimension of the structure by using information on the detected contour or edge.
